(19) United States
(12) Patent Application Publication
(10) Pub. No.: US 2025/0379230 A1
(43) Pub. Date: Dec. 11, 2025

(54) SI-BASED ANODE WITH ENGINEERED SILICON-BASED MATERIALS

(71) Applicant: Enevate Corporation, Irvine, CA (US)

(72) Inventors: Qing Zhang, Irvine, CA (US); Younes Ansari, Irvine, CA (US); Chang Wook Kim, Irvine, CA (US); Benjamin Yong Park, Irvine, CA (US); Shumao Cui, Irvine, CA (US); Jeremy Chang, Irvine, CA (US); Sung Won Choi, Irvine, CA (US); Hong Zhao, Irvine, CA (US); Heidi Anderson, Irvine, CA (US); Daniel Sylvinson Muthiah Ravinson, Irvine, CA (US); Ian Browne, Irvine, CA (US); Rahul Kamath, Irvine, CA (US)

(21) Appl. No.: 19/233,831

(22) Filed: Jun. 10, 2025

Related U.S. Application Data
(60) Provisional application No. 63/658,326, filed on Jun. 10, 2024.
(60) Provisional application No. 63/740,663, filed on Dec. 31, 2024.

(51) Int. Cl. H01M 4/587; H01M 4/133; H01M 4/36; H01M 4/48; H01M 4/62

(52) U.S. Cl. CPC H01M 4/587; H01M 4/133; H01M 4/366; H01M 4/48; H01M 4/625

(57) ABSTRACT

Systems and methods utilizing aqueous-based polymer binders for silicon-based anodes may include an electrode coating layer on a current collector, where the electrode coating layer is formed from a silicon carbon composite or SiOx-based or Si-Carbon-SiOx-based powder and a water soluble polymer and may comprise one or more additional materials. The anode may be in a lithium ion battery.

### CROSS-REFERENCE TO RELATED APPLICATIONS/INCORPORATION BY REFERENCE

This application claims the benefit of U.S. Provisional Application No. 63/658,326, filed Jun. 10, 2024 and U.S. Provisional Application No. 63/740,663, filed Dec. 31, 2024. The entirety of each of the above referenced applications is hereby incorporated herein by reference.

### FIELD

Aspects of the present disclosure relate to energy generation and storage. More specifically, certain embodiments of the disclosure relate to using engineered silicon-based materials to fabricate silicon-based anode materials.

### BACKGROUND

Conventional approaches for battery electrodes may be costly, cumbersome, and/or inefficient—e.g., they may be complex and/or time-consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method for using engineered silicon-based materials to fabricate silicon-based anode materials, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a diagram of a battery, in accordance with an example embodiment of the disclosure.

FIG. 2 is a flow diagram of a lamination process for forming a silicon-dominant anode cell, in accordance with an example embodiment of the disclosure.

FIG. 3 is a flow diagram of a direct coating process for forming a silicon-dominant anode cell, in accordance with an example embodiment of the disclosure.

FIG. 4 shows the performance of Anode 1 in single layer cells, in accordance with an example embodiment of the disclosure. The cathode chemistry is NMC811. From left to right 0.5C/0.5C 4.1-2.0 V cycling normalized capacity, 4C/0.5C 4.1-3.0 V cycling normalized capacity and 4C/0.5C 4.1-3.0 V cycling DCIR growth.

FIG. 5 shows the performance of the disclosed anode in 5-layer cells, in accordance with an example embodiment of the disclosure. The cathode chemistry is NMC811. From left to right 4C/0.5C 4.1-2.5 (3.0) V cycling capacity, 4C/0.5C 4.1-2.5 (3.0) V cycling normalized capacity and DCIR growth.

FIG. 6 shows a discharge rate test of the disclosed anode in 5-layer cells, in accordance with an example embodiment of the disclosure. The cathode chemistry is NMC811. From left to right discharge rate test normalized capacity, charge capacity vs. time for Anode 1 charge capacity vs. time for Anode 4 aqueous control.

FIG. 7 shows the performance of Anode 1 in single layer cells, in accordance with an example embodiment of the disclosure. The cathode chemistry is NMC811. From left to right 4C/0.5C 4.1-3.0 V cycling capacity and normalized capacity plot.

FIG. 8 shows the performance of a silicon carbon anode (pyrolyzed form), Anode 5 and Anode 6 in single layer cells, in accordance with an example embodiment of the disclosure. The cathode chemistry is NMC811. From left to right 0.5C/0.5C 4.1-2.0 V cycling normalized capacity, 4C/0.5C 4.1-3.0 V cycling normalized capacity and 4C/0.5C 4.1-3.0 V cycling DCIR growth.

FIG. 9 shows crystalline vs. amorphous silicon in single layer cells, in accordance with an example embodiment of the disclosure. The cathode chemistry is NMC811. From left to right 0.5C/0.5C 4.1-2.0 V cycling normalized capacity and 4C/0.5C 4.1-3.0 V cycling normalized capacity.

FIG. 10 shows the voltage vs. capacity profile of half-cell data (cycle 2) with Anode 1 N/P=1.2 and Anode 4 (aqueous control), in accordance with an example embodiment of the disclosure.

FIG. 11 shows changes in the surface roughness of the electrode as a function of graphite additive, in accordance with an example embodiment of the disclosure.

FIG. 12 shows an electrolyte embodiment where the electrolyte amount may be 2.60-2.90 grams/A and the EL amount: 2.60-2.90 g/Ah, in accordance with an example embodiment of the disclosure.

FIG. 13 shows initial coulombic efficiency (ICE) and cycling performance [4C/0.5C (3.5-2.5 V)] of LFP| Si (Crystalline) pouch cells with ether-based electrolytes and conventional carbonate-based electrolyte (blue), in accordance with an example embodiment of the disclosure.

FIG. 14 shows cycling performance (4C/0.5C (4.1-3.0 V) of NCM811| Si (Crystalline) pouch cells with ether-based electrolytes and conventional carbonate-based electrolyte at 25 and 45 degC, in accordance with an example embodiment of the disclosure.

FIG. 15 shows the effect of calendering, in accordance with an example embodiment of the disclosure.

FIG. 16 shows the effect of calendering, in accordance with an example embodiment of the disclosure.

FIG. 17 shows the effect of calendering, in accordance with an example embodiment of the disclosure.

FIG. 18 illustrates that reducing the electrode density improves cycle life, in accordance with an example embodiment of the disclosure.

FIG. 19 shows the effect of loading on ICE, in accordance with an example embodiment of the disclosure.

FIG. 20 shows the effect of loading on retention, in accordance with an example embodiment of the disclosure.

FIG. 21 shows a cycle life to 80% prediction, in accordance with an example embodiment of the disclosure.

FIG. 22 shows energy density vs cycle life prediction, in accordance with an example embodiment of the disclosure.

FIG. 23 shows formation profiles, in accordance with an example embodiment of the disclosure.

FIG. 24 shows cell expansion, in accordance with an example embodiment of the disclosure.

FIG. 25 shows cycling performance, in accordance with an example embodiment of the disclosure.

FIG. 26 shows 4C (4.2V)-0.5C (2.5V) cycle life, in accordance with an example embodiment of the disclosure.

FIG. 27 shows 4C (4.2V)-0.5C (2.5V) cycle life @ 45 degC, in accordance with an example embodiment of the disclosure.

FIG. 28 shows 4C (4.2V)-0.5C (2.5V) cycle life, in accordance with an example embodiment of the disclosure.

FIG. 29 shows 4C (4.2V)-0.5C (2.5V) Cycle Life @ 45 degC, in accordance with an example embodiment of the disclosure.

FIG. 30 shows data comparing 2 different formulations one with 0.5% SWCNT in dry composition, the other with no SWCNT, in accordance with an example embodiment of the disclosure.

FIG. 30 shows data comparing 2 different formulations one with 0.5% SWCNT in dry composition, the other with no SWCNT, in accordance with an example embodiment of the disclosure.

FIG. 31 shows electrodes with SWCNT, in accordance with an example embodiment of the disclosure.

FIG. 32 shows data comparing 2 different formulations one with 0.5% SWCNT in dry composition (black), and the other with no SWCNT (red), in accordance with an example embodiment of the disclosure.

FIG. 33 shows electrodes with SWCNT, in accordance with an example embodiment of the disclosure.

FIG. 34 shows Super P vs CNT formulations, in accordance with an example embodiment of the disclosure.

### DETAILED DESCRIPTION

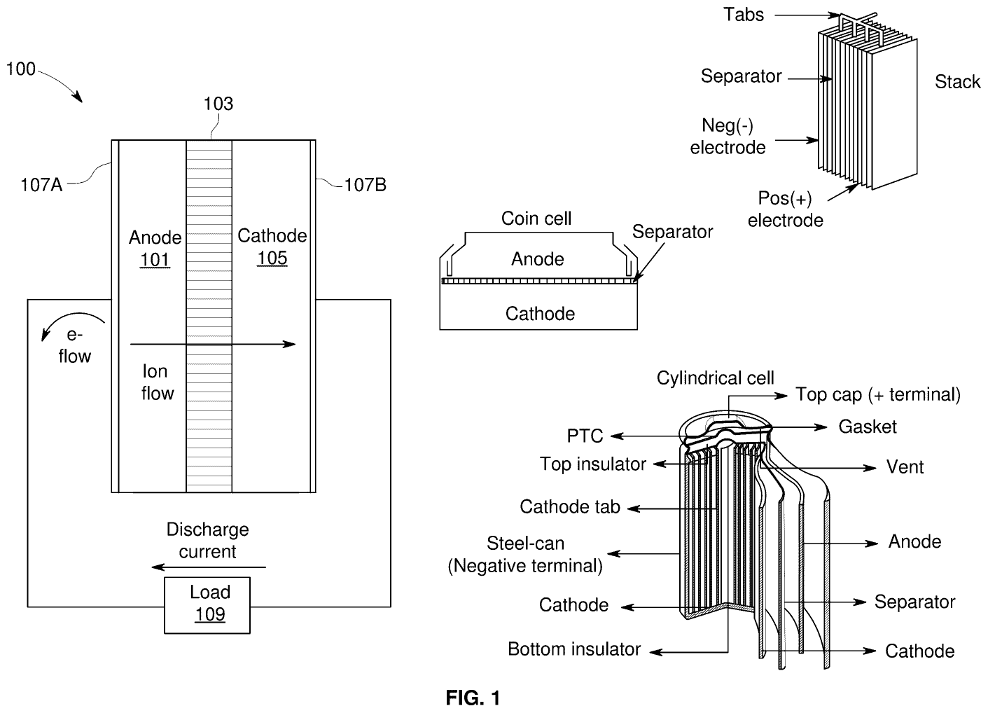

FIG. 1 is a diagram of a battery with silicon-dominant anodes, in accordance with an example embodiment of the disclosure. Referring to FIG. 1, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack. Furthermore, the battery 100 shown in FIG. 1 is a very simplified example merely to show the principle of operation of a lithium-ion cell. Examples of realistic structures are shown to the right in FIG. 1, where stacks of electrodes and separators are utilized, with electrode coatings typically on both sides of the current collectors. The stacks may be formed into different shapes, such as a coin cell, cylindrical cell, or prismatic cell, for example.

The development of portable electronic devices and electrification of transportation drive the need for high-performance electrochemical energy storage. Small-scale (<100 Wh) to large-scale (>10 KWh) devices primarily use lithium-ion (Li-ion) batteries over other rechargeable battery chemistries due to their high performance.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode are electrically coupled to the current collectors 107A and 107B, which comprise metal or other conductive material for providing electrical contact to the electrodes as well as physical support for the active material in forming electrodes.

The configuration shown in FIG. 1 illustrates the battery 100 in discharge mode, whereas in a charging configuration, load 109 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. Sheets of the cathode, separator, and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄ etc. In an example scenario, the electrolyte may comprise Lithium hexafluorophosphate (LiPF₆) and lithium bis(trifluoromethanesulfonyl)imide (LiTFSI) that may be used together in a variety of electrolyte solvents. Lithium hexafluorophosphate (LiPF₆) may be present at a concentration of about 0.1 to 4.0 molar (M) and lithium bis(trifluoromethanesulfonyl)imide (LiTFSI) may be present at a concentration of about 0 to 4.0 molar (M). Solvents may comprise one or more of ethylene carbonate (EC), fluoroethylene carbonate (FEC), and/or ethyl methyl carbonate (EMC) in various percentages. In some embodiments, the electrolyte solvents may comprise one or more of EC from about 0-40%, FEC from about 2-40%, and/or EMC from about 50-70%

The separator 103 may be wet or soaked with a liquid or gel electrolyte. In addition, in an example embodiment, the separator 103 does not melt below about 100 to 120° C. and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through gelling or other processes even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for the transfer of electrical charge in charge and discharge states. The anode 101 may comprise silicon, carbon, or combinations of these materials, for example. Typical anode electrodes comprise a carbon material that includes a current collector such as a copper sheet. Carbon is often used because it has excellent electrochemical properties and is also electrically conductive. Anode electrodes currently used in rechargeable lithium-ion cells typically have a specific capacity of approximately 200 milliampere hours per gram. Graphite, the active material used in most lithium-ion battery anodes, has a theoretical energy density of 372 milliampere hours per gram (mAh/g). In comparison, silicon has a high theoretical capacity of 4200 mAh/g. To increase the volumetric and gravimetric energy density of lithium-ion batteries, silicon may be used as the active material for the cathode or anode. Silicon anodes may be formed from silicon composites, with more than 50% silicon or more by weight in the anode material on the current collector, for example.

In an example scenario, the anode 101 and cathode 105 store the ion used for the separation of charge, such as lithium. In this example, the electrolyte carries positively charged lithium ions from the anode 101 to the cathode 105 in discharge mode, as shown in FIG. 1 for example, and vice versa through the separator 105 in charge mode. The movement of the lithium ions creates free electrons in the anode 101 which creates a charge at the positive current collector 107B. The electrical current then flows from the current collector through load 109 to the negative current collector 107A. The separator 103 blocks the flow of electrons inside the battery 100, allows the flow of lithium ions, and prevents direct contact between the electrodes.

While battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process costs and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be manipulated by incorporating conductive additives with different morphological properties. 0-dimensional carbon (for example, Super P), and 1-dimensional carbon (for example, vapor-grown carbon fibers, single-walled or multi-walled carbon nanotubes and other 1D carbon structures) and the mixture of the two have previously been incorporated separately into the anode electrode resulting in improved performance of the anode. The synergistic interactions between the two carbon materials may facilitate electrical contact throughout the large volume changes of the silicon anode during charge and discharge. These contact points facilitate the electrical contact between anode material and current collector to mitigate the isolation (island formation) of the electrode material while also improving conductivity in between silicon regions.

Current state-of-the-art lithium-ion batteries typically employ a graphite-dominant anode as an intercalation material for lithium. Silicon-dominant anodes, however, offer improvements compared to graphite-dominant Li-ion batteries. Silicon exhibits both higher gravimetric (4200 mAh/g vs. 372 mAh/g for graphite) and volumetric capacities (2194 mAh/L vs. 890 mAh/L for graphite). In addition, silicon-based anodes have a low lithiation/delithiation voltage plateau at about 0.3-0.4V vs. Li/Li+, which allows it to maintain an open circuit potential that avoids undesirable Li plating and dendrite formation. While silicon possesses high theoretical capacity (4200 mAh/g, it also suffers from severe volume fluctuation (>300%) during lithiation/de-lithiation (charging/discharging) during throughout battery operation. Thus despite silicon's excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

Electrodes comprised of silicon or silicon-based particles suspended in a matrix attached to a current collector provide superior energy density to industry-standard graphite electrodes if paired with high-voltage, high-capacity cathodes, such as NMC, NCA, NCMA, etc. In some embodiments, cathodes such as LFMP and LFP may be used as lower capacity, lower cost options.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life. Therefore, silicon based anodes require a strong conductive matrix that (a) holds silicon particles in the anode, (b) is flexible enough to accommodate the large volume expansion and contraction of silicon, and (c) allows fast conduction of electrons within the matrix. Binders may be used in anode technologies to maintain the integrity of the anode during excessive volume changes during lithiation.

Among the recent developments in silicon-based anode development, one is the direct coated anode using organic solvent-based binders followed by heat treatment to convert the binder into a carbon matrix. Embodiments of the present disclosure address at least one or more of the following key advancements over direct coated anode using organic solvent-based binders: 1) use of environmentally friendly water-based anode processing to allow safer, cheaper and faster processing and scalability; 2) Si based anodes having improved cycle life; 3) Si based anodes having improved initial coulombic efficiency (ICE) and cycled capacity with reduced negative/positive capacity ratio (N/P ratio); 4) Reduction or elimination of the pyrolysis step.

Disclosed herein are anodes formed from engineered materials that are comprised of silicon and carbon or SiOx which are developed as powders, that are used with unique binder systems that may be converted into fully or partially pyrolyzed carbon with heat treatments, or may be utilized without heat treatment.

Although solvent-based anodes have had some effectiveness in improving cycle performance, these anodes may have weak adhesion to the current collector and contain non-continuous carbon media that leads to unacceptable performance. While the introduction of carbon additives can somewhat improve the conductivity of the anode, the existence of carbon additives may weaken the adhesion of anode materials to the current collector. Thus, the binder plays an important role in improving the performance of silicon anodes.

Currently, polymeric binders may be used in silicon anode technologies to maintain the integrity of the anode during excessive volume changes during lithiation. Although polyvinylidene difluoride (PVDF) is commonly used in graphite cells, it is not capable of handling the excessive volume changes of silicon or silicon composite materials (engineered materials). Additionally, PVDF is soluble only in toxic organic solvents such as NMP, which require solvent recovery systems to recycle the solvent. In an example scenario, polymeric binders that are capable of mitigating the capacity fade of Si anodes occurring at a high rate and long-term cycling are disclosed. Water-based anode fabrication is of interest for large scale manufacturing of anodes to reduce the cost and eliminate the use of toxic solvents. Objectives of a aqueous-based anode polymer may include one or more of: 1) ease of processing—the resin being highly soluble in water allowing for ease of adjusting viscosity during coating; 2) high carbon yield and film-forming properties upon pyrolysis to create a conductive matrix around and between silicon particles; 3) a homogeneous distribution of polymeric components in water and the slurry without phase separation during the slurry formulation or coating; and 4) possessing a relatively low pyrolysis temperature that is compatible with the thermal behavior of the associated current collector. Note that aqueous-based materials are also referred to as water-based or water-soluble, these are materials that are partially or fully soluble in water or an aqueous solution.

Commercially available water-soluble polymers can have significantly low carbon yield (<10 wt. %) and develop microcracks during pyrolysis. As a result, these water-soluble polymers exhibit poor mechanical properties in the anode after pyrolysis. Polymer resins and their derivatives with high carbon yield upon pyrolysis are desired to yield a continuous carbon medium while keeping the robustness of the anode. Although available polymers and their blends may be capable of achieving a high char yield, most of these polymers are insoluble in water. Therefore, there is a trade-off among the functions of active materials, conductive additives, and polymer binders. The balance may be adversely impacted by high energy density silicon anodes with low conductivity and huge volume variations described above.

According to certain embodiments, water-soluble (aqueous-based) polymers are used as binders to fabricate silicon-based anode materials. These binders may also include various modifiers and/or additives in order to achieve the desired properties. These modifiers and/or additives may assist in any or all of, stabilizing, strengthening and/or adjusting the properties of the binder and may also serve as a carbon source themselves. The modifiers and/or additives comprise one or more additional components such as pH modifiers, viscosity modifiers, strengthening additives, surfactants and/or anti-foaming agents.

As the demands for both zero-emission electric vehicles and grid-based energy storage systems increase, lower costs and improvements in energy density, power density, and safety of lithium (Li)-ion batteries are highly desirable. Enabling the high energy density and safety of Li-ion batteries requires the development of high-capacity, and high-voltage cathodes, high-capacity anodes, and accordingly functional electrolytes with high voltage stability, interfacial compatibility with electrodes and safety.

A lithium-ion battery typically includes a separator and/or electrolyte between an anode and a cathode. In one class of batteries, the separator, cathode, and anode materials are individually formed into sheets or films. Sheets of the cathode, separator, and anode are subsequently stacked or rolled with the separator separating the cathode and anode (e.g., electrodes) to form the battery. Typical electrodes include electro-chemically active material layers on electrically conductive metals (e.g., aluminum and copper). Films can be rolled or cut into pieces which are then layered into stacks. The stacks are of alternating electro-chemically active materials with the separator between them.

As discussed above, a lithium-ion battery typically includes a separator and/or electrolyte between an anode and a cathode. Separators may be formed as sheets or films, which are then stacked or rolled with the anode and cathode (e.g., electrodes) to form the battery. The separator may comprise a single continuous or substantially continuous sheet or film, which can be interleaved between adjacent electrodes of the electrode stack. The separator may be configured to facilitate electrical insulation between the anode and the cathode, while still permitting ionic transport. In some embodiments, the separator may comprise a porous material. Functional compounds may be used to modify the separator to prepare different types of functional separators to improve the cycle performance of Li-ion batteries or Li-metal batteries.

Cathode materials may include Lithium Nickel Cobalt Manganese Oxide (NMC (NCM): LiNiₓCo_{y}Mn_{z}O₂, x+y+z=1); Lithium Iron Phosphate (LFP: LiFePO₄/C); Lithium Nickel Manganese Spinel (LNMO: LiNi_{0.5}Mn_{1.5}O₄); Lithium Nickel Cobalt Aluminium Oxide (NCA: LiNiₐCo_{b}Al_{c}O₂, a+b+c=1); Lithium Manganese Oxide (LMO: LiMn₂O₄); LMFP (LiMnₓFe₍₁₋ₓ₎PO₄)/C, x<1), NCMA (Li[NiₓCo_{y}Mn_{z}Al_{q}]O₂, x+y+z+q=1), and Lithium Cobalt Oxide (LCO: LiCoO₂).

Among the various cathodes presently available, layered lithium transition-metal oxides such as Ni-rich LiNiₓCo_{y}Mn_{z}O₂ (NCM, 0≤x, y, z<1), NCMA (Li[NiₓCo_{y}Mn_{z}Al_{q}]O₂, x+y+z+q=1), or LiNiₓCo_{y}Al_{z}O₂ (NCA, 0≤x, y, z<1) are promising ones due to their high theoretical capacity (˜280 mAh/g) and relatively high average operating potential (3.6 V vs Li/Li⁺). In addition to Ni-rich NCM or NCA cathode, LiCoO₂ (LCO) is also a very attractive cathode material because of its relatively high theoretical specific capacity of 274 mAh g⁻¹, high theoretical volumetric capacity of 1363 mAh cm⁻³, low self-discharge, high discharge voltage, and good cycling performance. Coupling Si-based anodes with high-voltage Ni-rich NCM (or NCA) or LCO cathodes can deliver more energy than conventional Li-ion batteries with graphite-based anodes, due to the high capacity of these new electrodes. However, both Si-based anodes and high-voltage Ni-rich NCM (or NCA) or LCO cathodes face formidable technological challenges, and long-term cycling stability with Si-based anodes paired with e.g., NCM or NCA cathodes has yet to be achieved.

Furthermore, cathodes such as lithium iron manganese phosphate (LFMP; Li Mn₍₁₋ₓ₎FeₓPO₄, x<1) and lithium iron phosphate (LFP; LiFePO₄) may be used as lower capacity, lower cost cathode options.

For anodes, silicon-based materials can provide significant improvement in energy density. However, the large volumetric expansion (e.g., >300%) during the Li alloying/dealloying processes can lead to disintegration of the active material and the loss of electrical conduction paths, thereby reducing the cycling life of the battery. In addition, an unstable solid electrolyte interphase (SEI) layer can develop on the surface of the cycled anodes and leads to an endless exposure of Si particle surfaces to the liquid electrolyte. This results in an irreversible capacity loss at each cycle due to the reduction at the low potential where the liquid electrolyte reacts with the exposed surface of the Si anode. In addition, oxidative instability of the conventional non-aqueous electrolyte takes place at voltages beyond 4.5 V, which can lead to accelerated decay of cycling performance. Because of the generally inferior cycle life of Si compared to graphite, only a small amount of Si or Si alloy is used in conventional anode materials.

In order to increase the volumetric and gravimetric energy density of lithium-ion batteries, silicon may be used as the active material for the cathode or anode. However, the expansion of the silicon active material can result in poor cycle life due to particle cracking. For example, silicon can swell over 300% upon lithium insertion. Because of this expansion, anodes including silicon should be allowed to expand while maintaining electrical contact between the silicon particles. The use of aqueous-based polymers as disclosed herein for Si anodes may allow for free spaces to be created among Si particles.

The cathode (e.g., NCM (or NCA) or LCO) usually suffers from inferior stability and a low capacity retention at a high cut-off potential. The reasons can be ascribed to the unstable surface layer's gradual exfoliation, the continuous electrolyte decomposition, and the transition metal ion dissolution into electrolyte solution; further causes for inferior performance can be: (i) structural changes from layered to spinel upon cycling; (ii) Mn- and Ni-dissolution giving rise to surface side reactions at the graphite anode; and (iii) oxidative instability of conventional carbonate-based electrolytes at high voltage. The major limitations for LCO cathodes are high cost, low thermal stability, and fast capacity fade at high current rates or during deep cycling. LCO cathodes are expensive because of the high cost of Co. Low thermal stability refers to an exothermic release of oxygen when a lithium metal oxide cathode is heated. In order to make good use of Si anode//NCM or NCA cathode, and Si anode//LCO cathode-based Li-ion battery systems, the aforementioned barriers need to be overcome.

Cathode electrodes (positive electrodes) described herein may include metal oxide cathode materials, such as Lithium Cobalt Oxide (LiCoO₂) (LCO), Ni-rich oxides, high voltage cathode materials, lithium-rich oxides, nickel-rich layered oxides, lithium-rich layered oxides, high-voltage spinel oxides, and high-voltage polyanionic compounds. Ni-rich oxides and/or high voltage cathode materials may include NCM and NCA. Example of NCM materials include, but are not limited to, LiNi_{0.6}Co_{0.2}Mn_{0.2}O₂ (NCM-622) and LiNi_{0.8}Co_{0.1}Mn_{0.1}O₂(NCM-811). Lithium-rich oxides may include xLi₂Mn₃O₂·(1−x) LiNiₐCo_{b}Mn_{c}O₂ (0≤x<1). Nickel-rich layered oxides may include LiNi₁₊ₓM₁₋ₓO₂ (where M=Co, Mn or Al; 0≤x<1). Lithium-rich layered oxides may include LiNi₁₊ₓM₁₋ₓO₂ (where M=Co, Mn or Ni; 0≤x<1). High-voltage spinel oxides may include LiNi_{0.5}Mn_{1.5}O₄. High-voltage polyanionic compounds may include phosphates, sulfates, silicates, etc. Other materials include LMFP (LiMnₓFe₍₁₋ₓ₎PO₄)/C, x<1) and NCMA (Li[NiₓCo_{y}Mn_{z}Al_{q}]O₂, x+y+z+q=1).

In certain embodiments, the positive electrode may be one of NCA, NCM, LMO or LCO. The NCM cathodes include NCM 9 0.5 0.5, NCM811, NCM622, NCM532, NCM433, NCM111, and others. In further embodiments, the positive electrode comprises a lithium-rich layered oxide xLi₂MnO₃·(1−x) LiNiₐCo_{b}Mn_{c}O₂ (a+b+c=1; 0≤x<1); nickel-rich layered oxide LiNi₁₋ₓMₓO₂ (M=Co, Mn and Al; 0≤x<1); or lithium rich layered oxide LiNi₁₊ₓM₁₋ₓO₂ (M=Co, Mn and Ni; 0≤x<1) cathode.

Described herein is the use of engineered silicon-based materials including silicon carbon composite powders and SiOx-based powders rather than pure Si to combine with polymers (resins) and conductive additives to make electrode slurries. The electrode slurries are then used to make coated silicon carbon composite electrodes, which may or may not be heat-treated/pyrolyzed.

The engineered material is a powder that may incorporate silicon nanophases that are either deposited within carbon skeletons from a gas phase, incorporated by using nanosilicon solid powder (e.g. larger chunks of silicon milled into sub-micron particles), or otherwise synthesized. The surface of the powder may be coated with a layer of carbon. Anodes made from this type of material may electrochemically perform better because of the robustness of the material's structure, resiliency in cycling due to the small size of the silicon phases, the carbon layer protecting the silicon's surface, and the improved electrical conductivity provided by the conductive carbon. In some embodiments, the elemental silicon content in the anode active material powder is between 40-90%, 30 and 70%, or ˜50% by weight.

In some embodiments, the anode is a silicon carbon composite anode which contains an engineered material in the anode active material layer. The engineered material is a silicon carbon composite or SiOx-based or Si-Carbon-SiOx-based powder that contains 40-90%, 30-70%, or ˜50% elemental silicon in the active material powder by weight (excluding the current collector). In other embodiments, the engineered material has the silicon embedded in a carbon matrix to form each powder particle as described above. Each particle may have its surface substantially covered by a carbon coating. Each particle may contain silicon phases which is are sub-micron in size (<1 μm diameter). In some embodiments, the anode active material layer contains >20%, >30%, or >40% elemental Si by weight. In other embodiments, the silicon may have crystallite size below 50 nm and particle size D50 of the composites should be below 10 μm. In further embodiments, the silicon carbon composite may have a carbon coating on the secondary particles and the coating ratio may be up to 5%.

Properties of the engineered materials are as follows in Table 1.

TABLE 1

| | | |
|---|---|---|
| D10 | 1-5 | μm |
| D50 | 6-10 | μm |
| D90 | 11-17 | μm |
| Real density | 2 g/cm³ | (within +/−20%) |
| Tap density | 1 g/cm³ | (within +/−20%) |
| Surface area | 3 m²/g | (within +/−20%) |
| Discharge capacity | 1500-2400 mAh/g | (within +/−20%) |
| First discharge capacity | 90% | (within +/−20%) |

In some embodiments, the largest dimension of the composite particles can be less than about 40 μm, less than about 1 μm, between about 10 nm and about 40 μm, between about 10 nm and about 1 μm, less than about 500 nm, less than about 100 nm, and about 100 nm. All, substantially all, or at least some of the composite particles may comprise the largest dimension described above. For example, an average or median largest dimension of the composite particles can be less than or equal to about 40 μm, less than or equal to about 30 μm, less than or equal to about 20 μm, less than or equal to about 10 μm; between about 5 μm and about 40 μm, between about 5 μm and about 30 μm, between about 5 μm and about 15 μm. Note that particle sizes may be described using values such as D10, D50 and D90. These are percentile values that can be determined from the particle size distribution and indicate the size below which 10%, 50% or 90% of all particles may be found, respectively. As discussed above, D50 also indicates the median particle size and the value Dmax=D100 (maximum particle size).

Electrode materials can also be called (or can comprise) active materials when referring to an electrode. The amount of silicon in the electrode material provided by the engineered material which is a silicon carbon composite or SiOx-based or Si-Carbon-SiOx-based powder can be greater than zero percent by weight of the mixture. In certain embodiments, the mixture may be a slurry that comprises an amount of silicon, the amount being within a range of from about 0% to about 95% by weight, including from about 30% to about 95% by weight of the mixture. The amount of silicon in the material can be within a range of from about 0% to about 35% by weight, including from about 0% to about 25% by weight, from about 10% to about 35% by weight, and about 20% by weight. In further certain embodiments, the amount of silicon in the mixture is at least about 30% by weight; greater than 0% and less than about 95% by weight; or between about 50% and about 95% by weight.

Anodes may be designed with variable Si % in the slurry, but post pyrolysis % Si can be controlled by combining polymers having different char yields and/or different pyrolysis temperatures. The final amount of silicon in the pyrolyzed anode is measured and, in one embodiment is about 80% by weight or more. The amount of silicon in the anode may also be about 85%, 90%, 95% by weight or more. Higher silicon embodiments include amounts of silicon in the pyrolyzed anode of about 95% or more, about 96% or more, about 97% or more, about 98% or more or about 99% or more % by weight. In some embodiments, the amount of silicon in the pyrolyzed anode is about 95-99%; about 96-99% or about 97-99% by weight.

In some embodiments, pyrolysis refers to heating the green anodes at temperatures above 350° C. in a reducing or inert environment (vacuum or N₂ or forming gas atmosphere). The heating rate and final dwell temperature affects the weight yield of the polymer binder. Heating rate may be about 0.5-30° C. per minute; in some embodiments, the heating rate is ≤5° C. per minute, or from about 0.5-4° C. per minute; or ≤10° C. per minute, or from about 0.5-9° C. per minute. Dwell temperatures may be from about 100-1000° C.; in some embodiments, the dwell temperature is about 300-900° C. Weight loss versus temperature is different for different binders and hence final composition also depends on the nature of the binder itself. Longer and higher dwell temps will also decrease the weight yield of the polymer binder. This may make the electrode more electrically conductive and/or to make the material less reactive in the cell causing less irreversible capacity loss. However, mass loss may also result in dimensional changes due to shrinking of the polymer and annealing of the current collector.

The electrode material can be formed by pyrolyzing a polymer precursor. The amount of carbon obtained from the precursor can be about 50 percent by weight of the electrode material. In certain embodiments, the amount of carbon from the precursor in the electrode material is about 10% to about 25% by weight. The carbon from the precursor can be hard carbon. Hard carbon can be a carbon that does not convert into graphite even with heating over 2800 degrees Celsius. Precursors that melt or flow during pyrolysis convert into soft carbons and/or graphite with sufficient temperature and/or pressure. Hard carbon may be selected since soft carbon precursors may flow and soft carbons and graphite are mechanically weaker than hard carbons. Other possible hard carbon precursors can include phenolic resins, epoxy resins, and other polymers that have a very high melting point or are crosslinked. A soft carbon precursor can be used if it does not melt at the heat treatment temperatures used. In some embodiments, the amount of carbon in the electrode material has a value within a range of from about 10% to about 25% by weight, about 20% by weight, or more than about 50% by weight. In some embodiments, there may be greater than 0% and less than about 90% by weight of one or more types of carbon phases. In certain embodiments, the carbon phase is substantially amorphous. In other embodiments, the carbon phase is substantially crystalline. In further embodiments, the carbon phase includes amorphous and crystalline carbon. The carbon phase can be a matrix phase in the electrode material. The carbon can also be embedded in the pores of the additives including silicon. The carbon may react with some of the additives to create some materials at interfaces. For example, there may be a silicon carbide layer between the silicon particles and the carbon.

As described herein and in U.S. patent application Ser. No. 17/945,790, entitled “Lower Pyrolysis Temperature Binder for Silicon-Dominant Anodes,” the entirety of which is hereby incorporated by reference, certain embodiments utilize directly coated anodes comprising a silicon-dominated anode active material, a carbon-based binder, and a carbon-based additive, with the composition being configured for low-temperature pyrolysis. The onset of the pyrolysis may occur below 500° C. (such as about 400° C.) and carbonization may occur below 600° C. In some embodiments, the binder comprises PAI (Polyamide imide) having silicon particles therein, where the active material is pyrolyzed to turn the binder into a glassy carbon that provides a structural framework around the silicon particles and also provides electrical conductivity.

In certain embodiments, graphite particles are added to the electrode material mixture. Advantageously, graphite can be an electrochemically active material in the battery as well as an elastically deformable material that can respond to the volume change of the silicon particles. Graphite is the preferred active anode material for certain classes of lithium-ion batteries currently on the market because it has a low irreversible capacity. Additionally, graphite is softer than hard carbon and can better absorb the volume expansion of silicon additives. In certain embodiments, the largest dimension of the graphite particles is between about 0.5 microns and about 20 microns. All, substantially all, or at least some of the graphite particles may comprise the largest dimension described herein. In further embodiments, an average or median largest dimension of the graphite particles is between about 0.5 microns and about 20 microns. In certain embodiments, the mixture includes greater than 0% and less than about 80% by weight of graphite particles. In further embodiments, the electrode material includes about 1% to about 20% by weight graphite particles. In further embodiments, the electrode material includes about 40% to about 75% by weight graphite particles.

In certain embodiments, conductive particles which may also be electrochemically active are added to the mixture. Such particles can enable both a more electronically conductive electrode as well as a more mechanically deformable electrode capable of absorbing the large volumetric change incurred during lithiation and de-lithiation. In certain embodiments, a largest (or median) dimension of the conductive particles is between about 10 nanometers and about 7 millimeters. In further embodiments, an average or median largest dimension of the conductive particles is between about 10 nm and about 7 millimeters. In further embodiments, a largest (or average/median) dimension may be about 10 nm to 1 μm, about 1 μm-10 μm, or about 10 nm-10 μm. All, substantially all, or at least some of the conductive particles may comprise the largest (or median) dimension described herein. In certain embodiments, the mixture includes greater than zero and up to about 80% by weight conductive particles. In further embodiments, the electrode material includes about 45% to about 80% by weight conductive particles. The conductive particles can be conductive carbon including carbon blacks, carbon fibers, carbon nanofibers, carbon nanotubes, graphite, graphene, etc. Many carbons that are considered as conductive additives that are not electrochemically active become active once pyrolyzed in a polymer matrix. Alternatively, the conductive particles can be metals or alloys including copper, nickel, or stainless steel.

An electrolyte composition for a lithium-ion battery can include a solvent and a lithium-ion source, such as a lithium-containing salt. The composition of the electrolyte may be selected to provide a lithium-ion battery with improved performance. In some embodiments, the electrolyte may contain an electrolyte additive. As described herein, a lithium-ion battery may include a first electrode, a second electrode, a separator between the first electrode and the second electrode, and an electrolyte in contact with the first electrode, the second electrode, and the separator. The electrolyte serves to facilitate ionic transport between the first electrode and the second electrode. In some embodiments, the first electrode and the second electrode can refer to anode and cathode or cathode and anode, respectively. Electrolytes and/or electrolyte compositions may be a liquid, solid, or gel.

In lithium-ion batteries, the most widely used electrolytes are non-aqueous liquid electrolytes; these may comprise a lithium-containing salt (e.g. LiPF₆) and low molecular weight carbonate solvents as well as various small amounts of functional additives. LiPF₆ holds a dominant position in commercial liquid electrolytes due to its well-balanced properties. However, LiPF₆ has problems such as high reactivity towards moisture and poor thermal stability. These issues are primarily attributed to the equilibrium decomposition reaction of LiPF₆. The P—F bond in LiPF₆ and PF₅ is rather labile towards hydrolysis by inevitable trace amounts of moisture in batteries. Besides, as a strong Lewis acid, PF₅ is also able to initiate reactions with carbonate solvents and causes further electrolyte degradation. Moreover, a temperature rise further accelerates the decomposition reaction of LiPF₆ and consequently promotes subsequent parasitic reactions. This is also a reason for faster aging of current lithium-ion batteries at elevated temperatures, as compared to room temperature.

In some embodiments, the electrolyte for a lithium ion battery may include a solvent comprising a fluorine-containing component, such as a fluorine-containing cyclic carbonate, a fluorine-containing linear carbonate, and/or a fluoroether. In some embodiments, the electrolyte can include more than one solvent. For example, the electrolyte may include two or more co-solvents. In some embodiments, at least one of the co-solvents in the electrolyte is a fluorine-containing compound. In some embodiments, the fluorine-containing compound may be fluoroethylene carbonate (FEC), or difluoroethylene carbonate (F2EC). In some embodiments, the co-solvent may be selected from the group consisting of FEC, ethyl methyl carbonate (EMC), 1,1,2,2-tetrafluoroethyl 2,2,3,3-tetrafluoropropyl ether, difluoroethylene carbonate (F2EC), ethylene carbonate (EC), diethyl carbonate (DEC), dimethyl carbonate (DMC), propylene carbonate (PC), Dimethoxy ethane (DME), and gamma-butyrolactone (GBL), methyl acetate (MA), ethyl acetate (EA), and methyl propanoate. In some embodiments, the electrolyte contains FEC. In some embodiments, the electrolyte contains both EMC and FEC. In some embodiments, the electrolyte may further contain 1,1,2,2-tetrafluoroethyl 2,2,3,3-tetrafluoropropyl ether, EC, DEC, DMC, PC, GBL, and/or F2EC or some partially or fully fluorinated linear or cyclic carbonates, ethers, etc. as a co-solvent. In some embodiments, the electrolyte is free or substantially free of non-fluorine-containing cyclic carbonates, such as EC, GBL, and PC.

In further embodiments, electrolyte solvents may be composed of a cyclic carbonate, such as fluoro ethylene carbonate (FEC), di-fluoroethylene carbonate (DiFEC), Trifluoropropylene carbonate (TFPC), ethylene carbonate (EC), propylene carbonate (PC), etc; a linear carbonate, such as dimethyl carbonate (DMC), diethyl carbonate (DEC), ethyl methyl carbonate (EMC), etc, or other solvents, such as methyl acetate, ethyl acetate, or gamma butyrolactone, dimethoxyethane, 1,1,2,2-tetrafluoroethyl 2,2,3,3-tetrafluoropropyl ether, etc.

In some embodiments, the electrolyte composition may comprise a system of solvents (i.e. a solvent, plus one or more co-solvents). The solvents may be fluorinated or non-fluorinated. In some embodiments, the co-solvents may be one or more linear carbonates, lactones, acetates, propanoates and/or non-linear carbonates. In some embodiments, the co-solvents may be one or more carbonate solvents, such as one or more linear carbonates and/or non-linear carbonates, as discussed above. In some embodiments, an electrolyte composition may comprise one or more of EC at a concentration of 5% or more; FEC at a concentration of 5% or more; and/or TFPC at a concentration of 5% or more.

In some embodiments, the solvents in the electrolyte composition include, but are not limited to, one or more of ethyl methyl carbonate (EMC), methyl acetate, dimethyl carbonate (DMC), diethyl carbonate (DEC), gamma butyrolactone, methyl acetate (MA), ethyl acetate (EA), methyl propanoate, fluoro ethylene carbonate (FEC), di-fluoroethylene carbonate (DiFEC), Trifluoropropylene carbonate (TFPC), ethylene carbonate (EC), vinylene carbonate (VC) or propylene carbonate (PC). In further embodiments, the solvents include at least one of one or more of ethyl methyl carbonate (EMC), methyl acetate, dimethyl carbonate (DMC), diethyl carbonate (DEC), gamma butyrolactone, methyl acetate (MA), ethyl acetate (EA), methyl propanoate, along with at least one or more of fluoro ethylene carbonate (FEC), di-fluoroethylene carbonate (DiFEC), Trifluoropropylene carbonate (TFPC), ethylene carbonate (EC), vinylene carbonate (VC) or propylene carbonate (PC).

As used herein, a co-solvent of an electrolyte has a concentration of at least about 10% by volume (vol %). In some embodiments, a co-solvent of the electrolyte may be about 20 vol %, about 40 vol %, about 60 vol %, or about 80 vol %, or about 90 vol % of the electrolyte. In some embodiments, a co-solvent may have a concentration from about 10 vol % to about 90 vol %, from about 10 vol % to about 80 vol %, from about 10 vol % to about 60 vol %, from about 20 vol % to about 60 vol %, from about 20 vol % to about 50 vol %, from about 30 vol % to about 60 vol %, or from about 30 vol % to about 50 vol %.

For example, in some embodiments, the electrolyte may contain a fluorine-containing cyclic carbonate, such as FEC, at a concentration of about 10 vol % to about 60 vol %, including from about 20 vol % to about 50 vol %, and from about 20 vol % to about 40 vol %. In some embodiments, the electrolyte may comprise a linear carbonate that does not contain fluorine, such as EMC, at a concentration of about 40 vol % to about 90 vol %, including from about 50 vol % to about 80 vol %, and from about 60 vol % to about 80 vol %. In some embodiments, the electrolyte may comprise 1,1,2,2-tetrafluoroethyl 2,2,3,3-tetrafluoropropyl ether at a concentration of from about 10 vol % to about 30 vol %, including from about 10 vol % to about 20 vol %.

In some embodiments, the electrolyte is substantially free of cyclic carbonates other than fluorine-containing cyclic carbonates (i.e., non-fluorine-containing cyclic carbonates). Examples of non-fluorine-containing carbonates include EC, PC, GBL, and vinylene carbonate (VC).

In some embodiments, the electrolyte may further comprise one or more additives. As used herein, an additive of the electrolyte refers to a component that makes up less than 10% by weight (wt %) of the electrolyte. In some embodiments, the amount of each additive in the electrolyte may be from about 0.2 wt % to about 1 wt %, 0.1 wt % to about 2 wt %, 0.2 wt % to about 9 wt %, from about 0.5 wt % to about 9 wt %, from about 1 wt % to about 9 wt %, from about 1 wt % to about 8 wt %, from about 1 wt % to about 8 wt %, from about 1 wt % to about 7 wt %, from about 1 wt % to about 6 wt %, from about 1 wt % to about 5 wt %, from about 2 wt % to about 5 wt %, or any value in between. In some embodiments, the total amount of the additive(s) may be from about 1 wt % to about 9 wt %, from about 1 wt % to about 8 wt %, from about 1 wt % to about 7 wt %, from about 2 wt % to about 7 wt %, or any value in between. In other embodiments, the percentages of additives may be expressed in volume percent (vol %).

In some embodiments, salts may be included in the electrolyte compositions. A lithium-containing salt for a lithium-ion battery may comprise a fluorinated or non-fluorinated salt. In further embodiments, a lithium-containing salt for a lithium-ion battery may comprise one or more of lithium hexafluorophosphate (LiPF₆), lithium tetrafluoroborate (LiBF₄), lithium hexafluoroarsenate monohydrate (LiAsF₆), lithium perchlorate (LiClO₄), lithium bis(trifluoromethanesulfonyl)imide (LiTFSI), lithium bis(fluorosulfonyl)imide (LiFSI), lithium bis(oxalato) borate (LiBOB), lithium difluoro (oxalate) borate (LiDFOB), lithium triflate (LiCF₃SO₃), lithium tetrafluorooxalato phosphate (LTFOP), lithium difluorophosphate (LiPO₂F₂), lithium pentafluoroethyltrifluoroborate (LiFAB), and lithium 2-trifluoromethyl-4,5-dicyanoimidazole (LiTDI), lithium bis(2-fluoromalonato) borate (LiBFMB), lithium 4-pyridyl trimethyl borate (LPTB), lithium 2-fluorophenol trimethyl borate (LFPTB), lithium catechol dimethyl borate (LiCDMB), lithium tetrafluorooxalatophosphate (LiFOP), etc. or combinations thereof. In certain embodiments, a lithium-containing salt for a lithium-ion battery may comprise lithium hexafluorophosphate (LiPF₆). In some embodiments, the electrolyte can have a salt concentration of about 1 moles/L (M). In other embodiments, the salt concentration can be higher than 1M; in further embodiments, the salt concentration can be higher than 1.2M.

The term “alkyl” refers to a straight or branched, saturated, aliphatic radical having the number of carbon atoms indicated. The alkyl moiety may be branched or straight chain. For example, C1-C6 alkyl includes, but is not limited to, methyl, ethyl, propyl, isopropyl, butyl, isobutyl, sec-butyl, tert-butyl, pentyl, isopentyl, hexyl, etc. Other alkyl groups include, but are not limited to heptyl, octyl, nonyl, decyl, etc. Alkyl can include any number of carbons, such as 1-2, 1-3, 1-4, 1-5, 1-6, 1-7, 1-8, 1-9, 1-10, 1-11, 1-12 2-3, 2-4, 2-5, 2-6, 3-4, 3-5, 3-6, 4-5, 4-6 and 5-6. The alkyl group is typically monovalent, but can be divalent, such as when the alkyl group links two moieties together.

The term “fluoro-alkyl” refers to an alkyl group where one, some, or all hydrogen atoms have been replaced by fluorine.

The term “alkylene” refers to an alkyl group, as defined above, linking at least two other groups, i.e., a divalent hydrocarbon radical. The two moieties linked to the alkylene can be linked to the same atom or different atoms of the alkylene. For instance, a straight chain alkylene can be the bivalent radical of —(CH₂)ₙ—, where n is 1, 2, 3, 4, 5, 6, 7, 8, 9, or 10. Alkylene groups include, but are not limited to, methylene, ethylene, propylene, isopropylene, butylene, isobutylene, sec-butylene, pentylene and hexylene.

The term “alkoxy” refers to alkyl group having an oxygen atom that either connects the alkoxy group to the point of attachment or is linked to two carbons of the alkoxy group. Alkoxy groups include, for example, methoxy, ethoxy, propoxy, iso-propoxy, butoxy, 2-butoxy, iso-butoxy, sec-butoxy, tert-butoxy, pentoxy, hexoxy, etc. The alkoxy groups can be further substituted with a variety of substituents described within. For example, the alkoxy groups can be substituted with halogens to form a “halo-alkoxy” group, or substituted with fluorine to form a “fluoro-alkoxy” group.

The term “alkenyl” refers to either a straight chain or branched hydrocarbon of 2 to 6 carbon atoms, having at least one double bond. Examples of alkenyl groups include, but are not limited to, vinyl, propenyl, isopropenyl, 1-butenyl, 2-butenyl, isobutenyl, butadienyl, 1-pentenyl, 2-pentenyl, isopentenyl, 1,3-pentadienyl, 1,4-pentadienyl, 1-hexenyl, 2-hexenyl, 3-hexenyl, 1,3-hexadienyl, 1,4-hexadienyl, 1,5-hexadienyl, 2,4-hexadienyl, or 1,3,5-hexatrienyl. Alkenyl groups can also have from 2 to 3, 2 to 4, 2 to 5, 3 to 4, 3 to 5, 3 to 6, 4 to 5, 4 to 6 and 5 to 6 carbons. The alkenyl group is typically monovalent, but can be divalent, such as when the alkenyl group links two moieties together.

The term “alkenylene” refers to an alkenyl group, as defined above, linking at least two other groups, i.e., a divalent hydrocarbon radical. The two moieties linked to the alkenylene can be linked to the same atom or different atoms of the alkenylene. Alkenylene groups include, but are not limited to, ethenylene, propenylene, isopropenylene, butenylene, isobutenylene, sec-butenylene, pentenylene and hexenylene.

The term “alkynyl” refers to either a straight chain or branched hydrocarbon of 2 to 6 carbon atoms, having at least one triple bond. Examples of alkynyl groups include, but are not limited to, acetylenyl, propynyl, 1-butynyl, 2-butynyl, isobutynyl, sec-butynyl, butadiynyl, 1-pentynyl, 2-pentynyl, isopentynyl, 1,3-pentadiynyl, 1,4-pentadiynyl, 1-hexynyl, 2-hexynyl, 3-hexynyl, 1,3-hexadiynyl, 1,4-hexadiynyl, 1,5-hexadiynyl, 2,4-hexadiynyl, or 1,3,5-hexatriynyl. Alkynyl groups can also have from 2 to 3, 2 to 4, 2 to 5, 3 to 4, 3 to 5, 3 to 6, 4 to 5, 4 to 6 and 5 to 6 carbons. The alkynyl group is typically monovalent, but can be divalent, such as when the alkynyl group links two moieties together.

The term “alkynylene” refers to an alkynyl group, as defined above, linking at least two other groups, i.e., a divalent hydrocarbon radical. The two moieties linked to the alkynylene can be linked to the same atom or different atoms of the alkynylene. Alkynylene groups include, but are not limited to, ethynylene, propynylene, butynylene, sec-butynylene, pentynylene, and hexynylene.

The term “cycloalkyl” refers to a saturated or partially unsaturated, monocyclic, fused bicyclic, bridged polycyclic, or spiro ring assembly containing from 3 to 12, from 3 to 10, or from 3 to 7 ring atoms, or the number of atoms indicated. Monocyclic rings include, for example, cyclopropyl, cyclobutyl, cyclopentyl, cyclohexyl, and cyclooctyl. Bicyclic and polycyclic rings include, for example, norbornane, decahydronaphthalene and adamantane. For example, C3-C8 cycloalkyl includes cyclopropyl, cyclobutyl, cyclopentyl, cyclohexyl, cyclooctyl, and norbornane. As used herein, the term “fused” refers to two rings which have two atoms and one bond in common. For example, in the following structure, rings A and B are fused

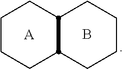

As used herein, the term “bridged polycyclic” refers to compounds wherein the cycloalkyl contains a linkage of one or more atoms connecting non-adjacent atoms.

The following structures

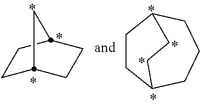

are examples of “bridged” rings. As used herein, the term “spiro” refers to two rings that have one atom in common and the two rings are not linked by a bridge. Examples of fused cycloalkyl groups are decahydronaphthalenyl, dodecahydro-1H-phenalenyl and tetradecahydroanthracenyl; examples of bridged cycloalkyl groups are bicyclo[1.1.1]pentyl, adamantanyl, and norbornanyl; and examples of spiro cycloalkyl groups include spiro[3.3]heptane and spiro[4.5]decane.

The term “cycloalkylene” refers to a cycloalkyl group, as defined above, linking at least two other groups, i.e., a divalent hydrocarbon radical. The two moieties linked to the cycloalkylene can be linked to the same atom or different atoms of the cycloalkylene. Cycloalkylene groups include, but are not limited to, cyclopropylene, cyclobutylene, cyclopentylene, cyclohexylene, and cyclooctylene.

The term “aryl” refers to a monocyclic or fused bicyclic, tricyclic or greater, aromatic ring assembly containing 6 to 16 ring carbon atoms. For example, aryl may be phenyl, benzyl or naphthyl, and may preferably be phenyl. Aryl groups may include fused multicyclic ring assemblies wherein only one ring in the multicyclic ring assembly is aromatic. Aryl groups can be mono-, di-, or tri-substituted by one, two or three radicals. Preferred as aryl is naphthyl, phenyl, or phenyl mono- or disubstituted by alkoxy, phenyl, halogen, alkyl or trifluoromethyl, especially phenyl or phenyl-mono- or disubstituted by alkoxy, halogen or trifluoromethyl, and in particular phenyl.

The term “arylene” refers to an aryl group, as defined above, linking at least two other groups. The two moieties linked to the arylene are linked to different atoms of the arylene. Arylene groups include, but are not limited to, phenylene.

The term “heteroaryl” refers to a monocyclic or fused bicyclic or tricyclic aromatic ring assembly containing 5 to 16 ring atoms, where from 1 to 4 of the ring atoms are a heteroatom such as N, O, or S. For example, heteroaryl includes pyridyl, indolyl, indazolyl, quinoxalinyl, quinolinyl, isoquinolinyl, benzothienyl, benzofuranyl, furanyl, pyrrolyl, thiazolyl, benzothiazolyl, oxazolyl, isoxazolyl, triazolyl, tetrazolyl, pyrazolyl, imidazolyl, thienyl, or any other radicals substituted, especially mono- or di-substituted, by e.g. alkyl, nitro or halogen. Pyridyl represents 2-, 3- or 4-pyridyl, advantageously 2- or 3-pyridyl. Thienyl represents 2- or 3-thienyl. Quinolinyl may preferably represent 2-, 3- or 4-quinolinyl. Isoquinolinyl may preferably represent 1-, 3- or 4-isoquinolinyl. Benzopyranyl, benzothiopyranyl may preferably represent 3-benzopyranyl or 3-benzothiopyranyl, respectively. Thiazolyl may preferably represent 2- or 4-thiazolyl, and most preferred may be 4-thiazolyl. Triazolyl may preferably be 1-, 2- or 5-(1,2,4-triazolyl). Tetrazolyl may preferably be 5-tetrazolyl.

Preferably, in example embodiments, heteroaryl is pyridyl, indolyl, quinolinyl, pyrrolyl, thiazolyl, isoxazolyl, triazolyl, tetrazolyl, pyrazolyl, imidazolyl, thienyl, furanyl, benzothiazolyl, benzofuranyl, isoquinolinyl, benzothienyl, oxazolyl, indazolyl, or any of the radicals substituted, especially mono- or di-substituted.

The term “heteroalkyl” refers to an alkyl group having from 1 to 3 heteroatoms such as N, O and S. The heteroatoms can also be oxidized, such as, but not limited to, —S(O)— and —S(O)₂—. For example, heteroalkyl can include ethers, thioethers, alkyl-amines and alkyl-thiols.

The term “heteroalkylene” refers to a heteroalkyl group, as defined above, linking at least two other groups. The two moieties linked to the heteroalkylene can be linked to the same atom or different atoms of the heteroalkylene.

The term “heterocycloalkyl” refers to a ring system having from 3 ring members to about 20 ring members and from 1 to about 5 heteroatoms such as N, O and S. The heteroatoms can also be oxidized, such as, but not limited to, —S(O)— and —S(O)₂—. For example, heterocycle includes, but is not limited to, tetrahydrofuranyl, tetrahydrothiophenyl, morpholino, pyrrolidinyl, pyrrolinyl, imidazolidinyl, imidazolinyl, pyrazolidinyl, pyrazolinyl, piperazinyl, piperidinyl, indolinyl, quinuclidinyl and 1,4-dioxa-8-aza-spiro[4.5]dec-8-yl.

The term “heterocycloalkylene” refers to a heterocyclalkyl group, as defined above, linking at least two other groups. The two moieties linked to the heterocycloalkylene can be linked to the same atom or different atoms of the heterocycloalkylene.

The term “optionally substituted” is used herein to indicate a moiety that can be unsubstituted or substituted by one or more substituent. When a moiety term is used without specifically indicating as substituted, the moiety is unsubstituted.

In one embodiment of the present disclosure, a direct coated anode using water soluble (aqueous-based) binders followed by heat treatment to convert the binder to carbon matrix is disclosed. The present disclosure addresses at least one or more of the following key advancements: 1) use of environmentally friendly water-based anode processing to allow safer, cheaper and faster processing and scalability; 2) Si dominant anodes with high Si content (>70 wt. %) for high capacity; and 3) the development of Si dominant anodes free of non-conducting binders capable of fast charging (>2C), i.e. anodes that contain only carbon and silicon. Although solvent-based anodes have had some effectiveness in improving cycle performance, these anodes may have weak adhesion to the current collector and contain non-continuous carbon media that leads to unacceptable performance. Also, although the introduction of carbon additives can somewhat improve the conductivity of the anode, the existence of carbon additives may weaken the adhesion of anode materials to the current collector. Thus, the binder plays an important role in improving the performance of silicon anodes.

Currently, polymeric binders may be used in silicon anode technologies to maintain the integrity of the anode during excessive volume changes during lithiation. For example, polyvinylidene difluoride (PVDF) is commonly used as a binder in graphite cells, but it is not capable of handling the excessive volume changes of silicon. Additionally, PVDF is soluble only in toxic organic solvents such as NMP, which require solvent recovery systems to recycle the solvent. Binders such as cellulose may also be used in conventional electrodes. However, these binders have not been successfully used in Si dominant anodes since the polymer interconnection between Si and carbon additives are not strong enough for excessive volume changes of Si. Additionally, most of the polymeric binders are soluble only in toxic organic solvents (e.g., NMP).

Some water-soluble polymers such as carboxymethyl cellulose (CMC), Styrene-Butadiene Rubber (SBR), sucrose, poly(acrylic acid) (PAA), Li-PAA, Li-CMC, aqueous Polyvinylidene fluoride (PVDF) dispersions, poly(vinyl alcohol) (PVA), starch, chitosan, lignin, and gums (e.g., xanthan gum) have been used as binders for preparing Si anodes. However, these polymers have not created a successful binder system that shows superior electrochemical performance and is capable of large-scale production.

In the present disclosure, aqueous-based polymer binders are disclosed. These polymers (also called resins) may be used as binders to fabricate silicon-based anode materials through creation of a water-based electrode slurry that is used as an electrode coating layer. These layers may be further heat-treated (pyrolyzed) or may be non-pyrolyzed. The polymer binder solution may also include various modifiers and/or additives in order to achieve the desired properties. The modifiers and/or additives include but are not limited to pH modifiers, viscosity modifiers, strengthening additives, surfactants and anti-foaming agents. The modifiers and/or additives may assist in any or all of, stabilizing, strengthening and/or adjusting the properties of the binder and may also serve as a carbon source themselves. The modifiers and/or additives may also apply in more than one category, for example, a compound may be a pH modifier and a viscosity modifier, etc.

In the present disclosure, water-soluble (aqueous-based) polymers and methods of making anodes including such polymers are disclosed. Methods for making and using water-soluble (aqueous-based) polymers involve include, but are not limited to, one or more of the following steps: aqueous based polymer solutions for electrode preparation; preparing polymer compositions with one or more additional components such as pH modifiers, viscosity modifiers, strengthening additives, surfactants and/or anti-foaming agents using water as the solvent and the preparation of slurries with Si; and using such slurries for coating of Si based anodes. In some embodiments, the anode is subjected to a heat treatment (pyrolysis). The aqueous-based (water-soluble) polymers may be used with an engineered material which is a silicon carbon composite or SiOx-based or Si-Carbon-SiOx-based powder to form slurries for battery electrodes (e.g., anodes). The electrode may be coated on a current collector.

In some embodiments, the battery electrode may comprise an electrode coating layer on a current collector, the electrode coating layer comprising a silicon carbon composite or SiOx-based or Si-Carbon-SiOx-based powder, and one or more aqueous-based polymers. In further embodiments, the electrode coating layer further comprises a conductive additive. In other embodiments, the battery electrode is an anode, where the anode may comprise silicon.

Aqueous-based (water-based) polymers (resins) useful as binders include, but are not limited to, polyimides, polyamideimides, phenolic resins (may be crosslinked), polysiloxanes, polyurethanes, polyvinyls, acrylics, polysaccharides, and derivatives thereof. The polymer binder is pyrolyzed into carbon during making of the electrode. These materials are the primary component of the binder and may function alone, or contain various additives (see below). The primary polymers (main resins) may have a carbon yield upon pyrolysis of greater than about 30%; in some embodiments the carbon yield may be 40-50% or more.

Example primary aqueous-based polymers include, but are not limited to, Polyamideimides (e.g. intl-innotek (GT-720W, GT-721W, GT-722W); China-innotek (e.g. PIW-015, PIW-025, PIW-026); Elantas (e.g. Elan-bind 1015, Elan-bind 1015 NF); Solvay Torlon AI series (e.g. AI30, AI30-LM, AI10, AI10-LM)); Polyimide; Ammonium Lignosulfonate; Kraft Lignin; Phenolic resins (e.g. Plenco (Novolac Resins); Resol Resins; Polymethylol phenol; ERPENE (phenolic resin emulsion); Formaldehyde based Resins; Melamine-formaldehyde based resins; Silane based resins (e.g. Gelest); Silicones; Polyurethanes; Poly(vinyl acetate)/poly(vinyl alcohol) complexes; TOCRYL (acrylic emulsion); Poly(methacrylic acid); Polymethyl methacrylate; ACRONAL (water-based acrylic and stryrene-acrylic emulsion) polymers; STYROFAN (carboxylated styrene-butadiene); aqueous Polyvinylidene fluoride (PVDF) dispersions, Acrylic resins; Poly(acrylic acid); Glycogen; Carbohydrates; Cellulose, Cellulose crystals (including cellulose nano-crystals); HEC (Hydroxy Ethyl Cellulose); CMHEC (Carboxy methyl hydroxy ethyl cellulose); Starch; Pullulan (polysaccharide polymer); Dextran; Chitosan; Helios Resins (includes polyester, polyacrylic, polyester and styrene/acrylic polymers; specifically DOMOPOL (polyester); DOMACRYL (polyacrylic); DOMALKYD (polyester) and DOMEMUL (styrene/acrylic)); and Rotaxane. Also contemplated are polymers having one or more of the following backbones: Sucrose, Glucose, Sucralose, Xylitol, Sorbitol, Sucralose, Glucosidases, Galactose, and Maltose.

In some embodiments, the primary aqueous-based polymers have a pyrolyzed carbon yield of over 40% after the pyrolysis process (˜300-900° C. in the absence of oxygen), where the residual carbon forms a conductive matrix in the anode to facilitate electron and ion transfer.

One component that may be utilized with the above primary aqueous-based polymer binders is a pH modifier. The pH may be modified to be more acidic or more basic using modifiers that serve as an acid or a base, respectively. The pH may be modified to affect solubility, corrosiveness of the slurry, and control reactions involving the ingredients. The pH modifiers may also serve to adjust the viscosity of the polymer solution. The pH modifiers may also have carbon residue when pyrolyzed and serve as a secondary carbon precursor. In the case where the pH modifier has a low carbon yield, the pH modifier may increase porosity within the electrode.

Example acidic pH modifiers include, but are not limited to, Mineral acids; Amic acid; Butane tetracarboxylic acid (BTC); Tetracarboxylic acid (TC); Carboxylic acid; Licanic acid; Methacrylic acid; Acetic acid; Aminomethanesulfonic acid; Anthranilic acid; Benzenesulfonic acid; Benzoic acid; Camphor-10-sulfonic acid; Citric acid; Folic acid; Formic acid; Fumaric acid; Gallic acid; Lactic acid; Maleic acid; Malonic acid; Methanesulfonic acid; Nitrilotriacetic acid; Oxalic acid; Peracetic acid; Phthalic acid; Propionic acid; phosphoric acid; Salicylic acid; Sorbic acid; Succinic acid; Sulfamic acid; Sulfanilic acid; Tannic acid; Thioacetic acid; Trifluoromethanesulfonic acid; Phosphates (including phosphate esters and phosphate diesters); Acrylic acids; Aminophenylboronic acid; Fuconic acid; Ranirestat; and Phosphatase. Acidic pH modifiers also may modify viscosity as well.

Example basic pH modifiers include, but are not limited to, Triethanolamine; Triethylamine; Tripropylamine; Tributylamine; Tripentylamine; Trihexylamine; Trioctylamine; Triphenylamine; N-Methyldiethanolamine; Butyldiethanolamine; Diethylamine; Ethylamine; Tetrabutylammonium hydroxide; Tetramethylammonium hydroxide; Tetramethylammonium hydroxide; Triisopropanolamine; Trolamine; Amino-2-propanol; Triisobutylamine; N-Isopropyl-N-methyl-tert-butylamine; 2-Amino-2-methyl-1-propanol; 1-Amino-2-butanol; 2-Amino-1-butanol; Diethanolamine; Ethanolamine; 2-Dimethylaminoethanol; N-Phenyldiethanolamine; 2-(Dibutylamino) ethanol; 2-(Butylamino) ethanol; N-tert-Butyldiethanolamine; N-Ethyldiethanolamine; Avridine; and 2-(Diisopropylamino) ethanol. Basic pH modifiers also may modify viscosity as well.

Another component that may be utilized with the above primary aqueous-based polymer binders is a viscosity modifier. Viscosity modifiers typically increase the viscosity of the slurry to ensure easy coating or other processing. The modifiers may affect thixotropic properties and render the slurry more stable. The viscosity modifiers may also have carbon residue when pyrolyzed and serve as a secondary carbon precursor. In the case where the viscosity modifier has a low carbon yield, the viscosity modifier may increase porosity within the electrode (see discussion of secondary polymers below). Additionally, any of the primary polymers listed above could be used as a viscosity modifier for any of the other primary polymers if there is a viscosity difference between them.

Example viscosity modifiers include, but are not limited to, Polyvinylalcohol; Polyols; Polyethylene-co-vinyl alcohol; Poly(allyl alcohol); Polyesters (e.g. n-butylcellosolve); Carboxymethylcellulose (CMC); Li-CMC; Myo-Inositol; Mannitol; Pinitol; Ribose; Sorbitol; Fucose; Maltodextrin; Ganglioside; Maltose; Sucrose; Glucose; Sucralose; Xylitol; Fructose; Palatinose hydrate; Dextran Sucrase; Guanosine; Inulin; Sucrose Phosphorylase; Glucosidases; AmberLite; Raffinose; Mannose; Psicose; Hexokinase; NADHs; Phosphoglucose; Phosphomannose; Topiramate; Furfurals; Nuciferine; Galactose; Maltose; and Hydroxymethylcellulose. In some embodiments, the viscosity modifier is a neutral compound.

A further component that may be utilized with the above primary aqueous-based polymer binders is a strengthening additive. Most strengthening additives are solid materials. These solids may be added to strengthen the electrode before and after heat treatment (pyrolysis or other heat treatment). Some of the additives that are conductive such as carbon and metal can also improve electrical and heat conductivity.

Example strengthening additives include, but are not limited to, Carbon nanofibers; Carbon nanotubes and carbon nanotube-based nanostructures; Conductive carbon black; Graphene; Graphene oxide; Carbon nanofibers+conductive carbon black; Carbon nanotube/carbon nanotube-based nanostructures+conductive carbon black; Carbon nanotube/carbon nanotube-based nanostructures+graphene/graphen oxide; Conductive carbon black+graphene/graphen oxide; Carbon nanotube/carbon nanotube-based nanostructures+conductive carbon black+graphene/graphen oxide; Alumina fibers, zirconia fibers; and Metal whiskers or nanowire (e.g. copper, nickel, tungsten, stainless steel) and mixtures and combinations thereof.

An additional component that may be utilized with the above primary aqueous-based polymer binders is a surfactant and/or anti-foaming agent. Surfactants help wetting of the powders and allow for better dispersion. Foaming is when air is entrained—in the case where reducing the foam is desired, an anti-foaming agent can be added.

Example surfactants include, but are not limited to, FluorN561 and FluorN562 (non-ionic polymer fluorosurfactants such as ethylene glycol based polymeric fluorosurfactants); Triton X100 (t-Octylphenoxypolyethoxyethanol); Polyvinylpyrrolidone; Detergents; Anionic surfactants (e.g. sulfate, sulfonate, and phosphate, carboxylate derivatives; such as Linear alkylbenzene sulfonates and Dioctyl sodium sulfosuccinate); Cationic surfactants (such as cetyl trimethylammonium bromide, Cetylpyridinium chloride); Zwitterionic surfactants; Ethoxylates; and Carboxy methyl cellulose (CMC), nonionic surfactants (such as TritonX and others such as Polyoxyethylene glycol, Polysorbate, Nonoxynol-9).

Example anti-foaming agents include, but are not limited to, Alcohols (e.g. ethanol, propanol, isopropanol); Oil based defoamers (e.g. mineral oil, vegetable oil, white oil, EBS, paraffin waxes, ester waxes, or fatty alcohol waxes); Fatty acid soaps; Esters; Silicone-based defoamers; and Alkyl polyacrylates. Some materials may function as both a surfactant and an anti-foaming agent.

Water soluble slurries are used containing polymers (resins) and an engineered material which is a silicon carbon composite or SiOx-based or Si-Carbon-SiOx-based powder. The resin may be used as a pyrolytic carbon source or as is (no or limited pyrolysis). As also discussed above, components of water soluble slurries include, but are not limited to, one or more of water soluble primary polymers (with or without organic base additives). These materials include, but are not limited to, polyimides; crosslinked phenolic resins; polysiloxanes; polyurethanes; polyvinyls; polyvinylpyrrolidone (and copolymers thereof); acrylic polymers; polysaccharides (and derivatives thereof); and/or other polymers.

In some embodiments, water soluble primary polymers include, but are not limited to, one or more of polyamide-imides (such as, intl-innotek (GT-720W, GT-721W, GT-722W), china-innotek (PIW-015, PIW-025, PIW-026), elantas (Elan-bind 1015, Elan-bind 1015 NF), Solvay Torlon AI series (AI30, AI30-LM, AI10, AI10-LM))

Crosslinked phenolic resins include, but are not limited to, one or more of ammonium lignosulfonate; Kraft lignin; phenolic resins (such as, Plenco (Novolac Resins)), Resol Resins, polymethylol phenol, ERPENE PHENOLIC RESIN (emulsion)); formaldehyde-based resins; and/or melamine-formaldehyde based resins.

Polysiloxanes include, but are not limited to, one or more of silane based resins (gelest), and/or silicones.

Polyurethanes include, but are not limited to, one or more of polyurethane dispersions, and/or hydrophobically modified urethane-ethoxylate (HEUR).

Polyvinyls and polyvinylpyrrolidones include, but are not limited to, one or more of poly(vinyl acetate)/poly(vinyl alcohol) complexes, vinylpyrrolidone-acrylic acid and/or copolymers thereof.

Other polymers include, but are not limited to, poly(2-ethyl-2-oxazoline), and certain resins (such as, Helios Resins (DOMOPOL [polyester], DOMACRYL [polyacrylic], DOMALKYD [polyester] and DOMEMUL [styrene/acrylic]), etc.

Acrylic polymers include, but are not limited to, one or more of poly(methacrylic acid), polymethyl methacrylate, water-based acrylic, stryrene-acrylic, vinyl acetate, styrene-butadiene emulsion polymers, carboxylated styrene-butadiene binders, acrylic Resins, poly(acrylic acid), water soluble copolymers of methacrylic acid and acrylate monomers (such as Kollicoat Mae), and/or copolymers of acrylic acid and acrylamide.

Polysaccharides include, but are not limited to, one or more of glycogen, carbohydrates, polymers with the following backbones (Sucrose, Glucose, Sucralose, Xylitol, Sorbitol, Sucralose, Glucosidases, galactose, maltose), cellulose crystals, cellulose nano-crystals, HEC (Hydroxy Ethyl Cellulose), CMHEC (Carboxy methyl hydroxy ethyl cellulose), cellulose, starch, pullulan (polysaccharide polymer), dextran, and/or chitosan.

Other materials that may be used include rotaxanes.

Organic bases include, but are not limited to, one or more of triethanolamine, methyldiethanolamine, etc. Also see further bases listed herein.

Polymer materials may or may not use a crosslinker. Crosslinkers include, but are not limited to, one or more of epoxy based crosslinkers (such as poly(propylene glycol) diglycidyl ether, 1,4-Butanediol diglycidyl ether, glycerol diglycidyl ether, glycerol diglycidyl ether), melamine formaldehyde, melamine formaldehyde-free resin (such as CYMEL® NF 3030), polyols (such as, glycerol, sorbitol, pentaerythritol), polybasic acids (such as, citric acid, pyromellitic dianhydride, pyromellitic acid, trimesic acid, diglycolic acid, maleic acid, phthalic acid, phthalic anhydride), polyamines (such as polyethylenimine (PEI)), and/or metal salts (such as AnteoX).

Acids include, but are not limited to, one or more of mineral acids, amic acid, butane tetracarboxylic acid (BTC), tetracarboxylic acid (TC), carboxylic acids, licanic acid, methacrylic acid, acetic acid, aminomethanesulfonic acid, anthranilic acid, benzenesulfonic acid, benzoic acid, camphor-10-sulfonic acid, citric acid, folic acid, formic acid, fumaric acid, gallic acids, lactic acid, maleic acid, malonic acid, methanesulfonic acid, nitrilotriacetic acid, oxalic acid, peracetic acid, phthalic acid, propionic acid, phosphoric acid, salicylic acid, sorbic acid, succinic acid, sulfamic acid, sulfanilic acid, tannic acid, thioacetic acid, trifluoromethanesulfonic acid, acrylic acids, aminophenylboronic acid, and/or fuconic acid. Also see further acids listed herein.

Structural additives can include 1D and 2D carbon additives, among other materials. Structural additives include, but are not limited to, one or more of carbon nanofibers; carbon nanotubes and carbon nanotube-based nanostructures; conductive carbon black; graphene; graphene oxide, carbon nanofibers+conductive carbon black; carbon nanotube/carbon nanotube-based nanostructures+conductive carbon black; carbon nanotube/carbon nanotube-based nanostructures+graphene/graphene oxide; conductive carbon black+graphene/graphene oxide; and/or carbon nanotube/carbon nanotube-based nanostructures+conductive carbon black+graphene/graphene oxide.

In one embodiment, the slurry composition has Si>70%; Acid<40%; Base<50%; other additives <50%, Structural additives <20%; while the final anode composition may be Si>70%; Pyrolitic carbon<30%; structural additives<40%.

Pyrolyzed electrodes may have the potential for poor mechanical properties such as adhesion, flexibility and cracking. Lowering the pyrolysis temperature may ameliorate mechanical problems but can result in poor performance mainly due to inadequate electronic conductivity of the electrode. Using certain type of additives, such as 1D and 2D carbon structures, may significantly improve the conductivity of the electrode even at low content (i.e. relatively small amounts) and low pyrolysis temperature. Additionally, decreasing the amount of polymer to be pyrolyzed (i.e. increasing the Si content) allows minimization of any negative impact of low temperature pyrolytic carbon (incomplete polymer pyrolysis). Adding a low char yield secondary polymer can also help to improve the flexibility of the electrode in cases where the primary carbon matrix remains too rigid even at lower pyrolysis temperature. In some embodiments, carbon structures such as carbon nanotubes, carbon nanofibers, graphene and other 1D, 2D, or 3D carbons are used in the electrode design to increase conductivity without sacrificing energy density.

In one embodiment, an electrode may comprise an engineered material which is a silicon carbon composite or SiOx-based or Si-Carbon-SiOx-based powder and a primary polymer which may be partially pyrolyzed at temperature >350° C. to create a matrix that remain flexible. In some embodiments, the polymer may be selected from the PI and PAI family and equivalents, including water soluble (aqueous) versions thereof. To such electrodes, a 1D or 2D carbon structure additive may be added to provide conductivity. Further, a secondary polymer with low char yield may be added to improve flexibility of the electrode. In certain embodiments, the electrode may comprise high Si content (>90%). In other embodiments, the electrode may have a maximum primary polymer content: 10%.

Advantages to electrodes having the above compositions include improvement of anode flexibility, improvement of anode adhesion, reduction of XY expansion, reduction of foaming during mixing and coating, and improved cycle life and initial Coulombic efficiency (ICE).

In an embodiment, a highly flexible Si-dominant anode may be created from a precursor comprising a water soluble (aqueous based) polymer, with a secondary polymer (sacrificial polymer) and a carbon additive, which may be a 1D or 2D carbon additive. In some embodiments, an anode is created from a water soluble polyamide imide (WPAI) solution with various additives therein. The control of pyrolysis temperature is an important feature and, in some embodiments, these electrodes may be pyrolyzed at temperatures as low as about 300 degrees Celsius. In some embodiments, the pyrolosis temperature may be from about 400-750° C., or about 400-500° C. In these materials, polymers such as polyvinyl alcohol (PVA), and/or poly ethylene oxide (PEO) may be added as secondary polymers (sacrificial polymers).

In some embodiments, the water soluble (aqueous based) polymer solution (such as WPAI) may be modified with the addition of a base such as methyl diethanolamine (MDEA). Such bases may be present in the water soluble (aqueous based) polymer solution in amounts of from about 30-60% by weight. In one embodiment, PAI water solubility and viscosity is controlled by methyl diethanolamine concentration. The latter increases pH of the binder.

Other bases that could be used to modify the water soluble polymer include, but are not limited to, Triethanolamine; Triethylamine; Tripropylamine; Tributylamine; Tripentylamine; Trihexylamine; Trioctylamine; Triphenylamine; N-Methyldiethanolamine; Butyldiethanolamine; Diethylamine; Ethylamine; Tetrabutylammonium hydroxide; Tetramethylammonium hydroxide; Tetramethylammonium hydroxide; Triisopropanolamine; Trolamine; Amino-2-propanol; Triisobutylamine; N-Isopropyl-N-methyl-tert-butylamine; 2-Amino-2-methyl-1-propanol; 1-Amino-2-butanol; 2-Amino-1-butanol; Diethanolamine; Ethanolamine; 2-Dimethylaminoethanol; N-Phenyldiethanolamine; 2-(Dibutylamino) ethanol; 2-(Butylamino) ethanol; N-tert-Butyldiethanolamine; N-Ethyldiethanolamine; Avridine; and 2-(Diisopropylamino) ethanol.

Carbon additives suitable for use in these anodes may be a 1D or 2D carbon structure, including but not limited to single-walled carbon nanotubes (SWCNT), multi-walled carbon nanotubes (MWCNT), carbon nanofibers, crosslinked carbon nanotubes (CCN). One example of a 2D carbon structure is crosslinked carbon nanotubes (CCN) which may be used in powder form or pre-dispersed in a solution such as dilute CMC. Carbon nanotubes have a high aspect ratio and high electrical conductivity, and thus could provide enough electrical conductivity for anodes. This reduces the need for pyrolytic carbon generated by treatment. With their high modulus, carbon nanotubes (CNT) are often utilized to enhance the strength of a polymer matrix. However, the low wettability and high surface area of carbon nanotubes may deteriorate the mechanical properties of the polymer matrix if the surface tension is not carefully tuned.

In one example, the PAI may be a water soluble, modified PAI that is an amic acid/amide copolymer (WPAI). Heat treatment between 200° C. to 400° C. may lead to the crosslinking of this modified PAI due to the imidization reaction or esterification reaction between amic acid and other hydroxyl group-containing polymers that may be present. Further increase in heat treatment temperature leads to thermal degradation (>≈400° C.) and carbonization (>≈600° C.) of the polymer matrix (PAI). In a further embodiment, PEO is included as a secondary polymer, with a 2D carbon additive of crosslinked carbon nanotubes (CCN). The thermal degradation of PEO starts at 320° C., and, depending on the temperature program, PEO could be degraded completely at 360° C. to 400° C. When the anode precursor containing water soluble PAI (WPAI), PEO and CCN is pyrolyzed at 400° C., PEO is removed while most PAI remains intact. Experiments show that porous structures created by removing PEO are beneficial for improving anode flexibility. If the anode is pyrolyzed at higher temperatures, the PAI will further degrade to form a pyrolytic carbon. With the degradation of the PAI structure at temperatures above 450 or 500° C., the polymer will also lose its inherent flexibility, leading to anode brittleness.

When using the above components in making an electrode slurry, the composition contains an engineered material which is a silicon carbon composite or SiOx-based or Si-Carbon-SiOx-based powder and a primary water-based (aqueous-based) polymer and may contain one or more of the above additional components in the following amounts (by weight): less than about 50% pH modifier, less than about 30% strengthening additive, less than about 50% viscosity modifier, less than about 10% surfactant, less than about 10% anti-foaming agent (percentages do not include the weight of the water). In some embodiments, the slurry contains greater than about 50% Si.

In one embodiment, an electrode may be made from an electrode slurry, where the slurry contains an engineered material which is a silicon carbon composite or SiOx-based or Si-Carbon-SiOx-based powder and a primary water-based polymer and further comprises additional components such as a pH modifier, viscosity modifier, and a surfactant.

In a further aspect, and in addition to the various modifiers and/or additives described above, the primary water-based polymers useful as binders as described above may also have another polymer present that functions as a secondary polymer. This secondary polymer may assist with control of electrode porosity by modifying the carbon yield. There may be one, or more than one, secondary polymers present.

When the direct coated silicon based anodes as described herein undergo a pyrolysis process, this may negatively affect the electrode/cell. Specifically, the pyrolysis may negatively affect any or all of (a) tensile strength of the copper current collector causing the anode to expand >1% in X and Y dimensions (and also in the Z dimension) during the cell's formation and cycling, (b) cell's cycle life, (c) cell's rate capability, and (d) adhesion of the electrode materials to the copper current collector. Most importantly, anode expansion may raise a concern regarding the safety of the cell and creates other complications such as anode disfiguration (warping or other changes) or disintegration during cycling. By controlling the porosity of the anode, the anode's expansion may be optimized, and its performance, rate capability, and adhesion may be improved. To control the porosity, secondary resins (secondary polymers) may be used. These secondary resins have a lower carbon yield with <30% contribution to the pyrolytic carbon in order to increase the overall porosity of the anode. Such anodes are shown herein to have lower X and Y expansion compared with silicon based anodes that lack a secondary polymer. On top of the reduction in the X and Y expansion, addition of a secondary resin with lower carbon yield may also improve the tensile strength, cycle life, rate capability, and adhesion of the active material to copper. In addition, an increase in the through resistance of the anode with use of the secondary resin may also be observed.

As demonstrated herein, electrodes with active material layers that are held together with certain pyrolyzed carbon show improved performance vs other electrode materials. Silicon based anodes, in particular, may have superior characteristics for one or more of energy density, cost, low temperature performance, safety, and fast charging. The silicon anodes may be made by starting with slurries where certain resins are dissolved or suspended in water (e.g. water-based polymer binders). In some embodiments, slurries that contain these resins and active materials such as engineered silicon-based materials then undergo a pyrolysis process (>500° C.) which may be advantageous for electrical conductivity, fast charge capability and cycle life compared with other commercialized and non-commercialized silicon containing anodes. In some embodiments, high carbon yield resins like polyamide-imide (PAI) and poly-imide (PI) resins may be utilized as the primary carbon precursor for both water-based slurries. The slurries may be directly coated on copper foil and calendered to form the green (or wet) anodes. These anodes may then be pyrolyzed at >500° C. (such as at about 400° C.) under inert atmosphere to form silicon based anodes which are assembled into cells. The cells may be formed and cycled at various test conditions.

As discussed above, anodes may have X, Y and Z expansion. For example, X and Y expansion may be >1%, and Z expansion may be >3% for a 5-layer ˜1 Ah cell (e.g. with 6 anodes and 5 cathodes) after formation and during cycling due to the large expansion of the engineered silicon-based materials (100-300%) during lithiation. Such expansion is undesirable as it can make designing cells more complex and potentially hurt cycle life due to weakening of the carbon matrix and disintegration of the anode during cycling. The X, Y, and Z expansion may be partially or mostly irreversible. To mitigate the anode expansion, a secondary resin may be added to the slurry. The secondary resin should have a significantly lower carbon yield compared with the main resin (e.g. PAI or PI) and contributes <30% of the pyrolytic carbon. The secondary resin creates a well-controlled porous matrix that provides enough voids for the engineered silicon-based material particles to expand and as a result reduce one or more of the X, Y and/or Z expansion.

Example secondary polymers that can be used to control the porosity of the final electrode include; but are not limited to; those polymers listed above as viscosity modifiers and also the following: Ammonium Lignosulfonate; Kraft Lignin; Formaldehyde based Resins; melamine-formaldehyde based resins; Silane based resins (gelest); silicones; polyurethanes; poly(vinyl acetate)/poly(vinyl alcohol) complexes; TOCRYL (acrylic emulsion); poly(methacrylic acid); polymethyl methacrylate; ACRONAL (water-based acrylic and stryrene-acrylic emulsion) polymers; STYROFAN (carboxylated styrene-butadiene) binders; Acrylic Resins; poly (acrylic acid); glycogen; carbohydrates (other); Cellulose crystals; cellulose nano-crystals; HEC (Hydroxy Ethyl Cellulose); CMHEC (Carboxy methyl hydroxy ethyl cellulose); cellulose; Starch; Pullulan (polysaccharide polymer); Dextran; chitosan; Helios Resins (includes polyester, polyacrylic, polyester and styrene/acrylic polymers; specifically DOMOPOL (polyester); DOMACRYL (polyacrylic); DOMALKYD (polyester) and DOMEMUL (styrene/acrylic)); rotaxane; and polymeric microbeads.

In some embodiments, a lithium-ion battery comprising an anode according to one or more embodiments described herein, may demonstrate one or more of the following advantages: increased cycle life, increased adhesion, reduced cost, improved safety, improved coulombic efficiency, increased electrical conductivity, reduced X & Y expansion, reduced Z expansion, improved porosity, improved capacity retention, improved flexibility and/or increased energy density.

In a further aspect, the water-based polymer binders and various modifiers and/or additives described herein may be utilized in a system where the solvent is eliminated or substantially reduced, resulting in a slurry where the solid content is increased. In some embodiments, the solid content of the slurry may be equal to or greater than 50%, 70%, 80%, 90% or higher. In one embodiment, the system is a solvent-free system. That is, the polymer binders may be part of an energy storage device in which no solvent is used (water or other solvent). For example, engineered silicon-based materials can be combined with a resin material in a solvent-free extrusion process or a two-step process involving deposition and hot roll pressing.

Since the solvent is reduced or eliminated, the materials would be processed under high heat, pressure, shear, and/or a combination thereof. The overall amount of polymers versus active material may also be reduced by 20%, 30%, 50% or more (due, at least in part, to not having to process the slurry in a standard low viscosity mixer) which may have performance benefits such as higher initial coulombic efficiency, higher reversible capacity, and better cycle life.

The water-based polymer binders described herein may be advantageously utilized within an energy storage device. In some embodiments, energy storage devices may include batteries, capacitors, and battery-capacitor hybrids. In some embodiments, the energy storage device comprises lithium. In some embodiments, the energy storage device may comprise at least one electrode, such as an anode and/or cathode. In some embodiments, at least one electrode may be a Si-based electrode. In some embodiments, the Si-based electrode may be a Si-dominant electrode, where silicon is the majority of the active material used in the electrode (e.g., greater than 50% silicon). In some embodiments, the energy storage device comprises a separator. In some embodiments, the separator is between a first electrode and a second electrode.

In some embodiments, the amount of silicon present in the electrode material (active material) from the engineered silicon-based material includes between about 30% and about 95% by weight, between about 50% and about 85% by weight, and between about 75% and about 95% by weight. In other embodiments, the amount of silicon in the electrode material may be at least about 30% by weight; greater than 0% and less than about 95% by weight; or between about 50% and about 95% by weight. In some embodiments, the amount of silicon is about 95-99%; about 96-99% or about 97-99%. In some embodiments, the electrode is silicon dominant (>50% silicon); in other embodiments, the amount of silicon is 70% or more.

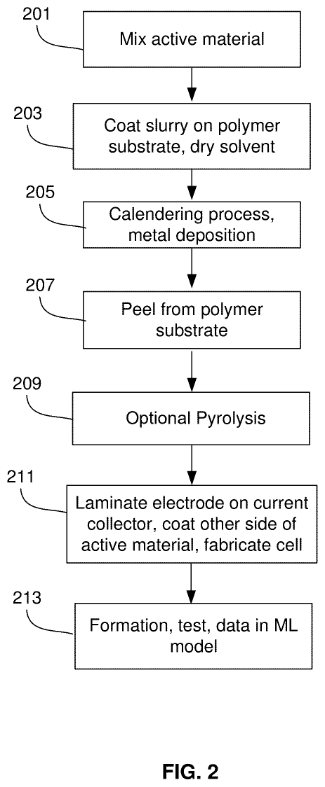

FIG. 2 is a flow diagram of a lamination process for forming a silicon-based anode cell, in accordance with an example embodiment of the disclosure. This process employs a pyrolysis process on a substrate, layer removal, and a lamination process to adhere the active material layer to a current collector. This strategy may also be adopted by other anode-based cells, such as graphite, conversion type anodes, such as transition metal oxides, transition metal phosphides, and other alloy type anodes, such as Sn, Sb, Al, P, etc.

The raw electrode active material is mixed in step 201. In the mixing process, the active material may be mixed with a binder/resin (such as water-soluble polyimide (PI), polyamideimide (PAI), Phenolic or other water-soluble resins and mixtures and combinations thereof), solvent, rheology modifiers, surfactants, pH modifiers, and conductive additives to form a slurry to use as an electrode coating layer. The materials may comprise carbon nanotubes/fibers, graphene sheets, metal polymers, metals, semiconductors, and/or metal oxides, for example. In one embodiment, engineered silicon-based material, for example, may then be dispersed in polyamic acid resin, polyamideimide, or polyimide (15-25% solids in N-Methyl pyrrolidone (NMP) or DI water) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30-40%. Particle sizes may be either as the D50 (median diameter), and/or as the size range—D10 to D90). The pH of the slurry can be varied from acidic to basic, which may be beneficial for controlling the solubility, conformation, or adhesion behavior of water-soluble polyelectrolytes, such as polyamic acid, carboxymethyl cellulose, or polyacrylic acid. Ionic or non-ionic surfactants may be added to facilitate the wetting of the insoluble components of the slurry or the substrates used for coating processes.

The particle size and mixing times may be varied to configure the electrode coating layer density and/or roughness. Furthermore, cathode electrode coating layers may be mixed in step 201, where the electrode coating layer may comprise lithium cobalt oxide (LCO), lithium iron phosphate, lithium nickel cobalt manganese oxide (NMC), Ni-rich lithium nickel cobalt aluminum oxide (NCA), lithium manganese oxide (LMO), lithium nickel manganese spinel, LFP, Li-rich layer cathodes, LNMO or similar materials or combinations thereof, mixed with carbon precursor and additive as described above for the anode electrode coating layer.

In step 203, the slurry may be coated on a substrate. In this step, the slurry may be coated onto a Polyester, polyethylene terephthalate (PET), or Mylar film at a loading of, e.g., 2-4 mg/cm² and then undergo drying to an anode coupon with high Si content and less than 15% residual solvent content. This may be followed by an optional calendering process in step 205, where a series of hard pressure rollers may be used to finish the film/substrate into a smoother and denser sheet of material.

In step 207, the green film may then be removed from the PET, where the active material may be peeled off the polymer substrate, the peeling process being optional for a polypropylene (PP) substrate since PP can leave ˜2% char residue upon pyrolysis. The peeling may be followed by an optional pyrolysis step 209 where the material may be heated to 400-1250C for 1-3 hours, cut into sheets, and vacuum dried using a two-stage process (120° C. for 15 h, 220° C. for 5 h). Pyrolysis may be full or partial. In some embodiments, no pyrolysis is performed.

In step 211, the electrode material may be laminated on a current collector. For example, a 5-20 μm thick copper foil may be coated with polyamide-imide with a nominal loading of, e.g., 0.2-0.6 mg/cm² (applied as a 6 wt % varnish in NMP and dried for, e.g., 12-18 hours at, e.g., 110° C. under vacuum). The anode coupon may then be laminated on this adhesive-coated current collector. In an example scenario, the silicon-carbon film is laminated to the coated copper using a heated hydraulic press. An example lamination press process comprises 30-70 seconds at 300° C. and 3000-5000 psi, thereby forming the finished silicon-based electrode.

In step 213, the cell may be assessed before being subject to a formation process. The measurements may comprise impedance values, open-circuit voltage, and thickness measurements. During formation, the initial lithiation of the anode may be performed, followed by delithiation. Cells may be clamped during formation and/or early cycling. The formation cycles are defined as any type of charge/discharge of the cell that is performed to prepare the cell for general cycling and is considered part of the cell production process. Different rates of charge and discharge may be utilized in the formation steps.

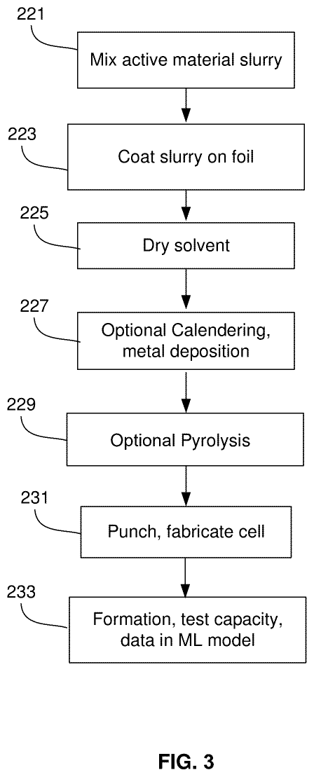

FIG. 3 is a flow diagram of a direct coating process for forming a silicon-based anode cell, in accordance with an example embodiment of the disclosure. This process comprises physically mixing the active material, conductive additive, and binder together, and coating it directly on a current collector before pyrolysis. This example process comprises a direct coating process in which an anode or cathode slurry is directly coated on a copper foil using a binder.

In step 221, the active material may be mixed, e.g., a binder/resin, solvent (such as DI water, or other environmentally benign solvents or their mixtures and combinations thereof), and conductive additives. The materials may comprise carbon nanotubes/fibers, graphene sheets, metal polymers, metals, semiconductors, and/or metal oxides, for example. Engineered silicon-based materials for example, may then be dispersed in a polymer binder solution at, e.g., 1000 rpm for, e.g., 10 minutes, and then the conjugated carbon/solvent slurry may be added and dispersed.

Furthermore, cathode active materials may be mixed in step 221, where the active material may comprise lithium cobalt oxide (LCO), lithium iron phosphate, lithium nickel cobalt manganese oxide (NMC), lithium nickel cobalt aluminum oxide (NCA), lithium manganese oxide (LMO), lithium nickel manganese spinel, or similar materials or combinations thereof, mixed with a binder as described above for the anode active material.

In step 223, the slurry may be coated on copper foil. In the direct coating process described here, an anode slurry is coated on a current collector with residual solvent followed by a calendering process for densification. Similarly, cathode active materials may be coated on a foil material, such as aluminum, for example. The active material layer may undergo drying in step 225 resulting in reduced residual solvent content. An optional calendering process may be utilized in step 227 where a series of hard pressure rollers may be used to finish the film/substrate into a smoother and denser sheet of material. In step 227, the foil and coating proceed through a roll press for lamination.

In step 229, the active material may be optionally pyrolyzed by heating to 400-1000° C. such that carbon precursors are partially or completely converted into glassy carbon. Pyrolysis can be done either in roll form or after punching. If done in roll form, the punching is done after the pyrolysis process. The pyrolysis step may result in an anode active material having silicon content greater than or equal to 50% by weight, where the anode has been subjected to heating at or above 400 degrees Celsius. In an example scenario, the anode active material layer may comprise 20 to 95% silicon and in yet another example scenario may comprise 50 to 95% silicon by weight. In instances where the current collector foil is not pre-punched/pre-perforated, the formed electrode may be perforated with a punching roller, for example. The punched electrodes may then be sandwiched with a separator and electrolyte to form a cell. In some embodiments, the anode active material has silicon content greater than or equal to 70% by weight. Additionally, in some embodiments, pyrolysis may be performed at a lower temperature, such as between about 300-900° C., about 300-750° C., about 300-500° C. or about 300-400° C.

Further, once pyrolyzed, the remainder of the anode (that is not silicon) may be pyrolytic carbon. In some embodiments, when strengthening additives are utilized, the remainder of the anode that is not silicon may comprise both pyrolytic carbon and strengthening additives. In some embodiments, the amount of pyrolytic carbon may be less than or equal to 30%; or be less than or equal to 15%. When strengthening additives are present, the amount of strengthening additives may be less than or equal to 30%.

In step 233, the cell may be assessed before being subject to a formation process. The measurements may comprise impedance values, open-circuit voltage, and thickness measurements. During formation, the initial lithiation of the anode may be performed, followed by delithiation. Cells may be clamped during formation and/or early cycling. The formation cycles are defined as any type of charge/discharge of the cell that is performed to prepare the cell for general cycling and is considered part of the cell production process. Different rates of charge and discharge may be utilized in the formation steps.

In some aspects, energy storage devices such as batteries are provided. In some embodiments, the energy storage device includes a first electrode and a second electrode, wherein at least one of the first electrode and the second electrode is a Si-based electrode. In some embodiments, the energy storage device includes a separator between the first electrode and the second electrode. In some embodiments, the energy storage device includes an electrolyte, which may be provided as an electrolyte composition. Pyrolysis may be full or partial. In some embodiments, no pyrolysis is performed.

In some embodiments, the battery may be capable of at least 200 cycles with more than 80% cycle retention when cycling with a C-rate of >2C cycling between an upper voltage of >4V and a lower cut-off voltage of <3.3V. In other embodiments, the battery may be capable of at least 200 cycles with more than 80% cycle retention when cycling with a C-rate of >2C cycling between an upper voltage of >4V and a lower cut-off voltage of <3.3V.

Example devices and processes for device fabrication are generally described below, and the performances of lithium-ion batteries with different electrode compositions may be evaluated. Slurry properties with various additives and modifiers may be assessed.

Advantages of the anodes of the present disclosure include, but are not limited to, (1) improved cycle life; (2) anode expansion; (3) improved initial coulombic efficiency (ICE) and cycled capacity with reduced N/P ratio; (4) improved ED; (5) anode flexibility; (6) fast charge capability; (7) no pre-lithiation needed; and/or (8) reduced XY expansion.

### Non-Pyrolyzed Anode

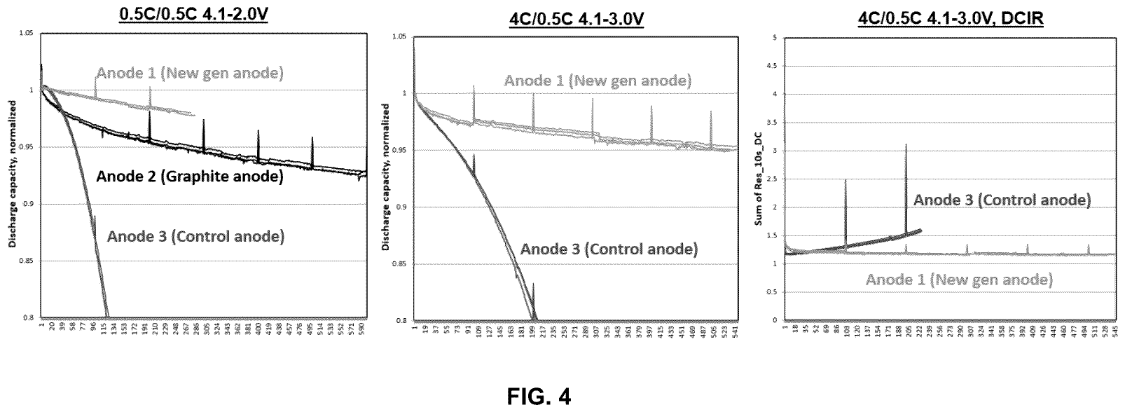

Anode 1 in single-layer and 5-layer cells: Anode 1 which used engineered silicon-based material in non-pyrolyzed form demonstrated promising cycling results in both 0.5C charge and 4C charge cycling tests. See FIG. 4. Anode 1 showed much less DCIR increase compared to the control anode in the 4C charge cycling test.

The anode formulation in the Anode 1 is as follows: silicon-carbon composite 1 (engineered material)/Carboxymethyl Cellulose (CMC)/Styrene-Butadiene Rubber (SBR)/single wall carbon nanotubes (SWCNT)/Dispersant/graphite=80.25/1.5/3/0.5/0.75/14, the areal specific loading is 6.49 mg/cm². N/P ratio between the anode/cathode areal capacity=2.0. The density of the anode active material layer=0.98 g/cc. The anode dry resistance is 0.095 ((dry resistance is measured by sandwiching 16 mm diameter anode disk between two blocking electrodes with a diameter of 9.98 mm and area of 0.78 cm² at a pressure of 14.5 psi). In this case, the anodes were not heat-treated beyond the normal drying conditions during coating.

The formulation of the Anode 2 (graphite anode) is graphite/carboxymethyl cellulose (CMC)/styrene-butadiene rubber (SBR)=96.9/1.1/1.5/0.8. The areal specific loading is 15.03 mg/cm². N/P ratio between the anode/cathode areal capacity=1.2. The formulation of Anode 3 (control anode) is Si/pyrolytic carbon=90/10. The areal specific loading is 3.43 mg/cm². The density of the anode active material layer=1.07 g/cc. N/P ratio between the anode/cathode areal capacity=2.5. The anode dry resistance is 0.55Ω. This anode was pyrolyzed at 650° C. for 3 hrs under argon.

The anodes were cycled against a LiNi_{0.8}Mn_{0.1}Co_{0.1}O₂ (NMC811) cathode (94% active ratio and 22.5 mg/cm² loading) in a pouch cell format. Formation of cells was performed at 1C for charge and 1C for discharge in the 4.1-2.0 V voltage range, with a 0.05C current taper at the end of charge and a 0.2C current taper at the end of discharge. Constant current cycling was performed in both 4.1-2.0 V and 4.1-3.0 V voltage range. Charge rate used 0.5C and 4C, respectively. Discharge rate for both tests was 0.5C. Cell capacity was 0.078 Ah.

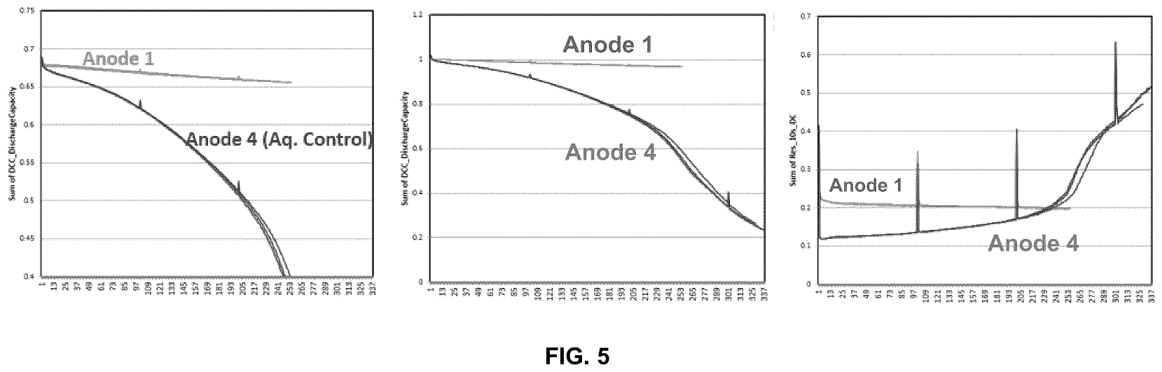

Anode 1 was also tested in 5-layer cells and demonstrated significantly improved cycle life compared to the control anode in the 4C charge cycling tests. See FIG. 5. Anode 1 also showed much less DCIR increase compared to the control anode in the 4C charge cycling test.

In further testing, Anode 1 has the same formulation as described above. The areal specific loading is 6.18 mg/cm². N/P ratio between the anode/cathode areal capacity=1.9. The density of the anode active material layer=1.14 g/cc. The formulation of the Anode 4, aqueous control anode is Si/super P/pyrolytic carbon=94/2/4. The areal specific loading is 3.46 mg/cm². The density of the anode active material layer =1.14 g/cc. N/P ratio between the anode/cathode areal capacity=2.5. This anode was pyrolyzed at 700° C. for 2 hrs under forming gas.

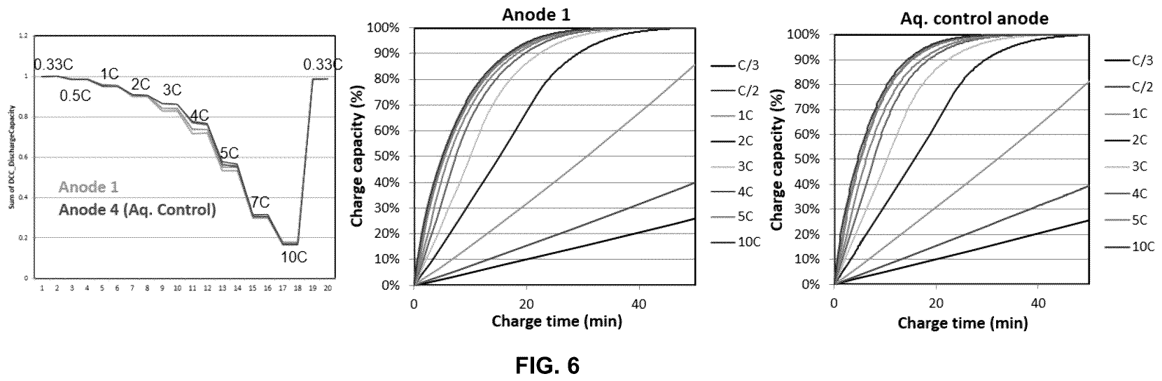

Additionally, charge and discharge rate tests were also performed. Anode 1 showed similar discharge and charge rate performance as Anode 4 aqueous control anode. See FIG. 6. In particular, at the charge rate of 4C, Anode 1 can reach 81% of charge capacity in 15 minutes while the aqueous control anode can reach 83%.

Anode XY dimensions were measured after formation. Anode 1 was found to have 0.05% expansion along the X and 0.03% expansion along the Y. In comparison, Anode 4 had 1.25% expansion along the X and 1.14% expansion along the Y. Thus Anode 1 of the present invention showed much improvement on anode expansion.

The anodes were cycled against a LiNi_{0.8}Mn_{0.1}Co_{0.1}O₂ (NMC811) cathode (94% active ratio and 22.5 mg/cm² loading) in a pouch cell format. Formation of cells was performed at 1C for charge and 1C for discharge in the 4.1-2.0 V voltage range, with a 0.05C current taper at the end of charge and a 0.2C current taper at the end of discharge. Constant current cycling was performed in the 4.1-2.5 V voltage range for Anode 1 and 4.1-3.0 V voltage range for the Anode 4 aqueous control. The two anodes used different voltage ranges to ensure they cycle at the same capacity. Charge rate used 4C and discharge rate for both tests was 0.5C. Cell capacity was about 0.78 Ah. For the discharge rate test, cells were charged at 0.5C to 4.1V until 0.05C and then discharge at each rate shown in the figure to 2.5 V. For the charge rate test, cells were charged at each rate shown in the figure to 4.1 V until 0.05C and then discharged at 0.5C to 2.5 V. For both discharge and charge rate tests, there was a 20 minute rest at the end of both charge and discharge.

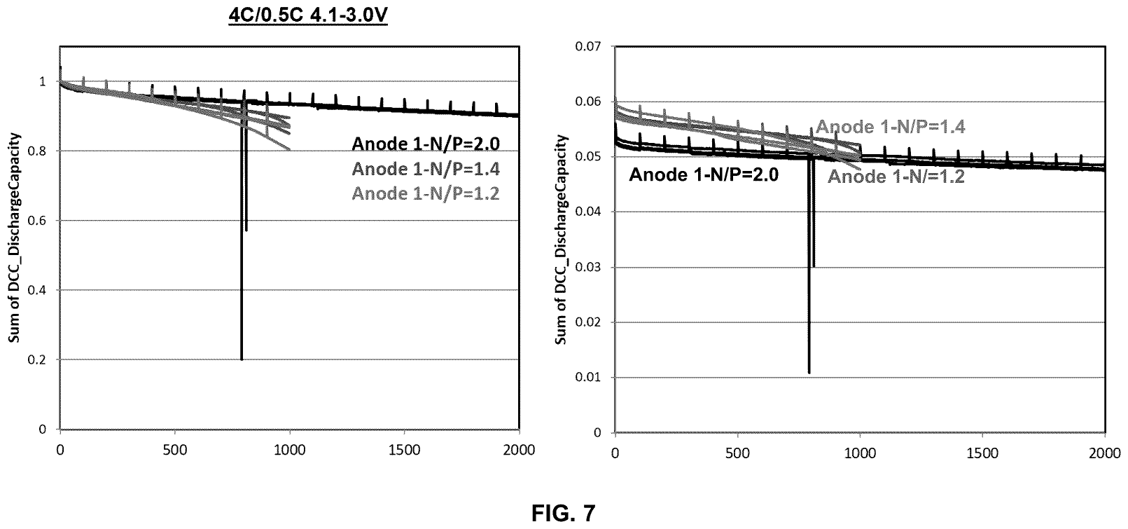

Anode 1 N/P ratio study: Anode 1 formulation was tested at three N/P ratios, 2.0, 1.4 and 1.2. See FIG. 7. From the initial cycling data, the N/P of 1.2 and 1.4 cycled at slightly higher capacity. The ICE of N/P of 2.0, 1.4 and 1.2 was found to be 80.6%, 83.8% and 83.6%. This indicates that lower N/P benefits the capacity.

The anodes were cycled against a LiNi_{0.8}Mn_{0.1}Co_{0.1}O₂ (NMC811) cathode (94% active ratio and 22.5 mg/cm² loading) in a pouch cell format. Formation of cells was performed at 1C for charge and 1C for discharge in the 4.1-2.0 V voltage range, with a 0.05C current taper at the end of charge and a 0.2C current taper at the end of discharge. Constant current cycling was performed in the 4.1-3.0 V voltage range. Charge rate used 4C, respectively. Discharge rate for both tests was 0.5C. Cell capacity was 0.078 Ah.

### Pyrolyzed Anode

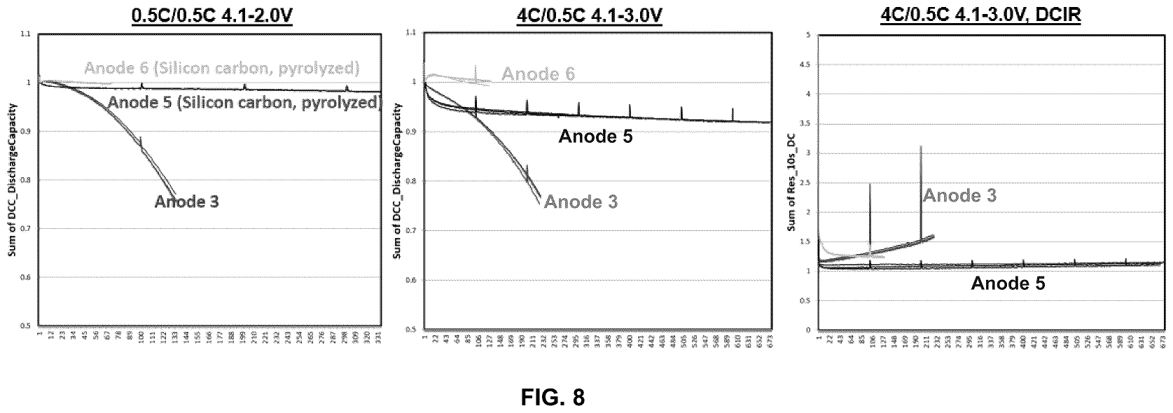

In a separate study, the silicon carbon composite 1 that was tested in the pyrolyzed form above also demonstrated better performances than the control anode. See FIG. 8. Both Anode 5 and Anode 6 had better retention and less DCIR increase compared to Anode 3.

The formulation of Anode 5 (silicon carbon anode) is as follows: silicon-carbon composite 1/pyrolitic carbon=90/10. The areal specific loading is 6.6 mg/cm². N/P ratio between the anode/cathode areal capacity=2.5. The density of the anode active material layer=0.90 g/cc. The anode dry resistance is 1.1Ω. The pyrolysis condition was 600° C. for 2 hours under Ar/H2 forming gas.

The formulation of the Anode 6 (silicon carbon anode) is as follows: silicon-carbon composite 1/pyrolitic carbon/SWCNT=92/5.6/0.4. The areal specific loading is 6.25 mg/cm². N/P ratio between the anode/cathode areal capacity=2.2. The density of the anode active material layer=0.77 g/cc. The anode dry resistance is 1.82Ω. The pyrolysis condition was 400° C. for 5 hours under Ar/H2 forming gas. Anode 3 is described above.

The anodes were cycled against a LiNi_{0.8}Mn_{0.1}Co_{0.1}O₂ (NMC811) cathode (94% active ratio and 22.5 mg/cm² loading) in a pouch cell format. Formation of cells was performed at 1C for charge and 1C for discharge in the 4.1-2.0 V voltage range, with a 0.05C current taper at the end of charge and a 0.2C current taper at the end of discharge. Constant current cycling was performed in both 4.1-2.0 V and 4.1-3.0 V voltage range. Charge rate used 0.5C and 4C, respectively. And discharge rate for both tests was 0.5C. Cell capacity was 0.078 Ah.

### Silicon

In some embodiments, the silicon in the electrode is amorphous or

substantially amorphous and not substantially crystalline. The criteria to establish a substantially amorphous material include XRD or Raman analysis. XRD or Raman can be used to estimate crystallinity, for example, Hinrichen's method can be used with XRD. Also, the crystallite size can be determined from the full width at half maxima (FWHM), calculated directly or by using the Scherrer equation with XRD. Crystallinity of below 50% is substantially amorphous, however below 25% may be preferred and below 10% may be more preferred. Similarly, a crystallite size of <20 nm may be preferred while <10 nm may be more preferred. For Raman analysis, an FWHM of 4 cm-1 or higher may indicate substantially amorphous material with material that may preferably be 5 cm-1 or higher and, may be more preferably 6 cm-1 or higher.

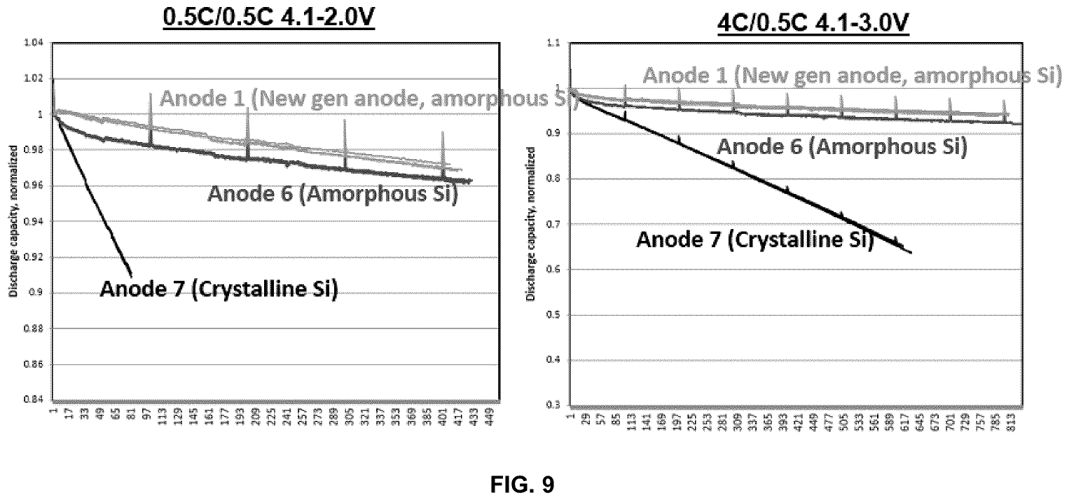

In a separate study, the effect of silicon crystallinity was examined. The active material used in Anode 1 and Anode 6 are both nano amorphous silicon, while the silicon in the Anode 7 is crystalline. As shown in FIG. 9, both amorphous Si anodes showed better retention than the crystalline Si anode.

The anode formulation in Anode 6 is as follows: silicon-carbon composite 2/carboxymethyl cellulose (CMC)/styrene-butadiene rubber (SBR)/single wall carbon nanotubes (SWCNT)/dispersant/graphite=80.25/1.5/3/0.5/0.75/14, the areal specific loading is 6.73 mg/cm². N/P ratio between the anode/cathode areal capacity=2.5. The density of the anode active material layer=1.02 g/cc. The anode dry resistance is 0.044Ω. In this case, the anodes were not heat-treated beyond the normal drying conditions during coating.

The anode formulation in Anode 7 is as follows: silicon-carbon composite 3/carboxymethyl cellulose (CMC)/styrene-butadiene rubber (SBR)/single wall carbon nanotubes (SWCNT)/dispersant/graphite=80.25/1.5/3/0.5/0.75/14, the areal specific loading is 7.65 mg/cm². N/P ratio between the anode/cathode areal capacity=2.3. The density of the anode active material layer=1.24 g/cc. The anode dry resistance is 0.034Ω. In this case, the anodes were not heat-treated beyond the normal drying conditions during coating.

The anodes were cycled against a LiNi_{0.8}Mn_{0.1}Co_{0.1}O₂ (NMC811) cathode (94% active ratio and 22.5 mg/cm² loading) in a pouch cell format. Formation of cells was performed at 1C for charge and 1C for discharge in the 4.1-2.0 V voltage range, with a 0.05C current taper at the end of charge and a 0.2C current taper at the end of discharge. Constant current cycling was performed in both 4.1-2.0 V and 4.1-3.0 V voltage range. Charge rate used 0.5C and 4C, respectively. And discharge rate for both tests was 0.5C. Cell capacity was 0.078 Ah.

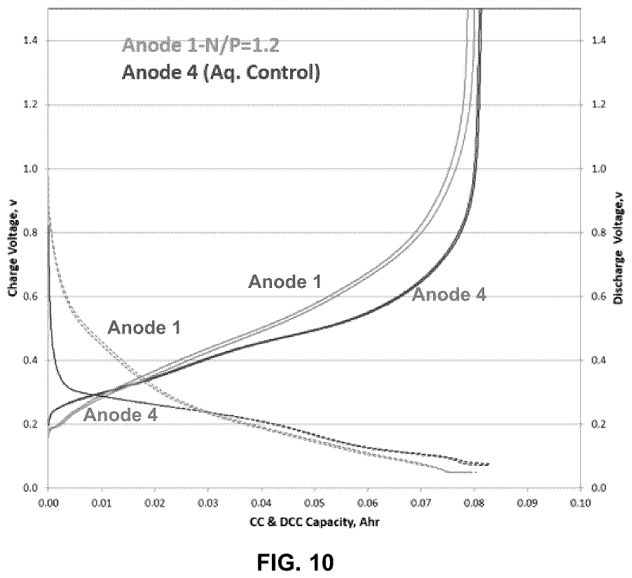

FIG. 10 shows the lithium half-cell data of Anode 4 (Aq. control) vs. Anode 1-N/P=1.2. When the two anodes are lithiated to the same capacity, Anode 1 has a lower ending voltage. This means that when the full cells that are built with the same cathode but with these two different anodes have the same voltage during charge, the cathode that pairs with Anode 1 would reach a lower voltage at the end of charge. The cell level performance at elevated temperature (gassing, capacity recovery, DCIR growth, etc) is very dependent on cathode voltage. Since Anode 1 has lower ending voltage, it is possible to increase the cell upper voltage cutoff (increase cell capacity and energy density) without pushing the cathode voltage too high.

Half cells were built using lithium metal as the counter electrode. The anodes were lithiated at 11 mA to 90 mAh (NMC811 cathode capacity, to mimic the anode utilization in a full cell) or to 0.05V until 1.1 mA, and then de-lithiated to 1.5 V. On the next cycle and following cycles, the lithiation capacity equals the de-lithiation capacity of the last cycle.

### Binders

Four Examples of binder systems proposed herein in the case of anode designs that do not utilize heat-treatment beyond normal drying conditions are as follows: (1) Single-component binder systems: CMC, HPC, PVA, polyacrylamide, poly(2-ethyl-2-oxazoline), and PVP; (2) Binder systems containing both thickeners and highly flexible binder dispersions: Thickeners include HPC, CMC, PVA, polyacrylamide, acrylamide/acrylic acid random copolymers and their salts, poly(2-ethyl-2-oxazoline). High flexibility binders could be SBR, PUD, or other latex materials; (3) Binder systems with strong cohesion: When binders containing a high content of hydroxyl groups or amine are mixed with binders containing a high content of COOH groups, the hydrogen bonding between OH/COOH or amine/COOH will provide extra cohesion of the polymer matrix. Binders with high quantities of OH groups and amine include PVP, CMC, PVA, HPC, or their copolymers. Binders with high contents of COOH groups include polyamic acid, PAA, lithium PAA, copolymers of acrylic acid and methacrylic acid, and their salts such as poly(acrylamide-co-acrylic acid); (4) Chemically crosslinked binder systems: When heated at high temperatures, COOH and OH groups from different polymer/crosslinkers can undergo an esterification reaction and crosslink together. Molecules containing multiple epoxy groups such as poly(ethylene glycol) diglycidyl ether can also react with COOH groups and crosslink binders with COOH groups mentioned above. Besides, melamine formaldehyde can be used to crosslink binders containing OH, primary amine, and secondary amine groups. See also listing of crosslinkers above.

Among all the four categories of polymer binder, category 3 and category 4 are most preferable for anode building. The strong physical interaction or covalent bonding between binders helps maintain the anode structure during Si expansion/shrinkage. Binder system 2 introduces highly flexible/elastic polymer dispersions which also help mitigate the matrix deterioration during cycling.

For binder system 1, water-soluble polymers such as CMC, HPC, and polyacrylamide with very high Tg and rigid polymer chains are the lea st preferable as binder material to accommodate Si expansion/shrinkage during cycling. However, water-soluble polymers with relatively flexible chain structures such as PVA, Poly(2-ethyl-2-oxazoline), and water-soluble that can be plasticized by electrolytes such as PVP and its copolymer will show more accommodation to the Si volume change than rigid polymers. Thus, they are more suitable as binders for anodes.

The processability of anode slurry also plays a pivotal role in the development of scalable Si-based anodes. In binder systems 3, if the hydrogen bonding between 2 different polymers is too strong, gelation of slurry will happen. Consequently, the slurry cannot be coated through the roll-to-roll or slot-die coating method. To mitigate the gelation issue, polymer solution concentration, molecule weight of polymers and functional groups density along the polymer chain could be adjusted. For example, high molecular weight PAA can be used to pair with low molecule weight PVA to mitigate the gelation issue. Neutralization of COOH groups on PAA chain with other counter ions such as NH4+, Li+ will help reduce the gelation issue.

Polymer binders that are coated on Si-carbon composite particles or SiOx-based materials may block the ion transport towards particles during the cycling of cells. On the other hand, the lack of polymer binders may decrease the matrix strength and adhesion to the current collector of anodes. Thus, the content of the polymer inside the anodes significantly affects the cell performance. The weight percentage of polymer binder in anodes may be between 1% to 20%, and may preferably be between 3% to 15%, and may more preferably be between 4% to 8%.

Binder precursor materials for anode designs that utilize heat-treatment above normal drying conditions include: Polyimide, Polyamide-imide, phenolic resin, melamine formaldehyde resin, polyacrylonitrile, lignin-based polymers, Polysaccharide, PVMMA, tannin acid, humic acid etc.

In the case of anodes utilizing heat treatment above normal drying conditions, sacrificial polymers can be added to tune anode porosity/morphology. Other than Binder precursors which carbonize during heat treatment, the majority of sacrifice polymers decompose during heat treatment. Materials that are applied as sacrificial polymers include PEO, PVP, PVA, all acrylic latex, styrene-acrylic latex, and other materials that can decompose under 450° C.

### Additives

Conductive additives are used to reduce the surface roughness of the anode surface and to assist electrical conductivity of the electrode. Increasing the surface roughness of the anode can lead to a higher risk of short circuits and thermal runaway compromising the safety of the cell. The additive content can be adjusted from 0 to 20 wt %, and as the additive content increases, the surface roughness decreases, creating a smooth anode surface. Graphite can be used as a type of additive, and other ceramic materials such as Mg(OH)₂, AlO(OH), Al₂O₃, and TiO₂ can also be used.

In order to reduce surface roughness, the particle size of the additive is important. The more additives are added, the lower the surface roughness value is, and a flat anode surface can be obtained.

In some embodiments, the median particle size (D50) may be in the range of 1˜20 5 μm, while in a further embodiment, the median particle size (D50) may be in the range of 2˜8 5 μm.

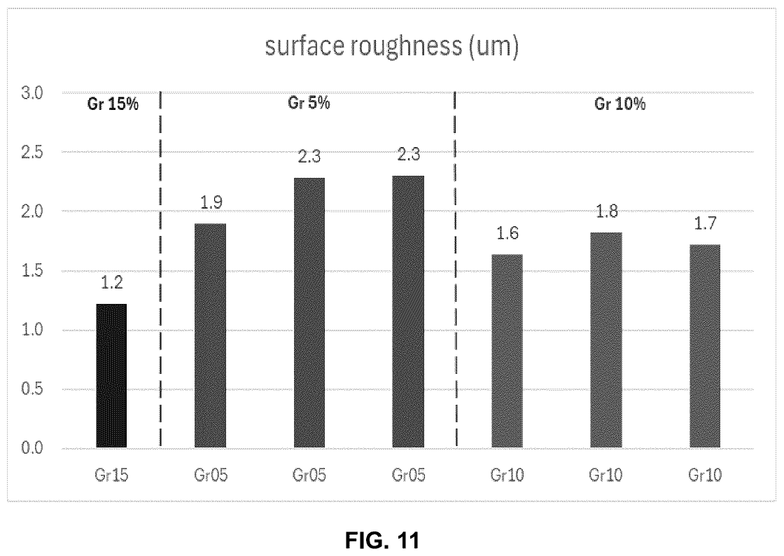

Surface roughness Sa (arithmetical mean height) when no additives were used was 2.5 μm, when 5% additives were used, Sa was 2.2 5 μm, and when 10% additives were used, Sa was 1.7 5 μm. When 15% additive content was used, the value was 1.2 5 μm. The additive used at those experiments was IMERYS SFG6L (D50˜3.6 5 μm), a synthetic graphite. FIG. 11 shows changes in the surface roughness of the electrode as a function of graphite additive. The range of graphite content is from about 0% to about 30%, about 0% to about 20%, or may preferably be about 0% to about 14% by weight.

### FURTHER EMBODIMENTS AND IMPORTANT FACTORS

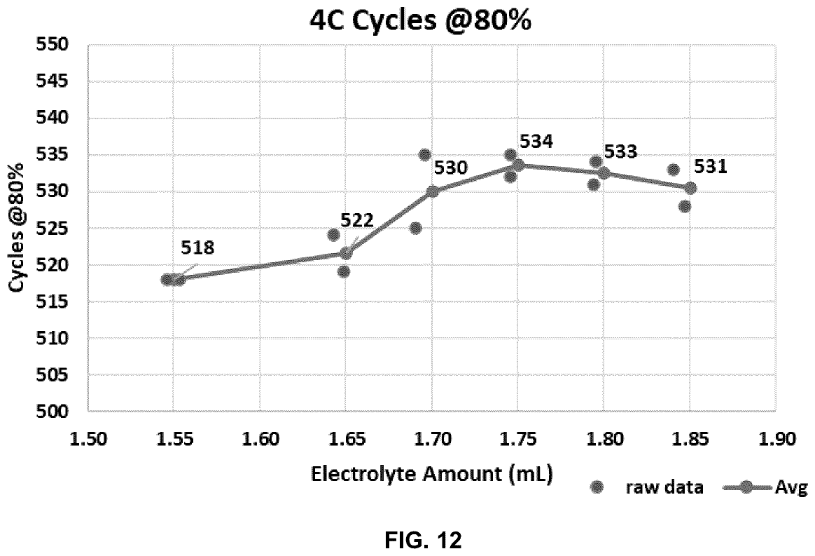

Electrolyte embodiment: In one embodiment with good performance, the electrolyte amount may be 2.60-2.90 grams/A and the EL amount: 2.60-2.90 g/Ah. See Table 2 below and FIG. 12.

TABLE 2

| | EL weight, | | | 4 C cycle to 80% |
|---|---|---|---|---|
| EL volume, cc | gram | g/Ah | Capacity, Ah | SOH |
| 1.5 | 1.935 | 2.38 | 0.816 | 518 |
| 1.6 | 2.064 | 2.53 | 0.817 | 522 |
| 1.65 | 2.1285 | 2.61 | 0.814 | 530 |
| 1.7 | 2.193 | 2.69 | 0.813 | 534 |
| 1.75 | 2.2575 | 2.77 | 0.815 | 533 |
| 1.8 | 2.322 | 2.85 | 0.813 | 531 |
| Density | 1.29 | g/cc | | |
| Capacity | 0.815 | Ah | | |

To deliver optimal battery performance, electrolyte may be comprised of materials previously studied for pyrolyzed silicon dominant anodes. The details of these formulations can be found from previous filings such as U.S. patent application Ser. No. 17/193,850, entitled “Method And System For Safety Of Silicon Dominant Anodes”; U.S. patent application Ser. No. 18/669,350, entitled “Electrolyte Formulations for Optimal Performance in Si-Containing Lithium Ion Batteries”; and U.S. patent application Ser. No. 18/412,293, entitled “Electrolyte Compositions for Batteries”; the entirety of each is hereby incorporated by reference.

Formation regime: Formation charging using >0.1C current (prefer to use ≥1C current) between 30% SOC to 100% SOC with or without constant voltage step. Formation discharge using >0.1C current (prefer to use ≥1C current) down to 2.0V with or without constant voltage step. Or the formation discharging step may be omitted. For the formation step with a temperature range between 0-65 degC (prefer to use 20-45 degC).

Formation pressure: Constant pressure (using spring clamping technique) with a pressure range between 50 and 3000 kPa (prefer to use 400-2000 kPa). Constant gap using foam pad(s), with initial applied pressure range between 0-1000 kPa (prefer to use 100-500 kPa) and final pressure at 100% SOC between 0 and 2000 kPa (prefer to control 200-1000 kPa).

Cycling pressure: Constant gap using foam pad(s) with initial pressure at BOL between 0 and 500 kPa (prefer 50-200 kPa) and final pressure at EOL between 100 and 1000 kPa (prefer to control between 100-400 kPa). Constant pressure with applied pressure between 0-500 kPa (prefer between 50-200 kPa)

Separator: Use separators with a thickness of 4-25 microns (prefer to use adhesive-coated CCS separator(s) with 9-20 microns thickness). Lamination with wet or dry lamination process with and without heat (prefer a wet process with heat and cold lamination). Provide good adhesion between the separator and electrode to reduce the resistance and minimize the anode expansion. Preference: adhesive-ccs>pcs>ccs>PE/PP. General expected properties: porosity, tortuosity, mechanical strength, Gurley no. and so. (measurement of how quickly air goes through a separator using a standard machine).

Summary of properties is in Table 3. In some embodiments the target range is achieved; while in others the preferred range is achieved.

TABLE 3

| Property | | | | |
|---|---|---|---|---|
| group | Properties | Target | | Preferred range |
| Physical | Air permeability (s/100 ml) | ≤300 s/100 ml | | ≤200 s/100 ml |
| properties | Porosity | ≥38% | | ≥45% |
| Mechanical | Tensile (mechanical) | TD | >50 kgf/cm2 | >prefer 1000 |
| properties | strength | | | kgf/cm2 |
| | | MD | >50 kgf/cm2 | >prefer 1000 |
| | | | | kgf/cm2 |

| | | |
|---|---|---|
| Puncture strength (grams): | >100 g | >300 g |

One embodiment comprises an anode where: the anode contains a silicon carbon composite or SiOx-based or Si-Carbon-SiOx-based powder that contains 40-90%, 30-70%, or ˜50% elemental silicon in the active material powder by weight (excluding the current collector.

Another embodiment comprises an anode as above, where the silicon is embedded in a carbon matrix to form each powder particle and/or where each particle may have its surface substantially covered by a carbon coating and/or where each particle contains silicon phases which are sub-micron in size (<1 μm diameter).

In the above embodiments, the anode active material layer may contains >20%, >30%, or >40% elemental Si by weight.

In one embodiment, the silicon has a crystallite size below 50 nm and a particle size D50 of the composite of below 10 μm. In further embodiments, the silicon carbon composite may comprise a carbon coating on the secondary particles and the coating ratio may be up to 5%.

One embodiment comprises a binder material comprising: (1) Single-component binder systems: CMC, HPC, PVA, polyacrylamide, poly(2-ethyl-2-oxazoline), and PVP; (2) Binder systems containing both thickeners and highly flexible binder dispersions: Thickeners include HPC, CMC, PVA, polyacrylamide, acrylamide/acrylic acid random copolymers and their salts, poly(2-ethyl-2-oxazoline). High flexibility binders could be SBR, PUD, or other latex materials; (3) Binder systems with strong cohesion: When binders containing a high content of hydroxyl groups or amine are mixed with binders containing a high content of COOH groups, the hydrogen bonding between OH/COOH or amine/COOH will provide extra cohesion of the polymer matrix. Binders with high quantities of OH groups and amine include PVP, CMC, PVA, HPC, or their copolymers. Binders with high contents of COOH groups include polyamic acid, PAA, lithium PAA, copolymers of acrylic acid and methacrylic acid, and their salts such as poly(acrylamide-co-acrylic acid); and/or (4) Chemically crosslinked binder systems: When heated at high temperatures, COOH and OH groups from different polymer/crosslinkers can undergo an esterification reaction and crosslink together. Molecules containing multiple epoxy groups such as poly(ethylene glycol) diglycidyl ether can also react with COOH groups and crosslink binders with COOH groups mentioned above. Besides, melamine formaldehyde can be used to crosslink binders containing OH, primary amine, and secondary amine groups.

Among all the four categories of polymer binder discussed above, category 3 and category 4 may be the most preferable for anode preparation. The strong physical interaction or covalent bonding between binders helps maintain the anode structure during Si expansion/shrinkage. Binder system 2 introduces highly flexible/elastic polymer dispersions which also help mitigate the matrix deterioration during cycling.

For binder system 1, water-soluble polymers such as CMC, HPC, and polyacrylamide with very high Tg and rigid polymer chains are the least preferable as binder material to accommodate Si expansion/shrinkage during cycling. However, water-soluble polymers with relatively flexible chain structures such as PVA, Poly(2-ethyl-2-oxazoline), and water-soluble that can be plasticized by electrolytes such as PVP and its copolymer will show more accommodation to the Si volume change than rigid polymers. Thus, they are more suitable as binders for anodes.

The processability of anode slurry also plays a pivotal role in the development of scalable Si-based anodes. In binder system 3, if the hydrogen bonding between 2 different polymers is too strong, gelation of slurry will happen. Consequently, the slurry cannot be coated through the roll-to-roll or slot-die coating method. To mitigate the gelation issue, polymer solution concentration, molecule weight of polymers and functional groups density along the polymer chain may be adjusted. For example, high molecular weight PAA may be used to pair with low molecule weight PVA to mitigate the gelation issue. Neutralization of COOH groups on PAA chain with other counter ions such as NH4+, Li+ will help reduce the gelation issue.

In some embodiments, CMC and SBR are used together.

Polymer binders that are coated on Si-carbon composite particles may block the ion transport towards particles during the cycling of cells. On the other hand, the lack of polymer binders may decrease the matrix strength and adhesion to the current collector of anodes. Thus, the content of the polymer inside the anodes significantly affects the cell performance. The weight percentage of polymer binder in anodes may be between 1% to 20%, and may preferably be between 3% to 15%, and may more preferably be between 4% to 8%.

In the case of anodes that are treated to higher temperatures than normal drying temperatures of lithium-ion electrodes (e.g. >200 or >300 Celsius): Binder precursors can include Polyimide, Polyamide-imide, phenolic resin, melamine formaldehyde resin, polyacrylonitrile, lignin-based polymers, Polysaccharide, PVMMA, tannin acid, humic acid etc.

In the case of anodes utilizing heat treatment above normal drying conditions, sacrifice polymers can be added to tune anode porosity/morphology. Other than Binder precursors which carbonize during heat treatment, the majority of sacrifice polymers decompose during heat treatment. Materials that are applied as sacrifice polymers include PEO, PVP, PVA, all acrylic latex, styrene-acrylic latex, and other materials that can decompose under 450° C.

In certain embodiments, the anode contains conductive additives in the form of zero-dimensional materials such as Super P, and one-dimensional materials such as single-walled carbon nanotubes or multiwalled-carbon nanotubes. Conductive carbon additives are used to reduce the surface roughness of the anode electrode and to improve electrical conductivity. Graphite or ceramic materials can be used as additives. Ceramic materials include Mg(OH)₂, AlO(OH), Al₂O₃, TiO₂, etc., and the particle size (D50) ranges from about 1 to 20 μm, more specifically about 2 to 8 μm.

In some embodiments, the cell is able to charge at 4C rate for at least 70% of its rated capacity before hitting the maximum voltage of the cell.

In some embodiments, the electrolyte amount is controlled to 2-3 g/Ah or even more ideally 2.6-2.9 g/Ah.

### Ether-Based Electrolytes

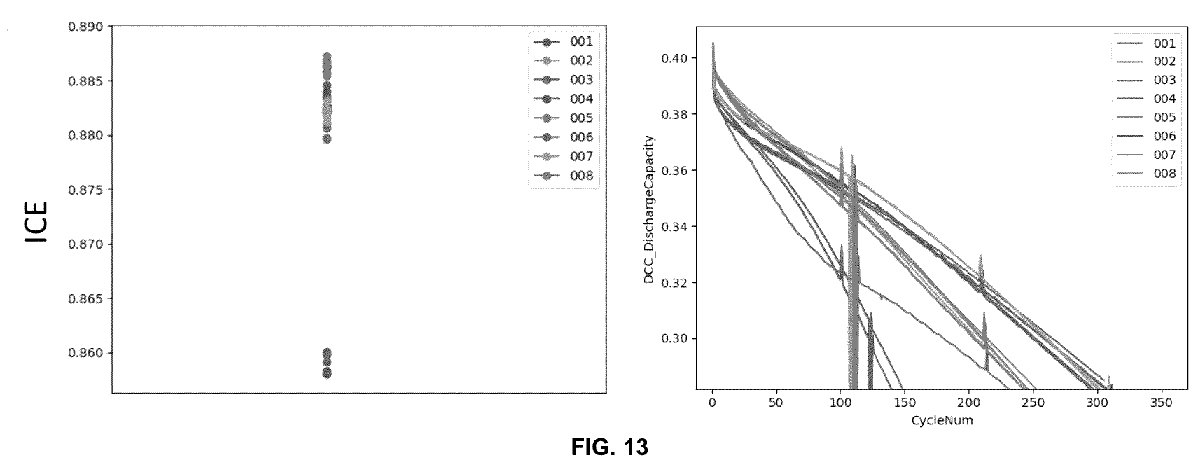

As noted earlier, the ICE of the amorphous Si/C anode as disclosed herein is lower than that of the crystalline Si based anodes. The electrolyte used can have a significant impact on the ICE of a cell. Disclosed herein is a new class of ether-based electrolytes that has demonstrated improved ICE and cycling performance in crystalline Si-based anodes systems compared to traditional carbonate-based electrolytes (FIG. 13). Such electrolytes may be used to boost the ICE and further improve the cycling performance of amorphous Si/C composite anode systems.

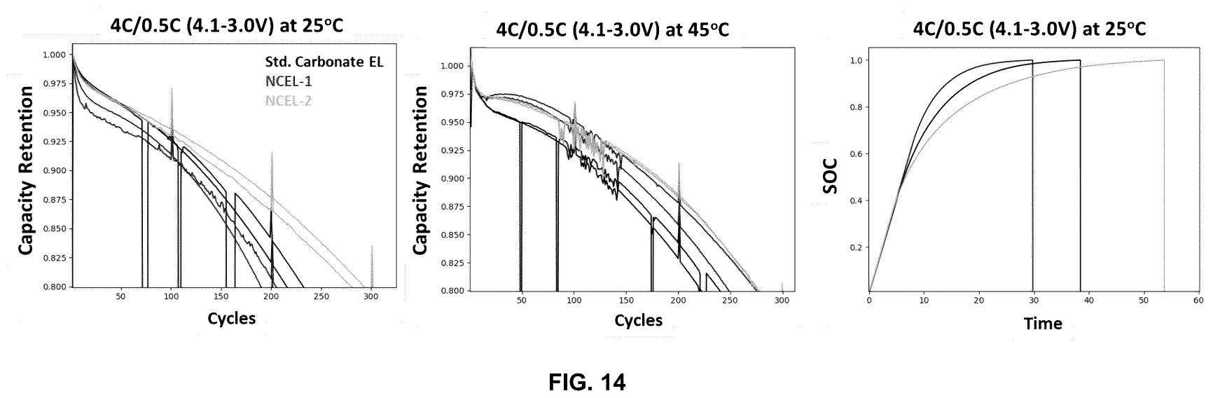

Furthermore, certain ether-based electrolyte formulations (NCEL-1 in FIG. 14 and below) can also achieve better rate capability than conventional carbonate-based electrolytes. Therefore, such electrolytes may be used with the amorphous Si/C composite systems to achieve better rate capability with minimal impact on cycling performance.

In order to reduce flammability of the electrolyte and enhance the safety characteristics of the cell, flame retardant compounds like phosphazenes and phosphate esters may be incorporated into the electrolyte as defined further below.

Formation protocol, cycling protocol and compositions are shown in Tables 4, 5 and 6, respectively. Initial coulombic efficiency (ICE) and cycling performance [4C/0.5C (3.5-2.5 V)] of LFP| Si (Crystalline) pouch cells with ether-based electrolytes and conventional carbonate-based electrolyte (blue) is demonstrated. See FIG. 13. Also see Scheme 10 below for glossary of compounds.

TABLE 4
Formation Protocol

| Cycle | |
|---|---|
| No. | Details |
| 1 | Charge at 1 C to 3.5 V until 0.05 C, Rest 5 minutes, discharge |
| | at 1 C to 2.0 V until 0.2 C, rest 5 minutes |
| 2 | Charge at 1 C to 2.7 V until 0.05 C, rest 10 minutes |

TABLE 5
Cycling protocol

| Cycle | |
|---|---|
| No. | Details |
| 1 | Rest 1 minute, Charge at 0.33 C to 3.5 V until 0.05 C, |
| | rest 5 minutes, discharge at 0.33 C |
| | to 2.5 V, rest 5 minutes |
| 2 | Rest 1 minute, Charge at 4 C to 3.5 V until 0.05 C, |
| | rest 5 minutes, discharge at 0.5 C |
| | to 2.5 V, rest 5 minutes |
| 3-100 | Same as Cycle 2 |
| 101 | Same as Cycle 1 |
| 102-200 | Same as Cycle 2 |
| 201 | Same as Cycle 1 |
| 202-300 | Same as Cycle 2 |
| . . . | . . . |

TABLE 6

| ID | Salt | Solvent 1 | vol. % | Solvent 2 | vol. % | Additives (wt %) |
|---|---|---|---|---|---|---|
| 001 | 0.8M LiFSI + 0.7M | FEC | 25 | EMC/FB | 65/10 | 1% PZ + 0.5% |
| | LiPF6 | | | | | LiDFOB |
| 002 | 1.3M LiFSI + 0.2M | 4mTHP | 70 | D7 | 30 | — |
| | LiNO3 | | | | | |
| 003 | 1.5M LiFSI | 4mTHP | 50 | D7 | 50 | — |
| 004 | 1.3M LiFSI + 0.2M | 4mTHP | 50 | D7 | 50 | — |
| | LiNO3 | | | | | |
| 005 | 1.3M LiFSI + 0.2M | THP | 50 | D7 | 50 | — |
| | LiNO3 | | | | | |
| 006 | 1.3M LiFSI + 0.2M | 4mTHP | 50 | D7 | 50 | — |
| | LiClO4 | | | | | |
| 007 | 1M LiFSI + 0.2M LiNO3 | 4mTHP | 30 | D7 | 70 | — |
| 008 | 1M LiFSI + 0.2M LiNO3 | THP | 30 | D7 | 70 | — |

Cycling performance (4C/0.5C (4.1-3.0 V) of NCM811| Si (Crystalline) pouch cells with ether-based electrolytes and conventional carbonate-based electrolyte at 25 and 45 degC is shown in Tables 7 and 8 below and FIG. 14. See Scheme 10 below for glossary of compounds.

TABLE 7

| | 4 C/0.5 C (4.1-3.0 V) at 25° C. | | | 4 C/0.5 C (4.1-3.0 V) at 45° C. | | |
|---|---|---|---|---|---|---|
| | | | SOC | | | SOC |
| | | Initial | charged | | Initial | charged |
| | Cycle | Capacity | in 15 mins | Cycle | Capacity | in 15 mins |
| | life | Ah | at 4 C | life | Ah | at 4 C |
| Std. | 225 | 0.677 | 86% | 230 | 0.699 | 92% |
| Carbonate | (100%) | (100%) | | (100%) | (100%) | |
| EL | | | | | | |
| NCEL-1 | 198 | 0.664 | 91% | 263 | 0.691 | 95% |
| | (88%) | (98%) | | (114%) | (99%) | |
| NCEL-2 | 288 | 0.649 | 76% | 278 | 0.681 | 85% |
| | (128%) | (96%) | | (121%) | (97%) | |

TABLE 8

| ID | Salt | Solvent 1 | vol. % | Solvent 2 | vol. % | Additives |
|---|---|---|---|---|---|---|
| Std. | 0.8M LiFSI + | FEC | 12 | EMC/FB | 73/15 | 0.4% PS + 0.3% |
| Carbonate EL | 0.7M LiPF6 | | | | | LiDODFP + 0.2% PRS |
| NCEL-1 | 1.45M LiFSI + | BFE | 50 | TFDOL-2 | 50 | — |
| | 0.05M LiDFOB | | | | | |
| NCEL-2 | 1.45M LiFSI + | THP | 50 | TFDOL-2 | 50 | — |
| | 0.05M LiDFOB | | | | | |

### Electrolyte Embodiments

All electrolyte compositions below may be used for cell designs involving Si/C composite anode systems wherein silicon may be amorphous, crystalline or a combination of the two and maybe combined with any of the cell designs described in this disclosure.

Also, for all electrolytes below the Li salt can be one or any combination of LiFSI, LiPF₆, LiBF₄, LiTFSI, LiNO₃, LiClO₄, LIDFOB, LiBOB, Lithium Bis(pentafluoroethanesulfonyl)imide, Lithium difluorophosphate (LiPO₂F₂), Lithium difluorobis(oxalato)phosphate (LiDODFP), Lithium triflate in any ratio wherein the total molarity of the salt lies between 0.6M-4M.

One embodiment comprises an electrolyte composition containing any/combination of the solvents defined in Scheme 1-9 below in any ratio (wherein the overall combination makes up 5% to 95% the wt. of the overall electrolyte).

Another embodiment comprises an electrolyte composition containing any/combination of solvents defined in Scheme 1 in combination with any/combination of traditional carbonate-based solvents like FEC, EC, PC, EMC, DMC, DEC, etc. in any ratio.

Another embodiment comprises an electrolyte composition as discussed above with any combination of additives including but not limited to VC (Vinylene carbonate), VEC (vinyl ethylene carbonate), PS (1,3-propane sultone), PES (prop-1-ene-1,3-sultone), BS (1,4-butane sultone), MMDS (methylene methanedisulfonate), TMSP (tris(trimethylsilyl)phosphite), TMS (trimethylene sulfate), TMSO (3-trimethylsilyl-2-oxazolidinone), 1,4-BS (1,4-butane sultone), PMS (propargyl methanesulfonate), DTD (1,3,2-Dioxathiolane 2,2-dioxide), TAP (Triallyl phosphate), phosphazenes like Ethoxy (pentafluoro)cyclotriphosphazene, hexamethoxycyclotriphosphazene, hexapropioxycyclotriphosphazene, hexafuluoroethoxycyclotriphosphazene, etc, wherein the composition of additives makes 0.1-20 wt % of the electrolyte.

Another embodiment comprises an electrolyte composition defined as above and containing any compound or combination of flame-retardant compounds described by chemical structures A and B below (typically between 1-80 wt % of electrolyte).

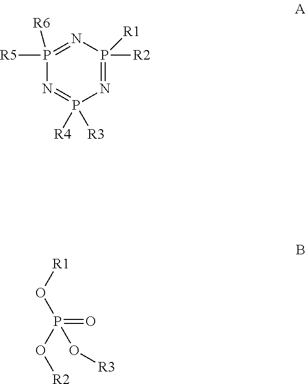

wherein, R1-R6 can be any combination of the following moieties: F, Cl, Br, CH₃, CH₂R, CHRR′, CRR′R″, CF₃, CF₂R, CHFR, CH₂F, OCH₃, OCH₂R, OCHRR′, OCRR′R″, NHR, NRR′, COR, CONRR′, COOR (where R,R′,R″ can be any alkyl group). Common examples include:

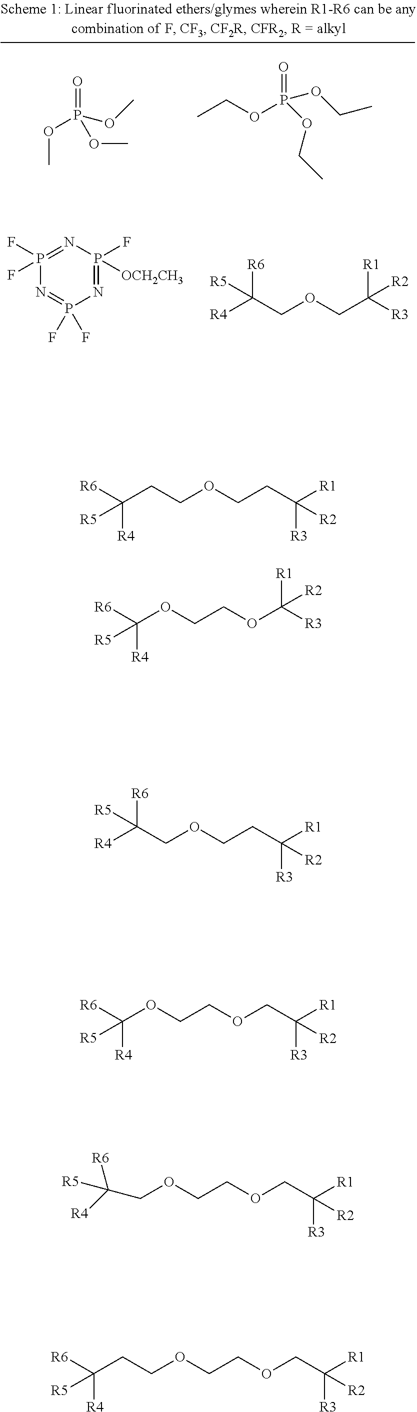

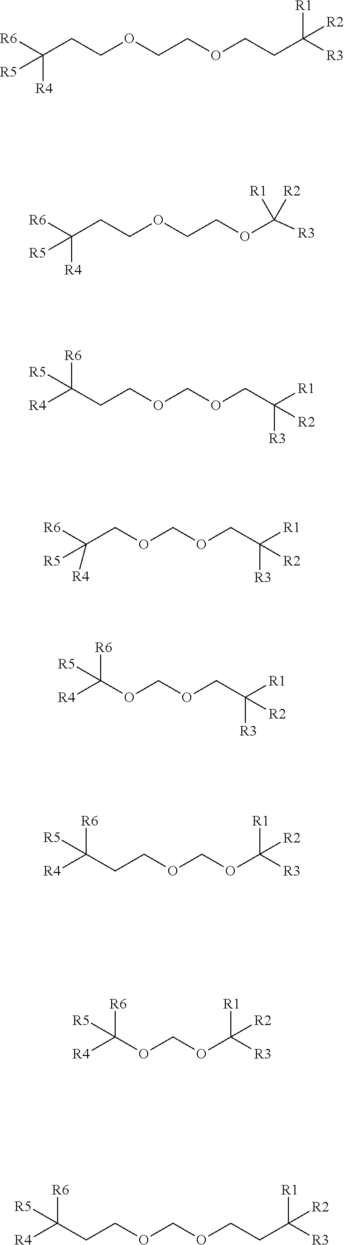

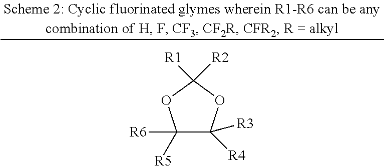

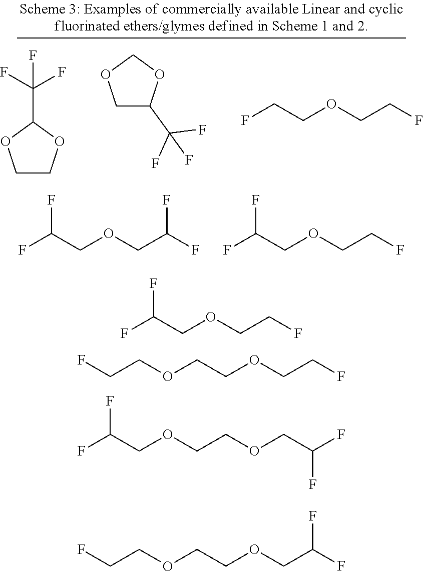

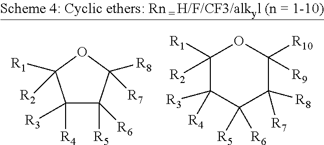

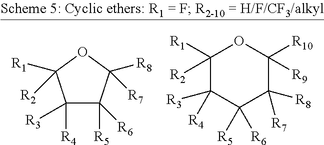

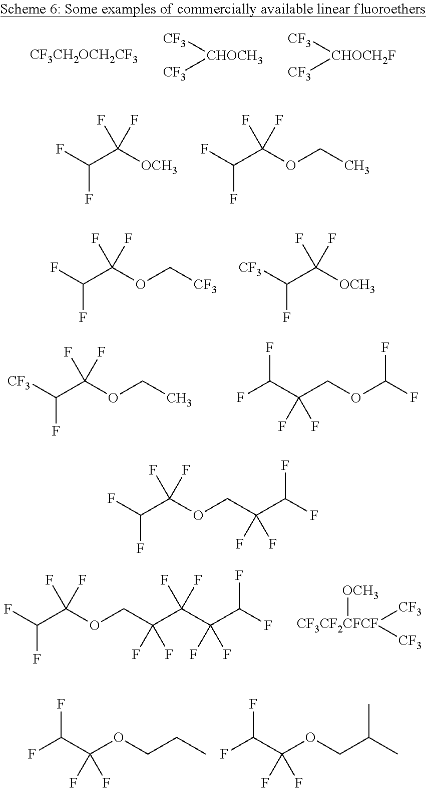

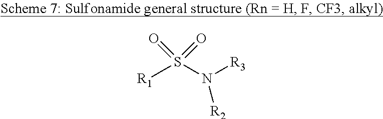

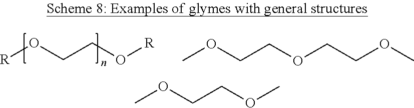

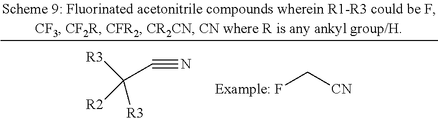

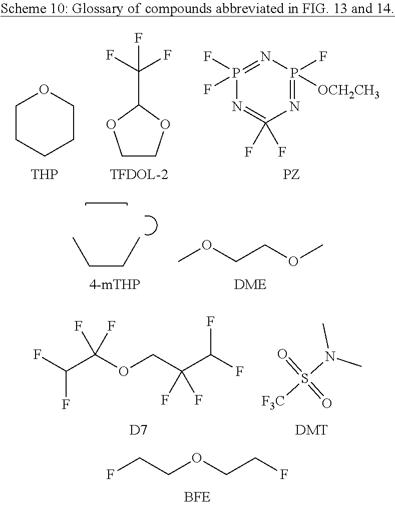

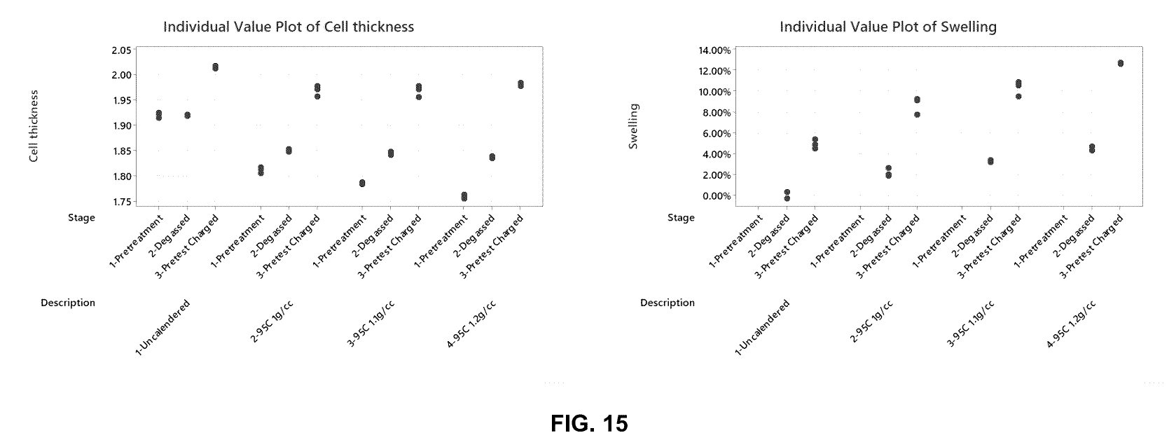

Further experiments show the effects of calendering in anodes as described herein. The preferred range of electrode density is from about 0.5-1.5 g/cc, about 0.7-1.1 g/cc, or may more preferably be about 0.8 g/cc to 1.0 g/cc. Results are shown in FIGS. 15, 16 and 17 and further described below. The formulation in the below examples is the following embodiment: 86.75% Silicon-carbon composite active material with 30-70% silicon and the remainder carbon, 2% CMC, 3% SBR, 7% Graphite, 1.25% CNT dispersion (0.5% CNT and 0.75% dispersant) coated on 15 micron copper foil with a loading of 4.1 mg/cm². In FIG. 15, comparison of calendared and non-calendared electrodes is shown. On the right of the figure is shown cell swelling and illustrates that swelling in formation increases substantially with increasing anode density. In FIG. 15, on the left is shown cell thickness and illustrates that there is negligible benefit in reducing degassed thickness and fully charged cell thickness for anode densities over 1 g/cc. In some embodiments, the silicon-carbon composite material may have about 50 wt % Si and about 50 wt % carbon and may be made by deposition of silane into porous carbon structures.

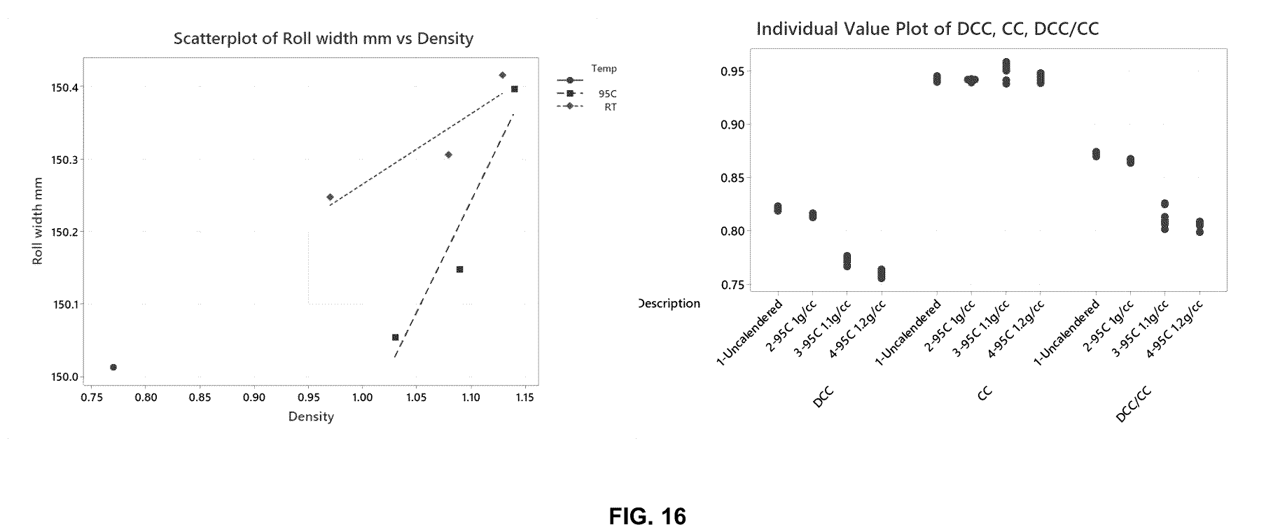

FIG. 16 shows on the right that calendering over 1 g/cc, for this formulation, appears to negatively impact discharging capacity and hence the initial capacity and energy density. FIG. 16 shows on the left that calendering at 95° C. can result in less extrusion than calendering at room temperature, depending on the density target. Although not required, heated calendering at above about 40° C. can help when calendaring to densify in a way that does not damage the electrode.

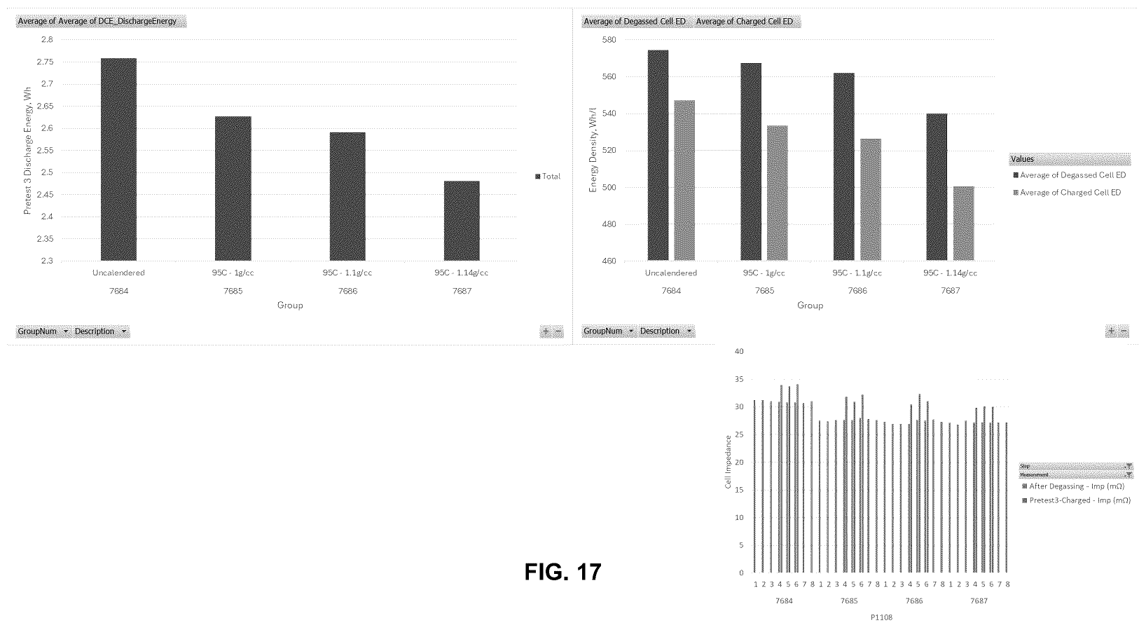

FIG. 17 further shows the effects of calendaring. ED calculations assume 61 mm×41 mm and use discharge energy calculated from charging at 0.2C to 4.2V and holding at 4.2V until the current reaches 0.05C and then discharging at 0.2C to 2V. The thickness of the cell for the ED calculations are from the thickness of the cell immediately after degassing or after the cell is charged. Calendering appears to reduce discharge energy and energy density, but also reduces cell impedance by about 10% (3 mOhm).

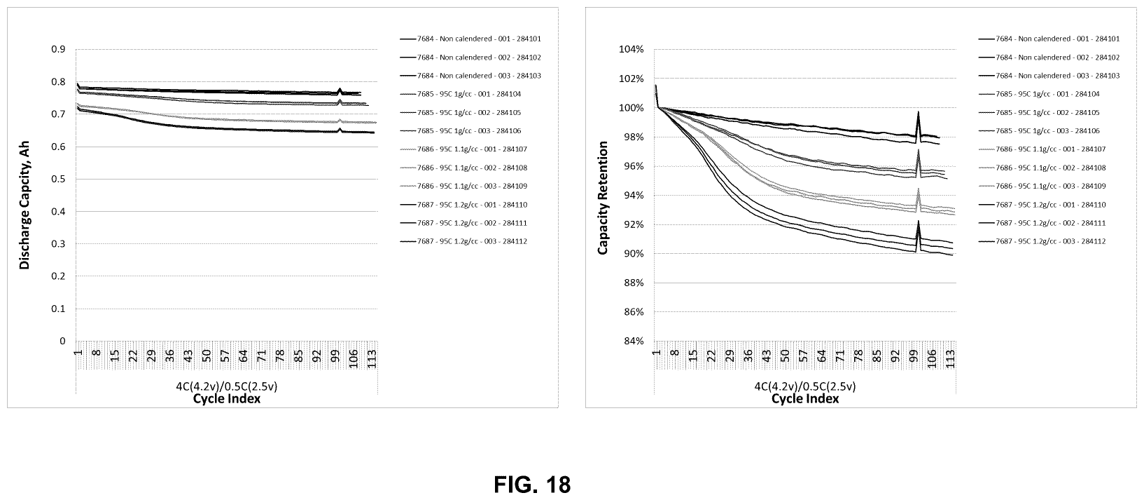

FIG. 18 shows that reducing the electrode density may also improve cycle life.

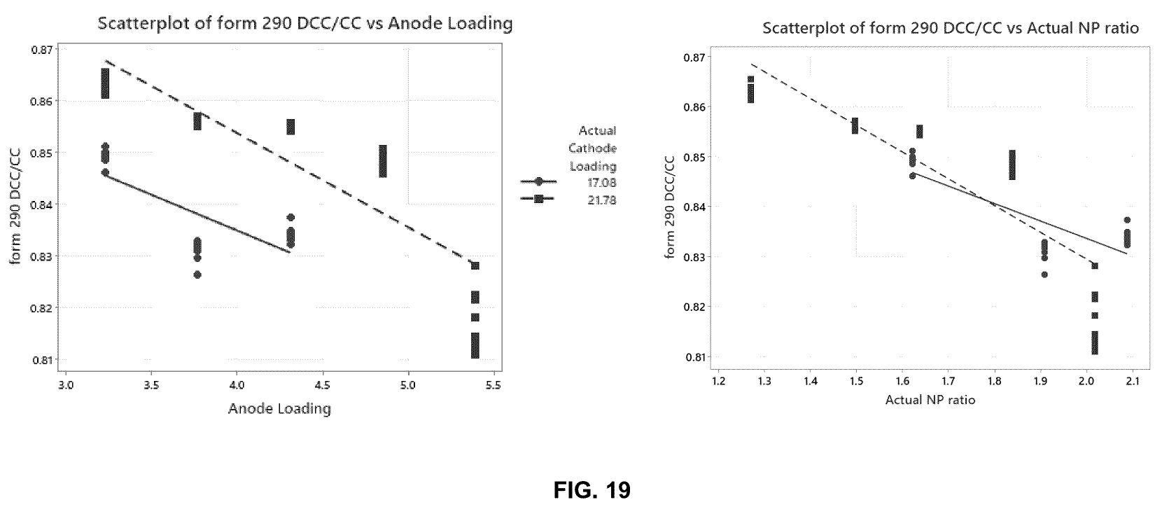

FIG. 19 shows the effect of loading on ICE. The formulation for these examples is also 86.75% Silicon-carbon composite active material (with 30-70% silicon and the remainder carbon), 2% CMC, 3% SBR, 7% Graphite, 1.25% CNT dispersion (0.5% CNT and 0.75% dispersant) coated on 15 micron copper foil. On the right of the figure, it is shown that the ICE trend appears to be driven primarily by N/P ratio; the ICE vs N/P ratio trend is similar when using a different loading range. There may be a difference in slope depending on cathode loading. In FIG. 19, on the left is shown that for the same anode loading, the ICE increases with decrease in N/P ratio (increase in cathode loading). For a fixed cathode loading, the ICE increases with decrease in N/P ratio (decrease in anode loading). As such, the range of N/P ratio may roughly be about 1.1-2, about 1.1 to 1.4, or may more preferably about 1.15-1.4 or about 1.15-1.3.

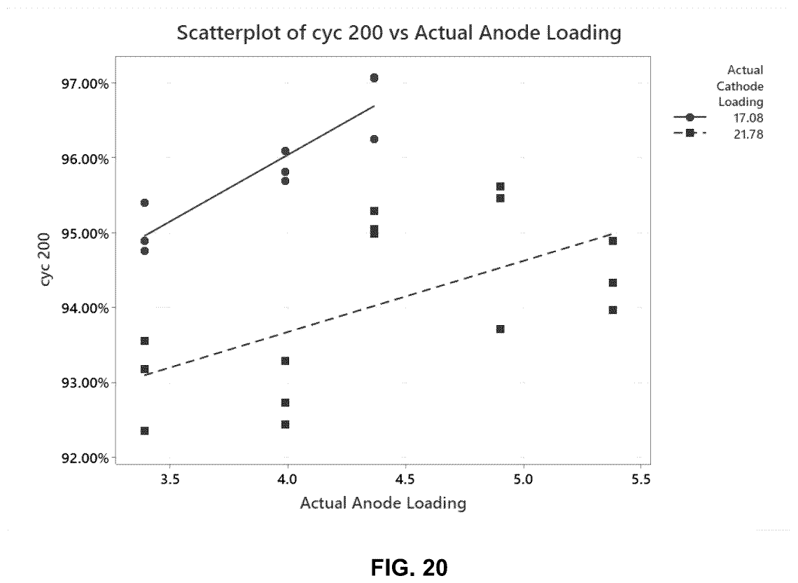

FIG. 20 shows the effect of loading on retention. For the same anode loading, the retention increases with decrease in cathode loading. For a fixed cathode loading, the retention increases with increase in anode loading.

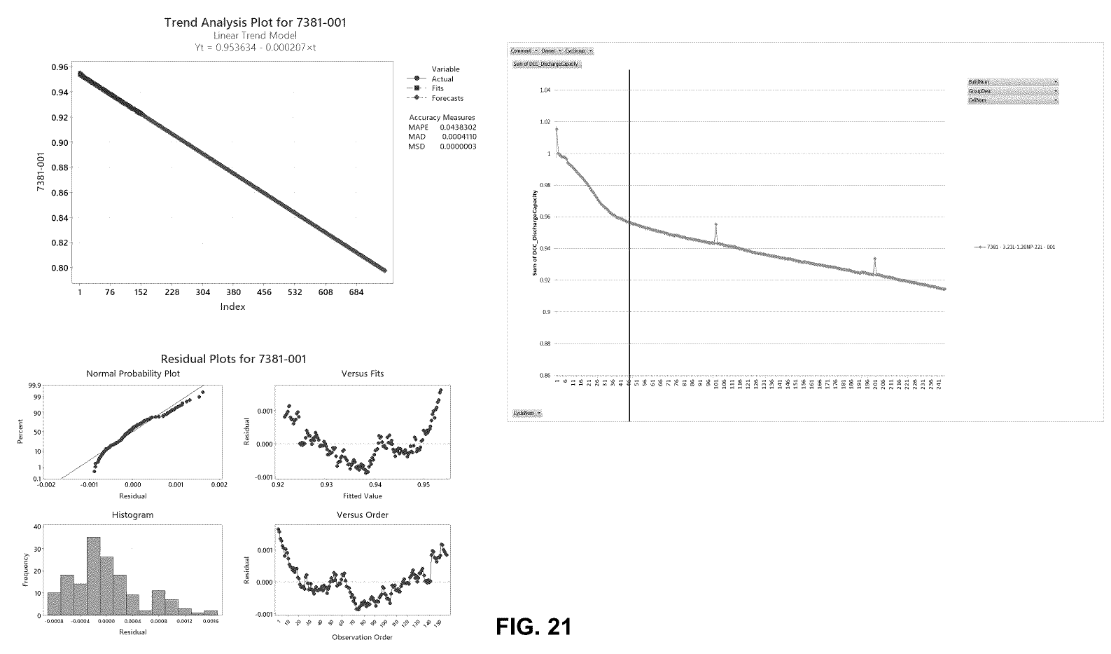

FIG. 21 shows a cycle life to 80% prediction. Cycle life prediction was done using linear extrapolation to 80% after removing first 50 cycles of normalized capacity (2nd cycle). 50 cycles were chosen since most of the initial fade was within those cycles. Discounting of first 50 cycles makes cycle life prediction more conservative.

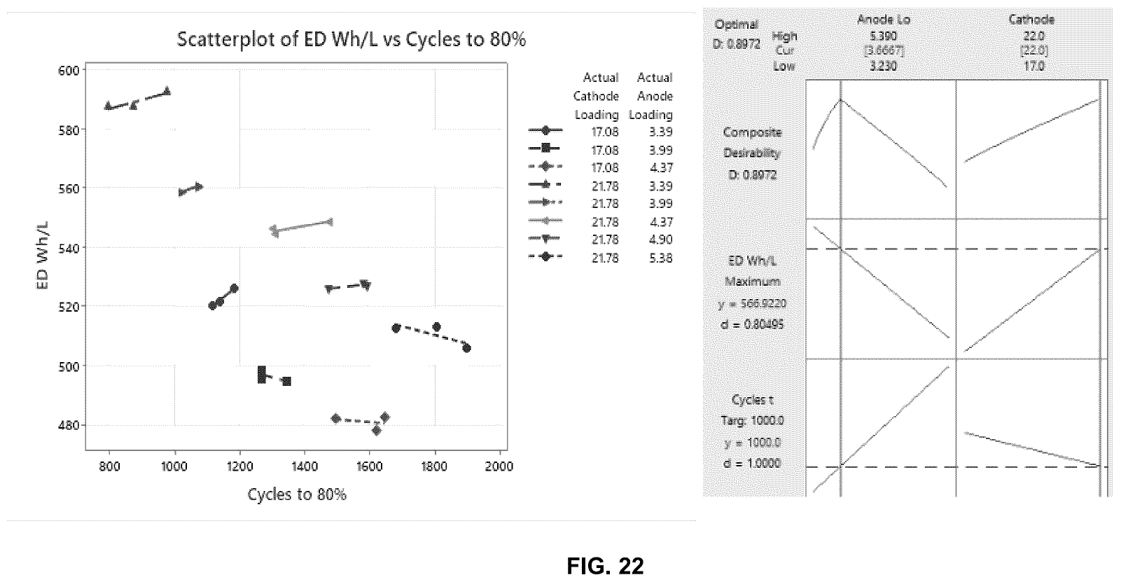

FIG. 22 shows energy density vs cycle life prediction. Energy density calculations are based on a 61 mm×41 mm cell, using degassed cell thickness, and using the discharge energy from cycle 1 of the 4C(4.2v)/0.5C(2.5v) test. Modeling for maximizing ED while targeting 1000 cycles to 80%, anode loading may be designed for a given cathode design. If higher energy density is desired within the range of N/P ratio of 1-2.5, the N/P ratio can be decreased to increase ED at the expense of cycle life. The design may be tuned per application to meet a desired performance profile.

In another set of experiments, formation protocols as well as X, Y expansion after formation are shown for a Silicon Carbon Composite anode. The fast charge cycling performance and the cell expansion are measured. For comparison, graphite cell formation protocol and other Si cell formation is tested. Cell design is as follows, where the cathode is 97% NCM811, with 22.5 loading and anode is the Silicon Carbon Composite anode. Measurable goal is cycling 4C/0.5C (Cycling1335, 780 mAh), X, Y expansion after formation. The anode for these experiments has the formulation of 80.25% Silicon-carbon composite active material (with 30-70% silicon and the remainder carbon), 1.5% CMC, 3% SBR, 14% Graphite, 1.25% CNT dispersion (0.5% CNT and 0.75% dispersant) coated on 15 micron copper foil.

The various formation profiles investigated are shown below as summarized in Table 9, with specific formation protocols shown in Tables 10-13. References: Andrew Weng et al. Modeling Battery Formation: Boosted SEI Growth, Multi-Species Reactions, and Irreversible Expansion. J. Electrochem. Soc. 17(9), September 2023; Batteries—2022 Annual Progress Report (US Department of Energy, Office of Energy Efficiency and Renewable Energy).

TABLE 9

| Group | Formation | Formation | Formation | Formation | | Cell | |
|---|---|---|---|---|---|---|---|
| No. | Pressure | protocol | Charge/discharge | Voltage Range | Cycling Test | Qty | Reference |
| 1 | 5 psi | Form518 | 0.1 C/0.1 C, 3 times, | 4.2 V-3 V | Cycling1335: | 5 (3 for | Graphite |
| | | | @45degC. | | 4 C(4.2 V)- | cycle, 2 | cell |
| | | | | | 0.5 C(2.5 V) | for DA) | |
| 2 | 60 psi | Form519 | 0.1 C/0.1 C, 2 times | 4.3 V-2.75 V | Cycling1335: | 5 (3 for | Si cell |
| | | | | | 4 C(4.2 V)- | cycle, 2 | |
| | | | | | 0.5 C(2.5 V) | for DA) | |
| 3 | 140 psi | Form290 | 1 C/1 C | 4.2 V-2 V | Cycling1335: | 5 (3 for | |
| | | | | | 4 C(4.2 V)- | cycle, 2 | |
| | | | | | 0.5 C(2.5 V) | for DA) | |
| 4 | 140 psi | Form501 | 1 C CC to | TBD-2 V | Cycling1335: | 5 (3 for | |
| | | | 50% SoC/1 C | | 4 C(4.2 V)- | cycle, 2 | |
| | | | | | 0.5 C(2.5 V) | for DA) | |

TABLE 10
Formation290

| Cycle No. | Details |
|---|---|
| 1 | Charge at 1 C to 4.2 V until 0.05 C, |
| | discharge at 1 C to 2 V until 0.2 C |
| 2 | Charge at 1 C to 3.3 V until 0.05 C, rest 10 minutes |

TABLE 11
Formation501

| Cycle | |
|---|---|
| No. | Details |
| 1 | Charge at 1 C to 50% of Expected Charge Capacity, Rest 5 minutes, discharge at 1 C |
| 2 | to 2 V until 0.2 C, rest 5 minutes |
| | Charge at 1 C to 3.3 V until 0.05 C, rest 10 minutes |

TABLE 12
Formation518

| Cycle No. | Details |
|---|---|
| 1-3 | Charge at 0.1 C to 4.2 V, then keep cell at 4.2 V until 0.05 C, discharge at 0.1 C to 3 V |

TABLE 13
Formation519

| Cycle | |
|---|---|
| No. | Details |
| 1-2 | Charge at 0.1 C to 4.3 V, then keep cell at 4.3 V until 0.05 C, discharge at 0.1 C to |
| | 2.75 V |

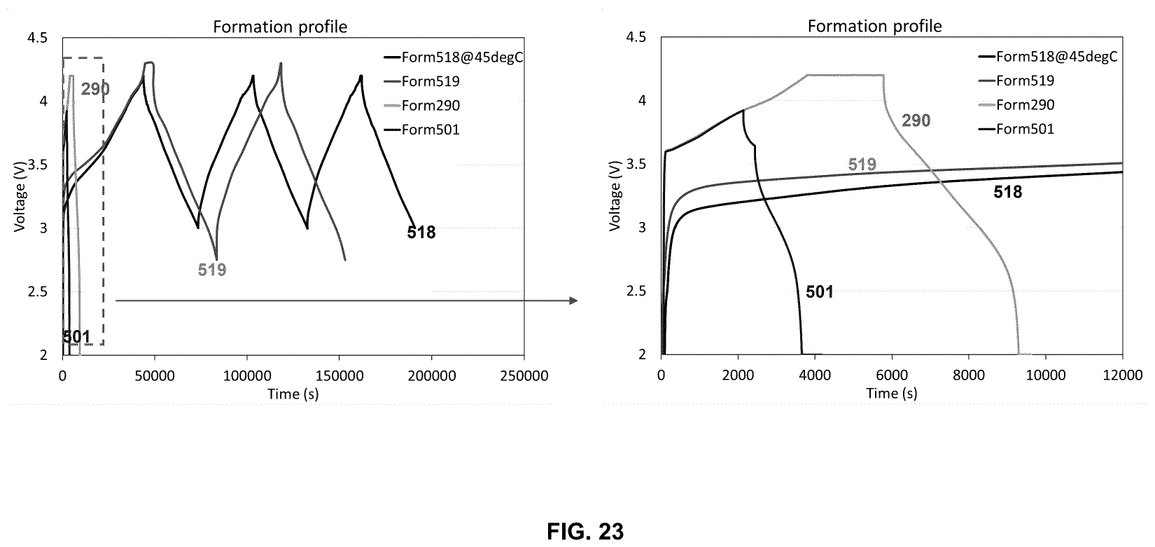

FIG. 23 shows formation profiles of further embodiments as shown in Table 14. These experiments show higher pressure and shorter time. To have a similar or better performance, the preferred formation pressure range is between about 100 psi and about 200 psi, and the formation charge/discharge rate range is from about 0.1C to 2C.

TABLE 14

| Group | Formation | Formation | Formation | Formation | OCV after | Total |
|---|---|---|---|---|---|---|
| No. | Pressure | protocol | Charge/discharge | Voltage Range | formation | time |
| 1 | 5 psi | Form518 | 0.1 C/0.1 C, 3 times, | 4.2 V-3 V | 3.10 V | 3181 min |
| | | | @45degC. | | | |
| 2 | 60 psi | Form519 | 0.1 C/0.1 C, 2 times | 4.3 V-2.75 V | 2.94 V | 2549 min |
| 3 | 140 psi | Form290 | 1 C/1 C | 4.2 V-2 V | 3.23 V | 159 min |
| 4 | 140 psi | Form501 | 1 C CC to | 3.92-2 V | 3.20 V | 69 min |
| | | | 50% SoC/1 C | | | |

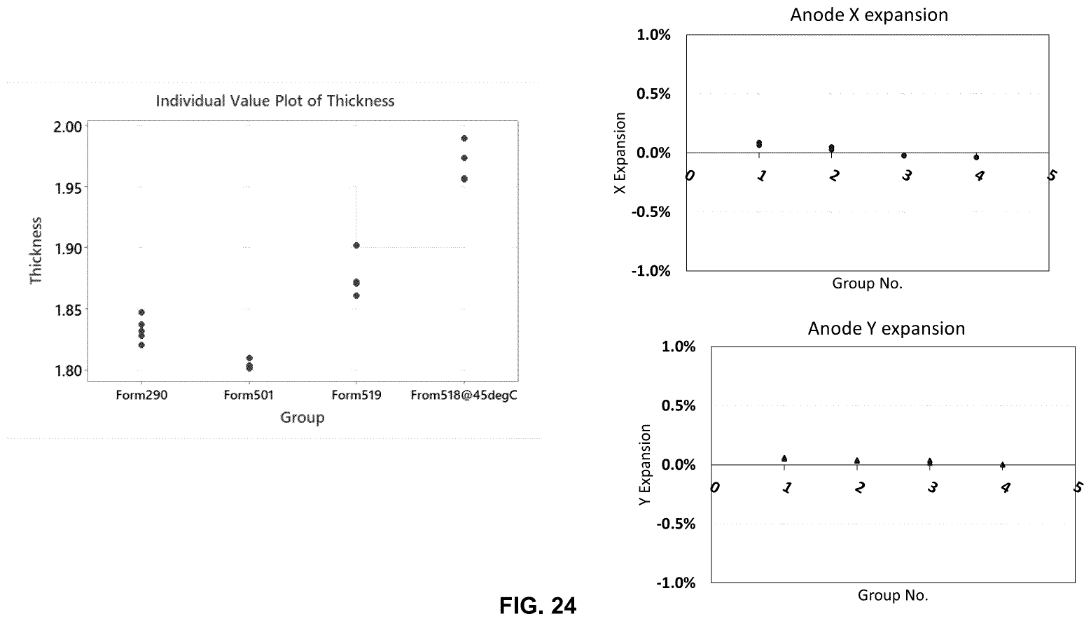

FIG. 24 shows cell expansion of embodiments as shown in Table 15. These experiments show almost no X, Y expansion for all and higher thickness expansion with lower pressure.

TABLE 15

| | Formation | | Formation |
|---|---|---|---|
| Group No. | Pressure | | protocol |
| 1 | 5 | psi | Form518@45degC. |
| 2 | 60 | psi | Form 519 |
| 3 | 140 | psi | Form 290 |
| 4 | 140 | psi | Form501 |

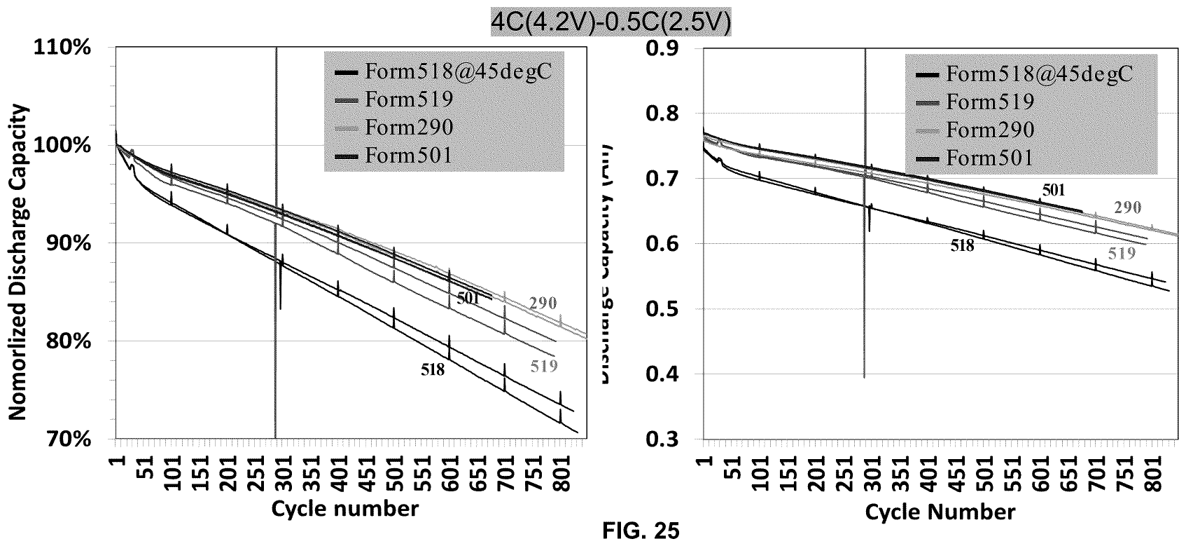

FIG. 25 shows cycling performance of embodiments as shown in Table 16. These experiments show improved performance and that charging to SOC levels lower than 100% (low SOC formation) can be equivalent to full SOC formation. For the low SOC formation, the preferred SOC range the cell need charge to is between about 30% SOC and about 100% SOC.

TABLE 16

| Group | Formation | | Formation | Formation | Formation Voltage |
|---|---|---|---|---|---|
| No. | Pressure | | protocol | Charge/discharge | Range |
| 1 | 5 | psi | Form518 | 0.1 C/0.1 C, 3 times, | 4.2 V-3 V |
| | | | | @45degC. | |
| 2 | 60 | psi | Form519 | 0.1 C/0.1 C, 2 times | 4.3 V-2.75 V |
| 3 | 140 | psi | Form290 | 1 C/1 C | 4.2 V-2 V |
| 4 | 140 | psi | Form501 | 1 C CC to 50% SoC/1 C | 3.92-2 V |

The above formation protocols have shorter time and better performance as compared to other protocols. The low SOC formation has same performance as a standard formation. Less expansion is shown for the above formations. Further, no X, Y expansion was shown for all formation protocols.

In another set of experiments, a clamping evaluation with the above Silicon Carbon Composite anode is shown. These experiments test a spring clamping setup. Specifically, 5-layer cells per cycle life are tested and % capacity retention, difference between clamping method are measured. 12×5 layer pouch cells are utilized. Table 17 outlines the tests. A starting pressure, which may be between about 0 kPa and about 1000 kPa, or may preferably be about 50 kPa and about 500 kPa, can be applied for the Silicon Carbon Composite anode. To have similar or better performance to silicone foam gap clamping (clamping within a fixed gap along with silicone foam: BISCO® HT-800 Medium Silicone Foam from Rogers Corporation), the preferred starting pressure range is between about 100 kPa and about 400 kPa. The preferred max pressure at end of life should not exceed about 1500 kPa. In some embodiments, springs of about 15-30 kPa are used; in other embodiments, springs of about 13 kPa, Spring Clamping (Spring of 31 N/mm) are used. References: Paul, Partha & Thampy, Vivek & Cao, Chuntian & Steinrueck, Hans-Georg & Tanim, Tanvir & Dunlop, Alison & Dufek, Eric & Trask, Stephen & Jansen, Andrew & Toney, Michael & Weker, Johanna. (2021). Quantification of heterogeneous, irreversible lithium plating in extreme fast charging of Li-ion batteries. Energy & Environmental Science. 14. 10.1039/D1EE01216A; Tanvir R. Tanim, Partha P. Paul, Vivek Thampy, Chuntian Cao, Hans-Georg Steinrück, Johanna Nelson Weker, Michael F. Toney, Eric J. Dufek, Michael C. Evans, Andrew N. Jansen, Bryant J. Polzin, Alison R. Dunlop, Stephen E. Trask, Heterogeneous Behavior of Lithium Plating during Extreme Fast Charging, Cell Reports Physical Science, Volume 1, Issue 7, 2020; Tanvir R. Tanim, Partha P. Paul, Vivek Thampy, Chuntian Cao, Hans-Georg Steinrück, Johanna Nelson Weker, Michael F. Toney, Eric J. Dufek, Michael C. Evans, Andrew N. Jansen, Bryant J. Polzin, Alison R. Dunlop, Stephen E. Trask, Heterogeneous Behavior of Lithium Plating during Extreme Fast Charging, Cell Reports Physical Science, Volume 1, Issue 7, 2020

TABLE 17

| Tests for New Sample Cells | No. of Cells |
|---|---|
| 4 C (4.2 V)/0.5 C (2.5 V) | 3 |
| 4 C (4.2 V)/0.5 C (2.5 V) @ 45degC. | 3 |
| No. of Groups (Testing) | 2 |
| Cathode | 41205 (NCM811) |
| Anode | 42227 (Silicon Carbon Composite Anode) |
| Electrolyte | 10520 (EL01680, 1.8 mL) |

| Clamping Setup | Condition | Starting Pressure | |
|---|---|---|---|
| Gap clamping with HT800 | CT + 1.2 mm | 110 | kPa |
| (p/n 80030) | | | |
| Spring Clamping | 4X Low Pressure | 15 | kPa |

Spring

| | |
|---|---|
| Total No. of Cells | 12 |

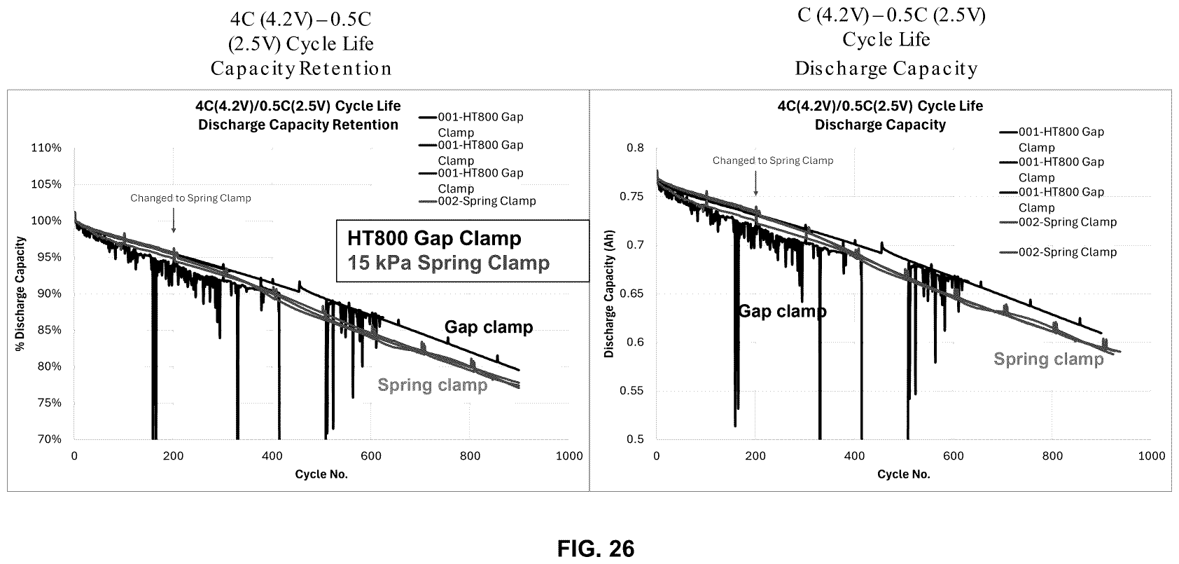

In FIG. 26, 4C (4.2V)-0.5C (2.5V) cycle life is shown. Cells (in red) were first clamped with silicone foam gap clamp and then switched to 15 kPa spring clamp at ˜200 cycles. Switching to 15 kPa spring clamp showed lower cycle life compared to silicone foam gap clamp.

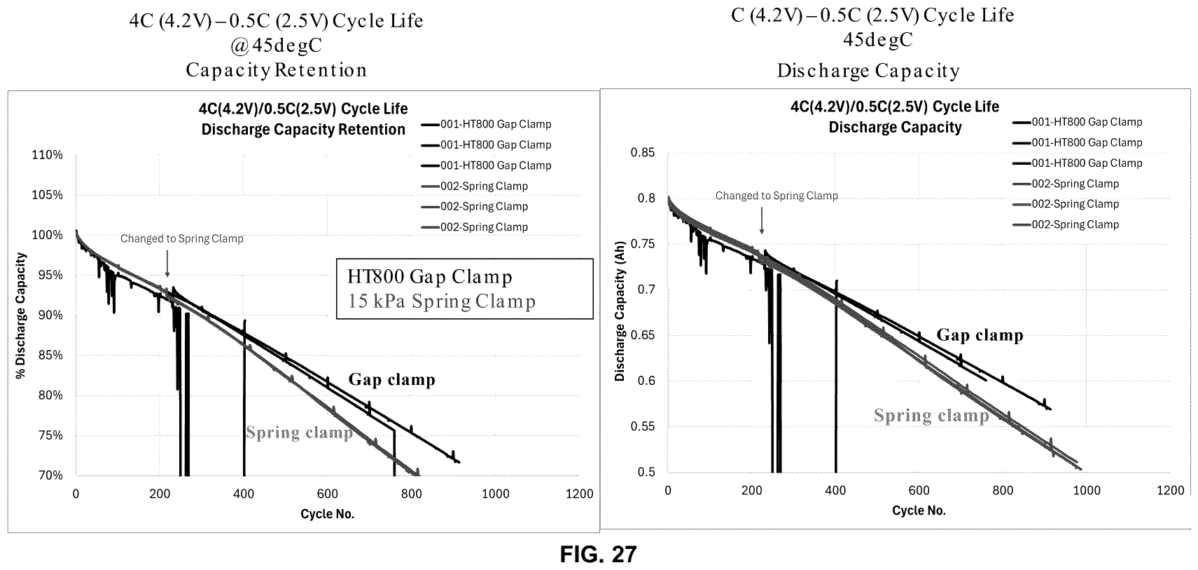

In FIG. 27, 4C (4.2V)-0.5C (2.5V) cycle life @ 45 degC is shown. Cells (in red) were first clamped with silicone foam gap clamp and then switched to 15 kPa spring clamp at ˜220 cycles. Switching to 15 kPa spring clamp showed lower cycle life compared to silicone foam gap clamp.

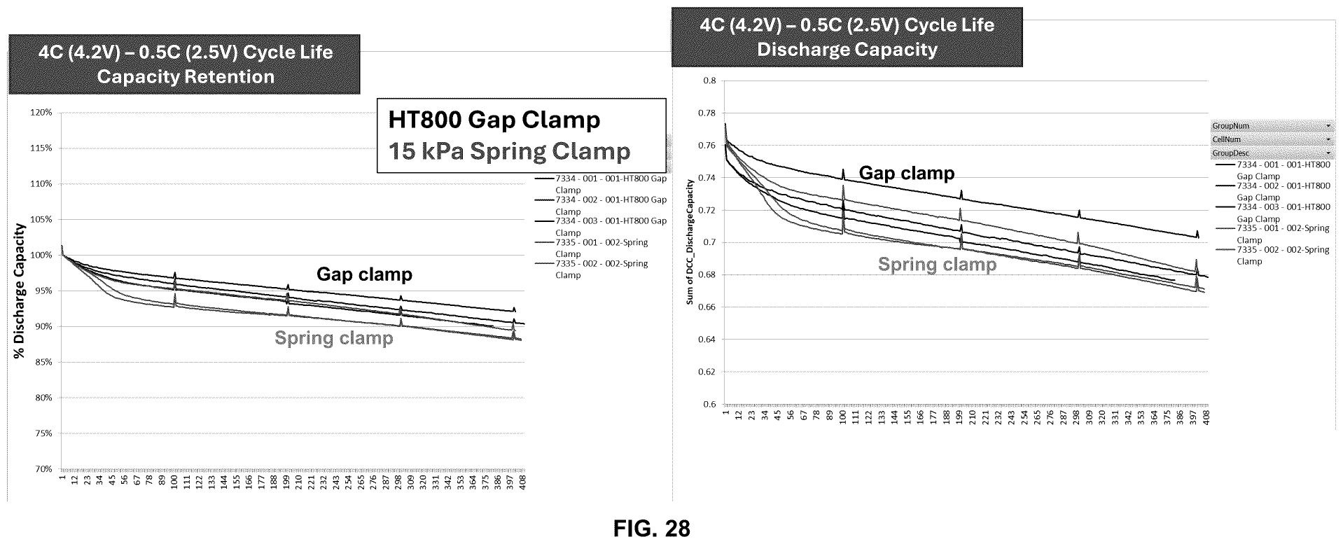

In FIG. 28, 4C (4.2V)-0.5C (2.5V) cycle life is shown. Lower ICE/discharge capacity is shown during formation for lower performing 2 cells from each group (RX80 cells with HT800 gap clamp has initial capacity of 0.775 Ah). Silicone foam gap clamping shows better cycle life as compared to 15 kPa spring clamping. 15 kPa spring clamping may fade faster than HT800 gap clamp.

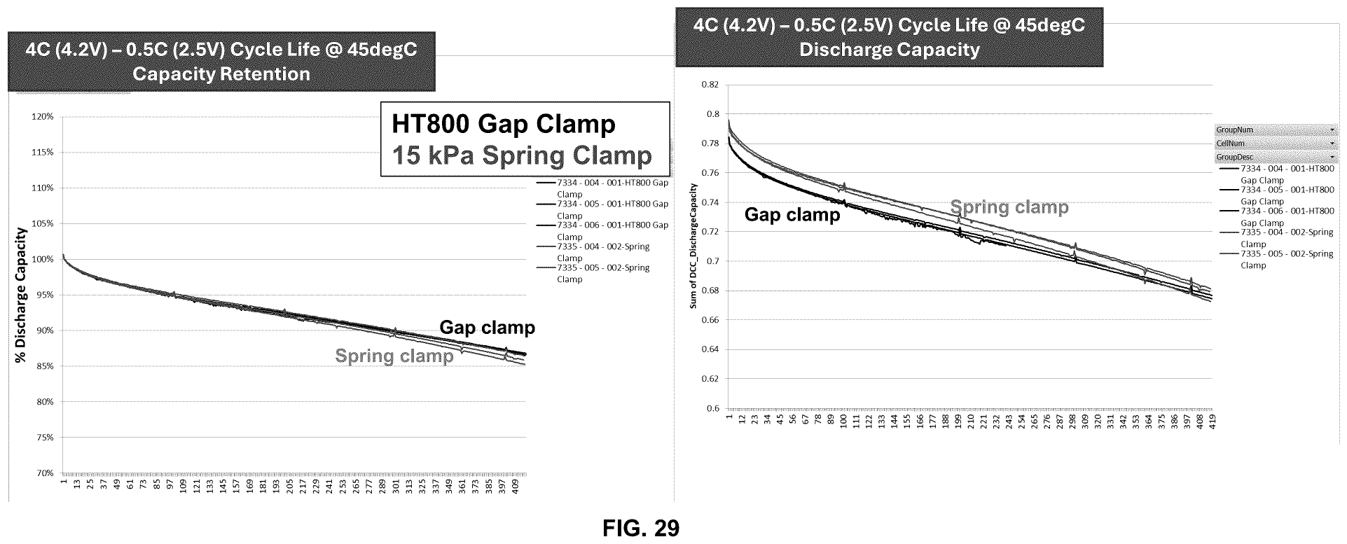

In FIG. 29, 4C (4.2V)-0.5C (2.5V) Cycle Life @ 45 degC is shown. Spring clamping shows higher initial discharge capacity compared to silicone foam gap clamp (˜1.3%). However, this is likely due to Spring clamping group showing higher ICE/discharge capacity during formation (˜1%), even though formation conditions were the same as silicone foam gap clamp group. Silicone foam gap clamping shows better 45 degC cycle life as compared to 15 kPa spring clamping. 15 kPa spring clamping may fade faster than HT800 gap clamp.

In another set of experiments, formulations with and without single-walled carbon nanotubes (SWCNT) are shown. Multi-walled carbon nanotubes (MWCNT) or other high-aspect-ratio carbons can also be used. See Table 18 below.

TABLE 18

| Electrode | Resistance | | |
|---|---|---|---|
| No SWCNT | 0.488 | 0.377 | 0.352 |
| SWCNT | 0.163 | 0.154 | 0.153 |

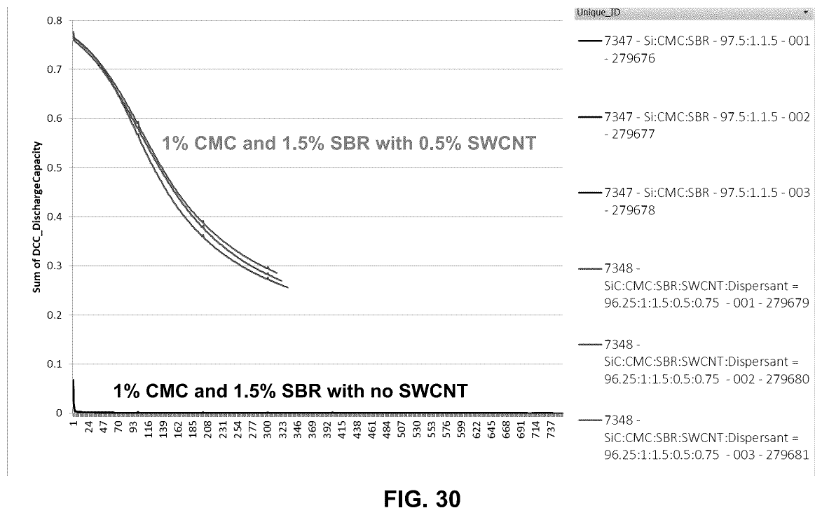

FIG. 30 shows data comparing 2 different formulations both with 1% CMC and 1.5% SBR in the dry electrode, one with 0.5% SWCNT in dry composition, the other with no SWCNT. The data illustrates that electrodes with SWCNT has better cycle life and dry resistance. The high-aspect-ratio carbon content in the final electrode may ideally be in the range of about 0.1-2%, or may preferably be about 0.3-1.2%.

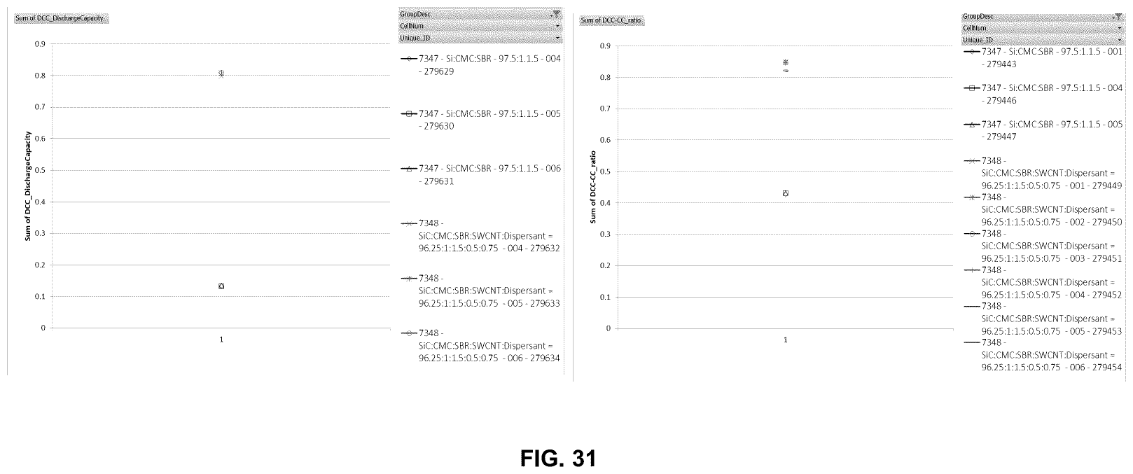

FIG. 31 shows electrodes with SWCNT have higher capacity & ICE.

In further set of experiments, graphite formulations with and without single-walled carbon nanotubes (SWCNT) are shown. MWCNT or other high-aspect-ratio carbons can also be used. See Table 19 below.

TABLE 19

| Electrode | Resistance | | |
|---|---|---|---|
| No SWCNT | 0.413 | 0.395 | 0.360 |
| SWCNT | 0.281 | 0.268 | 0.265 |

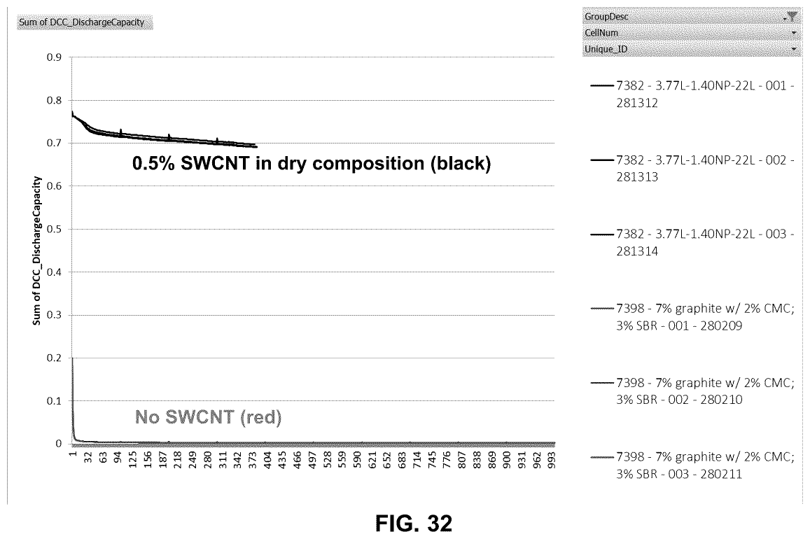

FIG. 32 shows data comparing 2 different formulations both with 2% CMC, 7% graphite as conductive additive and 3% SBR in the dry electrode, one with 0.5% SWCNT in dry composition (black), and the other with no SWCNT (red). Electrodes with SWCNT has better cycle life and dry resistance.

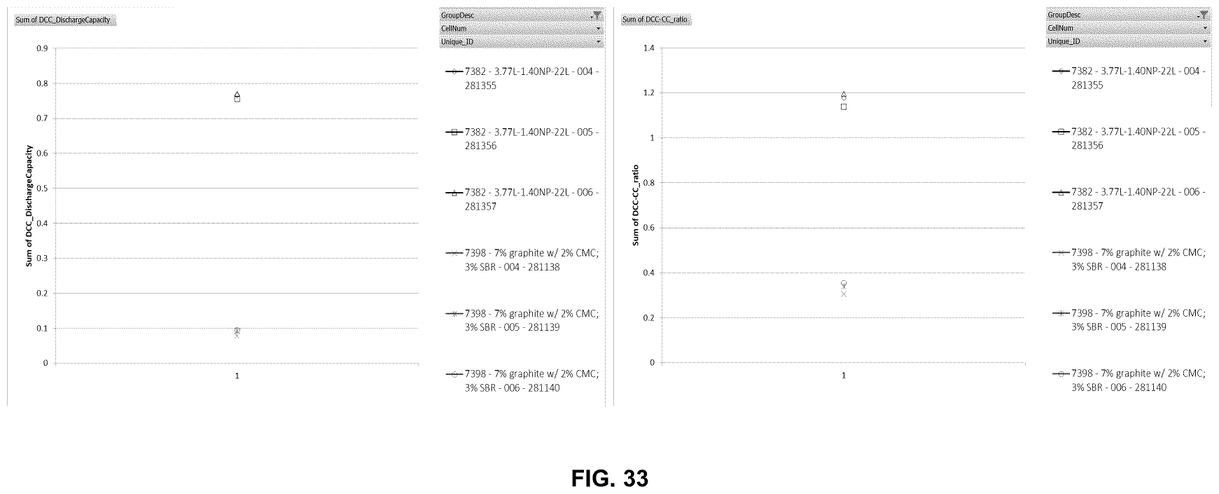

FIG. 33 shows electrodes with SWCNT have higher capacity & CE.

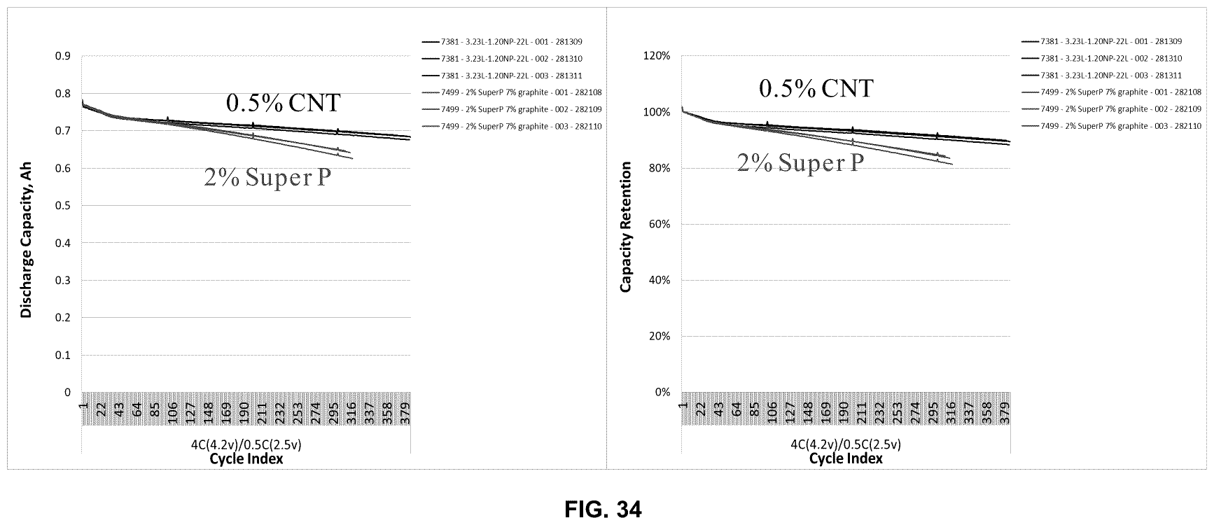

In further set of experiments, Super P vs CNT formulations are shown. Specifically, in a base formulation of 7% graphite, 2% CMC, 3% SBR, with the remainder being Si—C composite, 0.5% CNT provides superior cycle life to 2% Super P. See FIG. 34. The high-aspect-ratio carbon content in the final electrode may ideally be in the range of about 0.1-2%, or may preferably be about 0.3-1.2%. Utilizing high-aspect-ratio carbon conductive additives are preferrable to 0 dimensional carbon additives such as Super P.

In some embodiments of a battery electrode as disclosed herein, the electrode comprises an electrode coating layer on a current collector, the electrode coating layer comprising a silicon carbon composite or SiOx-based or Si-Carbon-SiOx-based powder, an aqueous-based polymer, a secondary polymer and one or more conductive additives. In other embodiments, the silicon carbon composite or SiOx-based or Si-Carbon-SiOx-based powder contains 40-90% elemental silicon in the powder or 30-70% elemental silicon in the powder.

In further embodiments, the conductive additive is a conductive carbon; the conductive carbon is selected from the group consisting of carbon blacks, carbon fibers, carbon nanofibers, carbon nanotubes, graphite, and graphene; the conductive carbon is a 1D or 2D carbon structure; the 1D or 2D carbon structure is one or more of carbon nanofibers; carbon nanotubes and carbon nanotube-based nanostructures; conductive carbon black; graphene; graphene oxide, carbon nanofibers+conductive carbon black; carbon nanotube/carbon nanotube-based nanostructures+conductive carbon black; carbon nanotube/carbon nanotube-based nanostructures+graphene/graphene oxide; conductive carbon black+graphene/graphene oxide; and carbon nanotube/carbon nanotube-based nanostructures+conductive carbon black+graphene/graphene oxide. In other embodiments, the 1D or 2D carbon structure is one or more of single-walled carbon nanotubes (SWCNT), multi-walled carbon nanotubes (MWCNT), carbon nanofibers, or crosslinked carbon nanotubes (CCN).

In some embodiments of a battery electrode as disclosed herein, the electrode comprises an electrode coating layer on a current collector, the electrode coating layer comprising a silicon carbon composite or SiOx-based or Si-Carbon-SiOx-based powder, an aqueous-based polymer, a secondary polymer and one or more conductive additives, where the aqueous-based polymer is selected from the group consisting of polyimides; crosslinked phenolic resins; polysiloxanes; polyurethanes; polyvinyls; polyvinylpyrrolidone (and copolymers thereof); acrylic polymers; and polysaccharides (and derivatives thereof).

In other embodiments, the aqueous-based polymer is selected from the group consisting of carboxymethyl cellulose (CMC); hydroxypropyl cellulose (HPC); poly(vinyl alcohol) (PVA); polyacrylamide; poly(2-ethyl-2-oxazoline); Polyvinylpyrrolidone (PVP); acrylamide/acrylic acid random copolymers and their salts; styrene-butadiene rubber (SBR); Polyurethane Dispersion (PUD); other latex materials; polyamic acid; poly(acrylic acid) (PAA); lithium PAA; aqueous Polyvinylidene fluoride (PVDF) dispersions and copolymers of acrylic acid and methacrylic acid.

In further embodiments, the secondary polymer is different from the aqueous-based polymer and said secondary polymer is selected from the group consisting of carboxymethyl cellulose (CMC); hydroxypropyl cellulose (HPC); poly(vinyl alcohol) (PVA); polyacrylamide; poly(2-ethyl-2-oxazoline); Polyvinylpyrrolidone (PVP); acrylamide/acrylic acid random copolymers and their salts; styrene-butadiene rubber (SBR); Polyurethane Dispersion (PUD); other latex materials; polyamic acid; poly(acrylic acid) (PAA); lithium PAA; aqueous Polyvinylidene fluoride (PVDF) dispersions and copolymers of acrylic acid and methacrylic acid.

In another embodiment, the aqueous-based polymer and the secondary polymer are chemically crosslinked with a crosslinker, and the crosslinker comprises one or more of epoxy based crosslinkers; melamine formaldehyde; melamine formaldehyde-free resin; polyols; polybasic acids; polyamines; and metal salts.

In some embodiments of a battery electrode as disclosed herein, the electrode comprises an electrode coating layer on a current collector, the electrode coating layer comprising a silicon carbon composite or SiOx-based or Si-Carbon-SiOx-based powder, an aqueous-based polymer, a secondary polymer and one or more conductive additives, where the silicon is substantially amorphous. Further embodiments of the battery electrode are Si-based electrodes or Si-dominant electrodes. In some embodiments, the battery electrode is in a lithium ion battery.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a battery, circuitry, or a device is “operable” to perform a function whenever the battery, circuitry, or device comprises the necessary hardware and code (if any is necessary) or other elements to perform the function, regardless of whether performance of the function is disabled or not enabled (e.g., by a user-configurable setting, factory trim, configuration, etc.).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A battery electrode, the electrode comprising:
an electrode coating layer on a current collector, the electrode coating layer comprising a silicon carbon composite or SiOx-based or Si-Carbon-SiOx-based powder, an aqueous-based polymer, a secondary polymer and one or more conductive additives.

2. The electrode according to claim 1, wherein the silicon carbon composite or SiOx-based or Si-Carbon-SiOx-based powder contains 40-90% elemental silicon in the powder.

3. The electrode according to claim 2, wherein the silicon carbon composite or SiOx-based or Si-Carbon-SiOx-based powder contains 30-70% elemental silicon in the powder.

4. The electrode according to claim 1, wherein said conductive additive is a conductive carbon.

5. The electrode according to claim 4, wherein said conductive carbon is selected from the group consisting of carbon blacks, carbon fibers, carbon nanofibers, carbon nanotubes, graphite, and graphene.

6. The electrode according to claim 4, wherein said conductive carbon is a 1D or 2D carbon structure.

7. The electrode according to claim 6, wherein said 1D or 2D carbon structure is one or more of carbon nanofibers; carbon nanotubes and carbon nanotube-based nanostructures; conductive carbon black; graphene; graphene oxide, carbon nanofibers +conductive carbon black; carbon nanotube/carbon nanotube-based nanostructures+conductive carbon black; carbon nanotube/carbon nanotube-based nanostructures+graphene/graphene oxide; conductive carbon black+graphene/graphene oxide; and carbon nanotube/carbon nanotube-based nanostructures+conductive carbon black+graphene/graphene oxide.

8. The electrode according to claim 6, wherein said 1D or 2D carbon structure is one or more of single-walled carbon nanotubes (SWCNT), multi-walled carbon nanotubes (MWCNT), carbon nanofibers, or crosslinked carbon nanotubes (CCN).

9. The electrode according to claim 1, wherein said aqueous-based polymer is selected from the group consisting of polyimides; crosslinked phenolic resins; polysiloxanes; polyurethanes; polyvinyls; polyvinylpyrrolidone (and copolymers thereof); acrylic polymers; and polysaccharides (and derivatives thereof).

10. The electrode according to claim 1, wherein said aqueous-based polymer is selected from the group consisting of carboxymethyl cellulose (CMC); hydroxypropyl cellulose (HPC); poly(vinyl alcohol) (PVA); polyacrylamide; poly(2-ethyl-2-oxazoline); Polyvinylpyrrolidone (PVP); acrylamide/acrylic acid random copolymers and their salts; styrene-butadiene rubber (SBR); Polyurethane Dispersion (PUD); other latex materials; polyamic acid; poly(acrylic acid) (PAA); lithium PAA; aqueous Polyvinylidene fluoride (PVDF) dispersions and copolymers of acrylic acid and methacrylic acid.

11. The electrode according to claim 1, wherein said secondary polymer is different from said aqueous-based polymer and said secondary polymer is selected from the group consisting of carboxymethyl cellulose (CMC); hydroxypropyl cellulose (HPC); poly(vinyl alcohol) (PVA); polyacrylamide; poly(2-ethyl-2-oxazoline); Polyvinylpyrrolidone (PVP); acrylamide/acrylic acid random copolymers and their salts; styrene-butadiene rubber (SBR); Polyurethane Dispersion (PUD); other latex materials; polyamic acid; poly(acrylic acid) (PAA); lithium PAA; aqueous Polyvinylidene fluoride (PVDF) dispersions and copolymers of acrylic acid and methacrylic acid.

12. The electrode according to claim 1, wherein said aqueous-based polymer and said secondary polymer are chemically crosslinked with a crosslinker.

13. The electrode according to claim 12, wherein said crosslinker comprises one or more of epoxy based crosslinkers; melamine formaldehyde; melamine formaldehyde-free resin; polyols; polybasic acids; polyamines; and metal salts.

14. The electrode according to claim 1, wherein the silicon is substantially amorphous.

15. The electrode according to claim 1, wherein said electrode is a Si-based electrode.

16. The electrode according to claim 15, wherein said Si-based electrode is a Si-dominant electrode.

17. The electrode according to claim 1, wherein the battery electrode is in a lithium ion battery.
